(19) United States
(12) Patent Application Publication
(10) Pub. No.: US 2024/0276987 A1
(43) Pub. Date: Aug. 22, 2024

(54) Compositions and Methods for Improving the Rainfastness of Proteins on Plant Surfaces

(71) Applicants: NOVOZYMES A/S, Bagsvaerd (DK); NOVOZYMES BIOAG A/S, Bagsvaerd (DK)

(72) Inventors: Callum Russell, Durham, NC (US); Asbjoern Toftgaard Pedersen, Copenhagen (DK); Kenneth Edmund Kellar, Durham, NC (US); Alexander Findelsen, Bagsvaerd (DK); Kate Sarah Brandon Sutton, Durham, NC (US); Svend Gunna Kaasgaard, Svovlunde (DK); Ines Marques Nunes, Malmo (SE); Gregory Stephen Maloney, Durham, NC (US); Casey Ruark-Seward, Salem, VA (US); Mary Ann Stringer, Soeborg (DK); Jason Quinlan, Davis, CA (US); Sharon Inch, Durham (NC)

(73) Assignees: NOVOZYMES A/S, Bagsvaerd (DK); NOVOZYMES BIOAG A/S, Bagsvaerd (DK)

(21) Appl. No.: 18/567,686

(22) PCT Filed: Jul. 15, 2022
(86) PCT No.: PCT/US2022/073761

§ 371 Date: Dec. 6, 2023

Related U.S. Application Data
(60) Provisional application No. 63/342,064, filed on May 14, 2022.
(60) Provisional application No. 63/222,612, filed on Jul. 16, 2021.
(60) Provisional application No. 63/222,620, filed on Jul. 16, 2021.

(51) Int. Cl. A01N 55/02; A01N 25/24; A01N 63/50

(52) U.S. Cl. CPC A01N 55/02; A01N 25/24; A01N 63/50

(57) ABSTRACT

The present disclosure provides compositions and methods for improving the rainfastness of proteins, such as enzymes and cell-signaling peptides, on plants and other surfaces that may be susceptible to infestation and/or infection by bacteria, fungi, etc. Particularly useful are rain fasteners selected from the group consisting of organo-modified siloxanes, such as polyether trisiloxanes.

### RELATED APPLICATIONS

This application claims priority to U.S. Provisional Application Nos. 63/222,612, filed Jul. 16, 2021; 63/222,620, filed Jul. 16, 2021; and 63/342,064, filed May 14, 2022, the disclosure of each of which is incorporated herein by reference in its entirety.

### REFERENCE TO A SEQUENCE LISTING

The application contains a Sequence Listing in computer readable form, which is incorporated herein by reference in its entirety.

### FIELD OF THE INVENTION

The present disclosure relates to compositions and methods for improving the rainfastness of proteins, including enzymes, on the surfaces of plants and plant parts.

### BACKGROUND

Myriad chemical compounds are currently approved for use as phytoprotective agents. However, due to the ecotoxicological effects of many of these agrochemicals, it is highly desirable to develop effective and environmentally friendly alternatives.

Protein-based actives, such as enzymes, cell-signaling proteins and antibodies, are particularly desirable because they are capable of exerting very specific and very effective phytoprotective activities and because they are biodegradable and will not accumulate in the environment even after many years of use.

Unfortunately, because proteins tend to be highly water-soluble, they are susceptible to being washed off by rain and/or irrigation events. In most instances, a rain or irrigation event that occurs immediately after or soon after treatment will remove all or substantially all the protein-based active from the surface of the treated plant(s).

The present disclosure provides compositions and methods for improving the rainfastness of a protein on a plant surface (i.e., for increasing the likelihood the protein will remain on the plant surface following a rain or irrigation event).

### DETAILED DESCRIPTION

This description is not intended to be a detailed catalog of all the different ways in which the inventive concepts disclosed herein may be implemented or of all the features that may be added thereto. For example, features illustrated with respect to one embodiment may be incorporated into other embodiments and features illustrated with respect to a particular embodiment may be deleted from that embodiment. In addition, numerous variations and additions to the various embodiments suggested herein, which do not depart from the instant inventions, will be apparent to those skilled in the art in light of the instant disclosure. Hence, the following description is intended to illustrate some embodiments of the instant inventions and not to exhaustively specify all permutations, combinations and variations thereof.

The terminology used herein is for the purpose of describing particular embodiments only and is not intended to be limiting of the instant inventions.

Unless otherwise defined, all terms (including technical and scientific terms) used herein have the same meaning as commonly understood by one of ordinary skill in the art to which the inventions belong. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For the sake of brevity and/or clarity, well-known functions or constructions may not be described in detail.

As used herein, the singular forms “a,” “an,” and “the” are intended to include the plural forms as well, unless the context clearly indicates otherwise.

As used herein, “additive,” when referring to effects of combinations within a composition means that the effects of the combinations are generally about the same as the sum of effects of the individual components of the combination alone. The combination of individual components producing this effect may be called an additive combination.

As used herein, the term “agriculturally acceptable carrier” refers to a substance or composition that can be used to deliver an agriculturally beneficial agent to a plant, plant part or plant growth medium (e.g., soil) without causing/having an unduly adverse effect on plant growth and/or yield. As used herein, the term “foliar-compatible carrier” refers to a material that can be foliarly applied to a plant or plant part without causing/having an unduly adverse effect on the plant, plant part, plant growth, plant health, or the like. As used herein, the term “seed-compatible carrier” refers to a material that can be applied to a seed without causing/having an unduly adverse effect on the seed, the plant that grows from the seed, seed germination, or the like. As used herein, the term “soil-compatible carrier” refers to a material that can be added to a soil without causing/having an unduly adverse effect on plant growth, soil structure, soil drainage, or the like.

As used herein, the term “agriculturally beneficial microorganism” refers to a microorganism having at least one agriculturally beneficial property (e.g., the ability to fix nitrogen, the ability to solubilize phosphate and/or the ability to produce an agriculturally beneficial agent, such as a plant signal molecule).

As used herein, the term “and/or” is intended to include any and all combinations of one or more of the associated listed items, as well as the lack of combinations when interpreted in the alternative (“or”). Thus, the phrase “A, B and/or C” is to be interpreted as “A, A and B, A and B and C, A and C, B, B and C, or C.”

As used herein, “antagonistic,” when referring to effects of combinations within a composition means that the effects of the combinations are generally less than the sum of effects of the individual components of the combination alone. These compositions may be called antagonistic combinations.

As used herein, the term “aqueous” refers to a composition that contains more than a trace amount of water (i.e., more than 0.5% water by weight, based upon the total weight of the composition).

As used herein, the terms “associated with,” in association with” and “associated therewith,” when used in reference to a relationship between a composition of the present disclosure and a plant or plant part, refer to at least a juxtaposition or close proximity of the composition and the plant or plant part. Such a juxtaposition or close proximity may be achieved by contacting or applying the composition directly to the plant or plant part and/or by applying the composition to the plant growth medium (e.g., soil) in which the plant or plant part will be grown (or is currently being grown). According to some embodiments, the composition is applied as a coating to the outer surface of the plant or plant part. According to some embodiments, the composition is applied to soil at, near or surrounding the site in which the plant or plant part will be grown (or is currently being grown).

As used herein, the term “biostimulant” refers to an agent or combination of agents the application of which enhances one or more metabolic and/or physiological processes of a plant or plant part (e.g., carbohydrate biosynthesis, ion uptake, nucleic acid uptake, nutrient delivery, photosynthesis and/or respiration).

As used herein, the term “binding module” refers to the region of an enzyme that mediates binding to the enzyme to a substrate.

As used herein, the term “catalytic domain” refers to the region of an enzyme containing the catalytic machinery of the enzyme.

As used herein, the term “cDNA” refers to a DNA molecule that can be prepared by reverse transcription from a mature, spliced, mRNA molecule obtained from a eukaryotic or prokaryotic cell. cDNAs lack intron sequences that may be present in the corresponding genomic DNA. The initial, primary RNA transcript is a precursor to mRNA that is processed through a series of steps, including splicing, before appearing as mature spliced mRNA.

As used herein, the term “coding sequence” refers to a polynucleotide that directly specifies the amino acid sequence of a polypeptide. The boundaries of the coding sequence are generally determined by an open reading frame, which begins with a start codon, such as ATG, GTG, or TTG, and ends with a stop codon, such as TAA, TAG, or TGA. The coding sequence may be a genomic DNA, cDNA, synthetic DNA, or a combination thereof.

As used herein, the terms “colony forming unit” and “cfu” refer to a microbial cell/spore capable of propagating on or in a suitable growth medium or substrate (e.g., a soil) when conditions (e.g., temperature, moisture, nutrient availability, pH, etc.) are favorable for germination and/or microbial growth.

As used herein, the term “consists essentially of,” when used in reference to compositions and methods of the present disclosure, means that the compositions/methods may contain additional components/steps so long as the additional components/steps do not materially alter the composition/method. The term “materially alter,” as applied to a composition/method of the present disclosure, refers to an increase or decrease in the effectiveness of the composition/method of at least 20%. For example, a component added to a composition of the present disclosure may be deemed to “materially alter” the composition if it increases or decreases the composition's ability to inhibit the growth of a target phytopathogen by at least 20%.

As used herein, the term “control sequences” refers to nucleic acid sequences involved in regulation of expression of a polynucleotide in a specific organism or in vitro. Each control sequence may be native (i.e., from the same gene) or heterologous (i.e., from a different gene) to the polynucleotide encoding the polypeptide, and native or heterologous to each other. Such control sequences include, but are not limited to leader, polyadenylation, prepropeptide, propeptide, signal peptide, promoter, terminator, enhancer, and transcription or translation initiator and terminator sequences. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a polypeptide.

As used herein, the term “diazotroph” refers to an organism capable of converting atmospheric nitrogen (N₂) into a form that may be utilized by a plant or plant part (e.g., ammonia (NH₃), ammonium (NH₄+), etc.).

As used herein, the term “dispersant” refers to an agent or combination of agents the application of which reduces the cohesiveness of like particles, the surface tension of a liquid, the interfacial tension between two liquids and/or the interfacial tension between or a liquid and a solid.

As used herein, the terms “effective amount,” “effective concentration” and “effective amount/concentration” refer to an amount or concentration that is sufficient to cause a desired effect (e.g., inhibiting plant disease, enhancing plant yield). The absolute value of the amount/concentration that is sufficient to cause the desired effect may be affected by factors such as the type and magnitude of effect desired, the type, size and volume of material to which the composition will be applied, the type(s) of enzymes in the composition, the amount(s) of enzyme(s) in the composition, the stability of the enzyme(s) in the composition and the storage conditions (e.g., temperature, relative humidity, duration). Those skilled in the art will understand how to select an effective amount/concentration using routine dose-response experiments. In some examples, an effective amount of a substance when used alone may be different than an effective amount of the same substance when used as part of a combination.

As used herein, the terms “enhanced growth” and “enhanced plant growth” refer to an improvement in one or more characteristics of plant growth and/or development as compared to one or more control plants (e.g., a plant germinated from an untreated seed or an untreated plant). Exemplary plant growth/development characteristics include, but are not limited to, biomass, carbohydrate biosynthesis, chlorophyll content, cold tolerance, drought tolerance, height, leaf length, leaf mass, leaf number, leaf surface area, leaf volume, nutrient uptake (e.g., calcium, magnesium, nitrogen, phosphorous and/or potassium uptake), rate(s) of photosynthesis, root area, root diameter, root length, root mass, root nodulation (e.g., nodule mass, nodule number, nodule volume), root number, root surface area, root volume, salt tolerance, seed germination, seedling emergence, shoot diameter, shoot length, shoot mass, shoot number, shoot surface area, shoot volume, spread, stomatal conductance and survival rate.

As used herein, the terms “enhanced stability” and “enhanced enzyme stability” refer to an improvement in one or more characteristics of enzyme stability as compared to one or more controls (e.g., a control composition that is identical to a composition of the present disclosure except that it lacks one or more of the components found in the composition of the present disclosure). Exemplary enzyme stability characteristics include, but are not limited to, maintenance of enzymatic activity after being applied to a plant or plant part and/or stored for a defined period of time and the ability to cause a desired effect (e.g., reduced phytopathogenicity of a target pest) after being applied to a plant or plant part and/or stored for a defined period of time.

As used herein, the terms “enhanced yield” and “enhanced plant yield” refer to an improvement in one or more characteristics of plant yield as compared to one or more control plants (e.g., a control plant germinated from an untreated seed). Exemplary plant yield characteristics include, but are not limited to, biomass; bushels per acre; grain weight per plot (GWTPP); nutritional content; percentage of plants in a given area (e.g., plot) that fail to produce grain; yield at standard moisture percentage (YSMP), such as grain yield at standard moisture percentage (GYSMP); yield per plot (YPP), such as grain weight per plot (GWTPP); and yield reduction (YRED).

As used herein, the term “expression” refers to any step involved in the production of a polypeptide including, but not limited to, transcription, post-transcriptional modification, translation, post-translational modification, and secretion. Expression can be measured—for example, to detect increased expression—by techniques known in the art, such as measuring levels of mRNA and/or translated polypeptide.

As used herein, the term “expression vector” refers to a linear or circular DNA construct comprising a DNA sequence encoding a polypeptide, which coding sequence is operably linked to a suitable control sequence capable of effecting expression of the DNA in a suitable host. Such control sequences may include a promoter to effect transcription, an optional operator sequence to control transcription, a sequence encoding suitable ribosome binding sites on the mRNA, enhancers and sequences which control termination of transcription and translation.

As used herein, the term “extension” refers to an addition of one or more amino acids to the amino and/or carboxyl terminus of a polypeptide.

As used herein, the term “foliage” refers to those portions of a plant that normally grow above the ground, including, but not limited to, leaves, stalks, stems, flowers, fruiting bodies and fruits.

As used herein, the terms “foliar application” and “foliarly applied” refer to the application of one or more active ingredients to the foliage of a plant (e.g., to the leaves of the plant). Application may be affected by any suitable means, including, but not limited to, spraying/fogging the plant with a composition comprising the active ingredient(s). In some embodiments, the active ingredient(s) is/are applied to the leaves, stems and/or stalk of the plant and not to the flowers, fruiting bodies or fruits of the plant.

As used herein, the term “fragment” refers to a polypeptide having one or more amino acids absent from the amino and/or carboxyl terminus of the mature polypeptide.

As used herein, the term “fusion polypeptide” refers to a polypeptide in which one polypeptide is fused at the N-terminus and/or the C-terminus of a polypeptide of the present disclosure. A fusion polypeptide is produced by fusing a polynucleotide encoding another polypeptide to a polynucleotide of the present disclosure, or by fusing two or more polynucleotides of the present disclosure together. Techniques for producing fusion polypeptides are known in the art and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779). A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

As used herein, the term “heterologous,” when used to describe the relationship between a polynucleotide or polypeptide and a host cell, refers to a polynucleotide or polypeptide that does not naturally occur in the host cell.

As used herein, the term “heterologous,” when used to describe the relationship between a polynucleotide or polypeptide and a control sequence (e.g., a promoter sequence), refers to a polynucleotide or polypeptide is not naturally associated with the control sequence (i.e., the control sequence is from a gene other than the gene encoding the mature polypeptide).

As used herein, the terms “host strain” and “host cell” refer to an organism into which an expression vector, phage, virus, or other DNA construct, including a polynucleotide encoding a polypeptide of interest (e.g., an amylase) has been introduced. Exemplary host strains are microorganism cells (e.g., bacteria, filamentous fungi, and yeast) and plant cells capable of expressing a protein of interest. The term “host cell” includes protoplasts created from cells.

As used herein, the terms “inoculant composition” and “inoculum” refer to a composition comprising microbial cells and/or spores, said cells/spores being capable of propagating/germinating on or in a suitable growth medium or substrate (e.g., a soil) when conditions (e.g., temperature, moisture, nutrient availability, pH, etc.) are favorable for germination and/or microbial growth.

As used herein, the term “introduced,” when used to describe the insertion of a nucleic acid sequence into a cell, encompasses “transfection”, “transformation” or “transduction,” as known in the art.

As used herein, the term “isolated” refers to a polypeptide, nucleic acid, cell, or other specified material or component that has been separated from at least one other material or component, including but not limited to, other proteins, nucleic acids, cells, etc. An isolated polypeptide, nucleic acid, cell or other material is thus in a form that does not occur in nature. An isolated polypeptide includes, but is not limited to, a culture broth containing the secreted polypeptide expressed in a host cell.

As used herein, the term “isomer” includes all stereoisomers of the compounds and/or molecules to which it refers, including enantiomers and diastereomers, as well as all conformers, roatmers and tautomers, unless otherwise indicated. Compounds and/or molecules disclosed herein include all enantiomers in either substantially pure levorotatory or dextrorotatory form, or in a racemic mixture, or in any ratio of enantiomers. Where embodiments disclose a (D)-enantiomer, that embodiment also includes the (L)-enantiomer; where embodiments disclose a (L)-enantiomer, that embodiment also includes the (D)-enantiomer. Where embodiments disclose a (+)-enantiomer, that embodiment also includes the (−)-enantiomer; where embodiments disclose a (−)-enantiomer, that embodiment also includes the (+)-enantiomer. Where embodiments disclose a (S)-enantiomer, that embodiment also includes the (R)-enantiomer; where embodiments disclose a (R)-enantiomer, that embodiment also includes the (S)-enantiomer. Embodiments are intended to include any diastereomers of the compounds and/or molecules referred to herein in diastereomerically pure form and in the form of mixtures in all ratios. Unless stereochemistry is explicitly indicated in a chemical structure or chemical name, the chemical structure or chemical name is intended to embrace all possible stereoisomers, conformers, rotamers and tautomers of compounds and/or molecules depicted.

As used herein, the term “mature polypeptide” refers to a polypeptide in its mature form following N-terminal and/or C-terminal processing (e.g., removal of signal peptide).

As used herein, the term “mature polypeptide coding sequence” refers to a polynucleotide that encodes a mature polypeptide.

As used herein, the term “modified microbial strain” refers to a microbial strain that is modified from a strain isolated from nature. Modified microbial strains may be produced by any suitable method(s), including, but not limited to, chemical or other form of induced mutation to a polynucleotide within any genome within the strain; the insertion or deletion of one or more nucleotides within any genome within the strain, or combinations thereof; an inversion of at least one segment of DNA within any genome within the strain; a rearrangement of any genome within the strain; generalized or specific transduction of homozygous or heterozygous polynucleotide segments into any genome within the strain; introduction of one or more phage into any genome of the strain; transformation of any strain resulting in the introduction into the strain of stably replicating autonomous extrachromosomal DNA; any change to any genome or to the total DNA composition within the strain isolated from nature as a result of conjugation with any different microbial strain; and any combination of the foregoing. The term modified microbial strains includes a strain with (a) one of more heterologous nucleotide sequences, (b) one or more non-naturally occurring copies of a nucleotide sequence isolated from nature (i.e., additional copies of a gene that naturally occurs in the microbial strain from which the modified microbial strain was derived), (c) a lack of one or more nucleotide sequences that would otherwise be present in the natural reference strain by for example deleting nucleotide sequence, and (d) added extrachromosomal DNA. In some embodiments, modified microbial strains comprise a combination of two or more nucleotide sequences (e.g., two or more naturally occurring genes that do not naturally occur in the same microbial strain) or comprise a nucleotide sequence isolated from nature at a locus that is different from the natural locus.

As used herein, the term “native” refers to a polynucleotide or polypeptide naturally occurring in a host cell.

As used herein, the term “naturally occurring” refers to anything (e.g., proteins, amino acids, or nucleic acid sequences) that is found in nature. Conversely, the term “non-naturally occurring” refers to anything that is not found in nature (e.g., recombinant nucleic acids and protein sequences produced in a laboratory, modification of a wild-type sequence, formulations comprising one or more synthetic components, formulations comprising an artificial combination of otherwise naturally occurring components).

As used herein, the term “non-aqueous” refers to a composition that comprises no more than a trace amount of water (i.e., no more than 0.5% water by weight, based upon the total weight of the composition).

As used herein, the term “nutrient” refers to a compound or element useful for nourishing a plant (e.g., vitamins, macrominerals, micronutrients, trace minerals, organic acids, etc. that are necessary for plant growth and/or development).

As used herein, the term “polynucleotide” encompasses DNA, RNA, heteroduplexes, and synthetic molecules capable of encoding a polypeptide. Polynucleotides may be single-stranded or double-stranded and may comprise chemical modifications. The terms “nucleic acid” and “polynucleotide” are used interchangeably. Because the genetic code is degenerate, more than one codon may be used to encode a particular amino acid, and the present compositions and methods encompass nucleotide sequences that encode a particular amino acid sequence. Unless otherwise indicated, nucleic acid sequences are presented in 5′-to-3′ orientation.

As used herein, the term “nucleic acid construct” refers to a polynucleotide, either single- or double-stranded, which is isolated from a naturally occurring gene or is modified to contain segments of nucleic acids in a manner that would not otherwise exist in nature or which is synthetic, and which comprises one or more control sequences operably linked to the nucleic acid sequence.

As used herein, the term “operably linked” means that specified components are in a relationship (including but not limited to juxtaposition) permitting them to function in an intended manner. For example, a regulatory sequence is operably linked to a coding sequence such that expression of the coding sequence is under control of the regulatory sequence.

As used herein, the term “phosphate-solubilizing microorganism” refers to a microorganism capable of converting insoluble phosphate into a soluble form of phosphate.

As used herein, the term “phytopathogenic pest” includes any organism or virus that negatively affects a plant, including, but not limited to, organisms and viruses that spread disease, damage host plants and/or compete for soil nutrients. The term “phytopathogenic pest” encompasses organisms and viruses that are known to associate with plants and to cause a detrimental effect on the plant's health and/or vigor. Phytopathogenic pests include, but are not limited to, arachnids (e.g., mites, ticks, spiders, etc.), bacteria, fungi, gastropods (e.g., slugs, snails, etc.), invasive plants (e.g., weeds), insects (e.g., white flies, thrips, weevils, etc.), nematodes (e.g., root-knot nematode, soybean cyst nematode, etc.), rodents and viruses (e.g., tobacco mosaic virus (TMV), tomato spotted wilt virus (TSWV), cauliflower mosaic virus (CaMV), etc.).

As used herein, the term “plant” includes all plant populations, including, but not limited to, agricultural, horticultural and silvicultural plants. The term “plant” encompasses plants obtained by conventional plant breeding and optimization methods (e.g., marker-assisted selection) and plants obtained by genetic engineering, including cultivars protectable and not protectable by plant breeders' rights.

As used herein, the term “plant cell” refers to a cell of an intact plant, a cell taken from a plant, or a cell derived from a cell taken from a plant. Thus, the term “plant cell” includes cells within seeds, suspension cultures, embryos, meristematic regions, callus tissue, leaves, shoots, gametophytes, sporophytes, pollen and microspores.

As used herein, the term “plant growth regulator” refers to an agent or combination of agents the application of which accelerates or retards the growth/maturation rate of a plant through direct physiological action on the plant or which otherwise alters the behavior of a plant through direct physiological action on the plant. “Plant growth regulator” shall not be interpreted to include any agent or combination of agents excluded from the definition of “plant regulator” that is set forth section 2(v) of the Federal Insecticide, Fungicide, and Rodenticide Act (7 U.S.C. § 136(v)). Thus, “plant growth regulator” does not encompass microorganisms applied to a plant, plant part or plant growth medium for the purpose of enhancing the availability and/or uptake of nutrients, nutrients necessary to normal plant growth, soil amendments applied for the purpose of improving soil characteristics favorable for plant growth or vitamin hormone products as defined by 40 C.F.R. § 152.6(f).

As used herein, the term “plant part” refers to any part of a plant, including cells and tissues derived from plants. Thus, the term “plant part” may refer to any of plant components or organs (e.g., leaves, stems, roots, etc.), plant tissues, plant cells and seeds. Examples of plant parts, include, but are not limited to, anthers, embryos, flowers, fruits, fruiting bodies, leaves, ovules, pollen, rhizomes, roots, seeds, shoots, stems and tubers, as well as scions, rootstocks, protoplasts, calli and the like.

As used herein, the term “plant propagation material” refers to a plant part from which a whole plant can be generated. Examples of plant propagation materials include, but are not limited to, cuttings (e.g., leaves, stems), rhizomes, seeds, tubers and cells/tissues that can be cultured into a whole plant.

As used herein, the term “protein” is not meant to refer to a specific amino acid chain length and encompasses peptides, oligopeptides and polypeptides. It is to be understood that the term “protein” also encompasses two or more polypeptides combined to form an encoded product, as well as hybrid polypeptides and fusion polypeptides.

As used herein, the term “purified” refers to a polynucleotide, protein or cell that is substantially free from other components as determined by analytical techniques well known in the art (e.g., a purified polynucleotide or protein may form a discrete band in an electrophoretic gel, chromatographic eluate, and/or a media subjected to density gradient centrifugation). A purified polynucleotide or protein is at least about 50% pure, usually at least about 60%, about 65%, about 70%, about 75%, about 80%, about 85%, about 90%, about 91%, about 92%, about 93%, about 94%, about 95%, about 96%, about 97%, about 98%, about 99%, about 99.5%, about 99.6%, about 99.7%, about 99.8% or more pure (e.g., percent by weight or on a molar basis). In a related sense, a composition is enriched for a molecule when there is a substantial increase in the concentration of the molecule after application of a purification or enrichment technique. The term “enriched” refers to a compound, polynucleotide, protein, cell, nucleic acid, amino acid, or other specified material or component that is present in a composition at a relative or absolute concentration that is higher than a starting composition.

In one aspect, the term “purified” as used herein refers to the protein or cell being essentially free from components (especially insoluble components) from the production organism. In other aspects. the term “purified” refers to the protein being essentially free of insoluble components (especially insoluble components) from the native organism from which it is obtained. In one aspect, the protein is separated from some of the soluble components of the organism and culture medium from which it is recovered. The protein may be purified (i.e., separated) by one or more of the unit operations filtration, precipitation, or chromatography.

Accordingly, the protein may be purified such that only minor amounts of other proteins, in particular, other proteins, are present. The term “purified” as used herein may refer to removal of other components, particularly other proteins and most particularly other enzymes present in the cell of origin of the protein. The protein may be “substantially pure”, i.e., free from other components from the organism in which it is produced, e.g., a host organism for recombinantly produced protein. In one aspect, the protein is at least 40% pure by weight of the total protein material present in the preparation. In one aspect, the protein is at least 50%, 60%, 70%, 80% or 90% pure by weight of the total protein material present in the preparation. As used herein. a “substantially pure protein” may denote a protein preparation that contains at most 10%, preferably at most 8%, more preferably at most 6%, more preferably at most 5%, more preferably at most 4%, more preferably at most 3%, even more preferably at most 2%, most preferably at most 1%, and even most preferably at most 0.5% by weight of other protein material with which the protein is natively or recombinantly associated.

It is, therefore, preferred that the substantially pure protein is at least 92% pure, preferably at least 94% pure, more preferably at least 95% pure, more preferably at least 96% pure, more preferably at least 97% pure, more preferably at least 98% pure, even more preferably at least 99% pure, most preferably at least 99.5% pure by weight of the total protein material present in the preparation. Proteins of the present disclosure are preferably in a substantially pure form (i.e., the preparations are essentially free of other protein material). This can be accomplished, for example by preparing the protein by well-known recombinant methods or by classical purification methods.

As used herein, the term “recombinant” is used in its conventional meaning to refer to the manipulation, e.g., cutting and rejoining, of nucleic acid sequences to form constellations different from those found in nature. The term recombinant refers to a cell, nucleic acid, protein or vector that has been modified from its native state. Thus, for example, recombinant cells express genes that are not found within the native (non-recombinant) form of the cell, or express native genes at different levels or under different conditions than found in nature. The term “recombinant” is synonymous with “genetically modified” and “transgenic”.

As used herein, the terms “recover” and “recovery” refer to the removal of a protein from at least one fermentation broth component selected from the list of a cell, a nucleic acid, or other specified material, e.g., recovery of the protein from the whole fermentation broth, or from the cell-free fermentation broth, by protein crystal harvest, by filtration, e.g. depth filtration (by use of filter aids or packed filter medias, cloth filtration in chamber filters, rotary-drum filtration, drum filtration, rotary vacuum-drum filters, candle filters, horizontal leaf filters or similar, using sheed or pad filtration in framed or modular setups) or membrane filtration (using sheet filtration, module filtration, candle filtration, microfiltration, ultrafiltration in either cross flow, dynamic cross flow or dead end operation), or by centrifugation (using decanter centrifuges, disc stack centrifuges, hydro cyclones or similar), or by precipitating the protein and using relevant solid-liquid separation methods to harvest the protein from the broth media by use of classification separation by particle sizes. Recovery encompasses isolation and/or purification of the protein.

As used herein, the relatedness between two amino acid sequences or between two nucleotide sequences is described by the parameter “sequence identity”.

For purposes of the present disclosure, the sequence identity between two amino acid sequences is determined as the output of “longest identity” using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the −nobrief option must be specified in the command line. The output of Needle labeled “longest identity” is calculated as follows:

$$( Identical Residues \times 100 ) / ( Length of Alignment - Total Number of Gaps in Alignment )$$

For purposes of the present disclosure, the sequence identity between two polynucleotide sequences is determined as the output of “longest identity” using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 6.6.0 or later. The parameters used are a gap open penalty of 10, a gap extension penalty of 0.5, and the EDNAFULL (EMBOSS version of NCBI NUC4.4) substitution matrix. In order for the Needle program to report the longest identity, the nobrief option must be specified in the command line. The output of Needle labeled “longest identity” is calculated as follows:

$$( Identical Deoxyribonucleotides \times 100 ) / ( Length of Alignment - Total Number of Gaps in Alignment )$$

As used herein, the term “signal peptide” refers to a sequence of amino acids attached to the N-terminal portion of a protein, which facilitates the secretion of the protein outside the cell. The mature form of an extracellular protein lacks the signal peptide, which is cleaved off during the secretion process.

As used herein, the terms “stabilizing compound” and “stabilizer” refer to an agent or combination of agents the application of which enhances the stability of an enzyme.

As used herein, the term “subsequence” refers to a polynucleotide having one or more nucleotides absent from the 5′ and/or 3′ end of a mature protein coding sequence; wherein the subsequence encodes a fragment having enzymatic activity.

As used herein, the term “variant” refers to a protein comprising a man-made mutation, i.e., a substitution, insertion (including extension), and/or deletion (e.g., truncation), at one or more positions. A substitution means replacement of the amino acid occupying a position with a different amino acid; a deletion means removal of the amino acid occupying a position; and an insertion means adding 1-5 amino acids (e.g., 1-3 amino acids, in particular, 1 amino acid) adjacent to and immediately following the amino acid occupying a position.

As used herein, the term “wild-type” in reference to an amino acid sequence or nucleic acid sequence means that the amino acid sequence or nucleic acid sequence is a native or naturally occurring sequence.

While certain aspects of the present disclosure will hereinafter be described with reference to embodiments thereof, it will be understood by those of ordinary skill in the art that various changes in form and details may be made therein without departing from the spirit and scope of the present disclosure as defined by the claims.

All publications, patent applications, patents and other references mentioned herein are incorporated by reference in their entirety, except insofar as they contradict any disclosure expressly set forth herein.

The present disclosure provides proteins useful for preventing, treating, suppressing, eliminating and/or reducing the severity of infestations/infections of/by various pests, including, but not limited to, horticultural pests, such as acarids, bacteria, fungi, gastropods, insects, nematodes, oomycetes, protozoa and weeds, as well as formulations comprising such proteins, polynucleotides encoding such proteins, organisms expressing such proteins, and methods of using such proteins, formulations, polynucleotides and organisms in agriculture and other fields of endeavor.

The present disclosure encompasses proteins having one or more catalytic activities, including, but not limited to, proteins capable of exhibiting one or more catalytic activities belonging to Enzyme Commission classification number 1 (EC 1), Enzyme Commission classification number 3 (EC 3) and/or Enzyme Commission classification number 4 (EC 4).

In some embodiments, proteins of the present disclosure exhibit one or more catalytic activities belonging to EC 1. For example, in some embodiments, proteins of the present disclosure exhibit glucose oxidase, cellobiose dehydrogenase, laccase, catalase and/or peroxidase activity useful for preventing, treating, suppressing, eliminating and/or reducing the severity of infestations/infections of/by pests, such as acarids, bacteria, fungi, gastropods, insects, nematodes, oomycetes and protozoa.

In some embodiments, proteins of the present disclosure exhibit oxidoreductase activity belonging to EC 1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-12.

In some embodiments, proteins of the present disclosure exhibit one or more oxidoreductase activities belonging to EC 1.1, such as oxidase activities belonging to EC 1.1.3 (e.g., glucose oxidase activity belonging to EC 1.1.3.4 and/or cellobiose dehydrogenase activity belonging to EC 1.1.3.25).

In some embodiments, proteins of the present disclosure exhibit oxidoreductase activity belonging to EC 1.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8.

In some embodiments, proteins of the present disclosure exhibit oxidase activity belonging to EC 1.1.3 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8.

In some embodiments, proteins of the present disclosure exhibit glucose oxidase activity belonging to EC 1.1.3.4 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-5.

In some embodiments, proteins of the present disclosure exhibit cellobiose dehydrogenase activity belonging to EC 1.1.3.25 (now included in EC 1.1.99.18) and, optionally comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 6-8.

In some embodiments, proteins of the present disclosure exhibit one or more oxidoreductase activities belonging to EC 1.10, such as activities belonging to EC 1.10.3 (e.g., laccase activity belonging to EC 1.10.3.2).

In some embodiments, proteins of the present disclosure exhibit oxidase activity belonging to EC 1.10 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 9.

In some embodiments, proteins of the present disclosure exhibit oxidase activity belonging to EC 1.10.3 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 9.

In some embodiments, proteins of the present disclosure exhibit laccase activity belonging to EC 1.10.3.2 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 9.

In some embodiments, proteins of the present disclosure exhibit one or more oxidoreductase activities belonging to EC 1.11, such as peroxidase activities belonging to EC 1.11.1 (e.g., catalase activity belonging to EC 1.11.1.6 and/or peroxidase activity belonging to 1.11.1.7).

In some embodiments, enzymes of the present disclosure exhibit peroxidase activity belonging to EC 1.11 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12.

In some embodiments, proteins of the present disclosure exhibit peroxidase activity belonging to EC 1.11.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12.

In some embodiments, proteins of the present disclosure exhibit catalase activity belonging to EC 1.11.1.6 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-11.

In some embodiments, proteins of the present disclosure exhibit peroxidase activity belonging to EC 1.11.1.7 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 12.

In some embodiments, proteins of the present disclosure exhibit one or more oxygenase activities belonging to EC 1.14, such as oxygenase activities belonging to 1.14.99 (e.g., lytic cellulose monooxygenase activity belonging to EC 1.14.99.56).

In some embodiments, proteins of the present disclosure exhibit oxygenase activity belonging to EC 1.14 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 98-99.

In some embodiments, proteins of the present disclosure exhibit oxygenase activity belonging to EC 1.14.99 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 98-99.

In some embodiments, proteins of the present disclosure exhibit lytic cellulose monooxygenase activity belonging to EC 1.14.99.56 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 98-99.

In some embodiments, proteins of the present disclosure exhibit one or more catalytic activities belonging to EC 3. For example, in some embodiments, proteins of the present disclosure exhibit lipase, triacylglycerol lipase, pectinesterase, phospholipase, lysophospholipase, amylase, glucosidase, galactosidase, cellulase, glucanase, xylanase, ceramidase, dextranase, chitinase, chitosanase, galacturonase, fucosidase, lysozymes, xylosidase, lucosidass, pullulanase, mannosidase, amidase, asparaginase, aminidase, maltohydrolases, cellobiosidase, pectinase, aminopeptidase, serine peptidase and/or metallopeptidase activity useful for preventing, treating, suppressing, eliminating and/or reducing the severity of infestations/infections of/by pests, such as acarids, bacteria, fungi, gastropods, insects, nematodes, oomycetes and protozoa.

In some embodiments, proteins of the present disclosure exhibit esterase activity belonging to EC 3 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13-48, 100-148 and 150.

In some embodiments, proteins of the present disclosure exhibit one or more esterase activities belonging to EC 3.1, such as lipase activities belonging to EC 3.1.1 (e.g., triacylglycerol lipase activity belong to EC 3.1.1.3, lysophospholipase activity belonging to 3.1.1.5, pectinesterase activity belonging to 3.1.1.11, and/or phospholipase activity belonging to 3.1.1.32) and hydrolase activities belonging to EC 3.1.4 (e.g., phospholipase C activity belonging to 3.1.4.3 and/or phoshoinositide phospholipase C activity belonging to 3.1.4.11).

In some embodiments, proteins of the present disclosure exhibit esterase activity belonging to EC 3.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 13 and 100-108.

In some embodiments, proteins of the present disclosure exhibit esterase activity belonging to EC 3.1.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 13 and 100-106.

In some embodiments, proteins of the present disclosure exhibit triacylglycerol lipase activity belonging to EC 3.1.1.3 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 100-103.

In some embodiments, proteins of the present disclosure exhibit lysophospholipase activity belonging to EC 3.1.1.5 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 13 and 104.

In some embodiments, proteins of the present disclosure exhibit pectinesterase activity belonging to EC 3.1.1.11 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 100-103.

In some embodiments, proteins of the present disclosure exhibit phospholipase A₁ activity belonging to EC 3.1.1.32 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 100-103.

In some embodiments, proteins of the present disclosure exhibit one or more glycosylase activities belonging to EC 3.2, such as glycosidase activities belonging to EC 3.2.1 (e.g., alpha-amylase activity belong to EC 3.2.1.1, beta-amylase activity belong to EC 3.2.1.2, glucan 1,4-alpha-glucosidase activity belong to 3.2.1.3, cellulase activity belong to 3.2.1.4, endo-1,3(4)-beta-glucanase activity belong to 3.2.1.6, inulinase activity belong to 3.2.1.7, endo-1,4-beta-xylanase activity belong to 3.2.1.8, oligo-1,6-glucosidase activity belong to 3.2.1.10, dextranase activity belong to 3.2.1.11, chitinase activity belong to 3.2.1.14, endo-polygalacturonase (pectinase) activity belong to 3.2.1.15, lysozyme activity belong to 3.2.1.17, alpha-glucosidase activity belong to 3.2.1.20, beta-glucosidase activity belong to 3.2.1.21, alpha-galactosidase activity belong to 3.2.1.22, beta-galactosidase activity belong to 3.2.1.23, alpha-mannosidase activity belong to 3.2.1.24, beta-mannosidase activity belong to 3.2.1.25, beta-fructofuranoside activity belong to 3.2.1.26, alpha,alpha-trehalase activity belong to 3.2.1.28, endo-1,3-beta-xylanase activity belong to 3.2.1.32, xylan 1,4-beta-xylosidase activity belong to 3.2.1.37, glucan endo-1,3-beta-D-glucosidase activity belong to 3.2.1.39, pullulanase activity belong to 3.2.1.41, alpha-L-arabinofuranosidase activity belong to 3.2.1.55, glucan 1,3-beta-glucosidase activity belong to 3.2.1.58, glucan endo-1,3-alpha-glucosidase activity belong to 3.2.1.59, licheninase activity belong to 3.2.1.73, glucan endo-1,6-beta-glucosidase activity belong to 3.2.1.75, mannan endo-1,4-$-mannosidase activity belonging to 3.2.1.78, 1,4-beta-cellobiosidase activity belong to 3.2.1.91, endo-alpha-N-acetylgalactosaminidase activity belong to 3.2.1.97, mannan endo-1,6-alpha-mannosidase activity belong to 3.2.1.101, endogalactosaminidase activity belong to 3.2.1.109, 1,3-alpha-L-fucosidase activity belong to 3.2.1.111, 2-deoxyglucosidase activity belong to 3.2.1.112, chitosanase activity belong to 3.2.1.132, glucan 1,4-alpha-maltohydrolase activity belong to 3.2.1.133, and/or 1,4-beta-cellobiosidase activity belonging to 3.2.1.176).

In some embodiments, proteins of the present disclosure exhibit glycosylase activity belonging to EC 3.2 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143.

In some embodiments, proteins of the present disclosure exhibit glycosidase activity belonging to EC 3.2.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143.

In some embodiments, proteins of the present disclosure exhibit alpha-amylase activity belonging to EC 3.2.1.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-16 and 109-113.

In some embodiments, proteins of the present disclosure exhibit glucan 1,4-alpha-glucosidase activity belonging to EC 3.2.1.3 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 17-18.

In some embodiments, proteins of the present disclosure exhibit cellulase activity belonging to EC 3.2.1.4 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 19 and 114-116.

In some embodiments, proteins of the present disclosure exhibit endo-1,3(4)-beta-glucanase activity belonging to EC 3.2.1.6 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 20 and 150.

In some embodiments, proteins of the present disclosure exhibit inulinase activity belonging to EC 3.2.1.7 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 117.

In some embodiments, proteins of the present disclosure exhibit endo-1,4-beta-xylanase activity belonging to EC 3.2.1.8 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 21-24 and 118-120.

In some embodiments, proteins of the present disclosure exhibit dextranase activity belonging to EC 3.2.1.11 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 25.

In some embodiments, proteins of the present disclosure exhibit chitinase activity belonging to EC 3.2.1.14 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 121-124 and 141.

In some embodiments, proteins of the present disclosure exhibit endo-polygalacturonase (pectinase) activity belonging to EC 3.2.1.15 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 125.

In some embodiments, proteins of the present disclosure exhibit lysozyme activity belonging to EC 3.2.1.17 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 26.

In some embodiments, proteins of the present disclosure exhibit beta-glucosidase activity belonging to EC 3.2.1.21 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 126.

In some embodiments, proteins of the present disclosure exhibit xylan 1,4-beta-xylosidase activity belonging to EC 3.2.1.37 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 127.

In some embodiments, proteins of the present disclosure exhibit glucan endo-1,3-beta-D-glucosidase activity belonging to EC 3.2.1.39 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 27-28 and 128.

In some embodiments, proteins of the present disclosure exhibit pullulanase activity belonging to EC 3.2.1.41 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 29.

In some embodiments, proteins of the present disclosure exhibit alpha-L-arabinofuranosidase activity belonging to EC 3.2.1.55 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 129.

In some embodiments, proteins of the present disclosure exhibit glucan endo-1,3-alpha-glucosidase activity belonging to EC 3.2.1.59 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 30 and 130-131.

In some embodiments, proteins of the present disclosure exhibit licheninase activity belonging to EC 3.2.1.73 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NO: 132.

In some embodiments, proteins of the present disclosure exhibit glucan endo-1,6-beta-glucosidase activity belonging to EC 3.2.1.75 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 31-32 and 133.

In some embodiments, proteins of the present disclosure exhibit mannan endo-1,4-beta-mannosidase activity belonging to EC 3.2.1.78 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 33 and 134.

In some embodiments, proteins of the present disclosure exhibit 1,4-beta-cellobiosidase activity belonging to EC 3.2.1.91 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 135.

In some embodiments, proteins of the present disclosure exhibit mannan endo-1,6-alpha-mannosidase activity belonging to EC 3.2.1.101 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 34 and 136.

In some embodiments, proteins of the present disclosure exhibit endogalactosaminidase activity belonging to EC 3.2.1.109 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 35-40 and 137-138.

In some embodiments, proteins of the present disclosure exhibit chitosanase activity belonging to EC 3.2.1.132 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 139-140.

In some embodiments, proteins of the present disclosure exhibit glucan 1,4-alpha-maltohydrolase activity belonging to EC 3.2.1.133 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 41.

In some embodiments, proteins of the present disclosure exhibit 1,4-beta-cellobiosidase activity belonging to EC 3.2.1.176 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 142-143.

In some embodiments, proteins of the present disclosure exhibit one or more peptidase activities belonging to EC 3.4, such as aminopeptidase activities belonging to EC 3.4.11 (e.g., leucyl aminopeptidase activity belong to EC 3.4.11.1), serine endopeptidase activities belonging to EC 3.4.21 (e.g., glutamyl endopeptidase activity belonging to EC 3.4.21.19 and/or subtilisin activity belonging to 3.4.21.62) and metalloendopeptidase activity belonging to EC 3.4.24 (e.g., bacillolysin activity belonging to EC 3.4.24.28).

In some embodiments, proteins of the present disclosure exhibit peptidase activity belonging to EC 3.4 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-48.

In some embodiments, proteins of the present disclosure exhibit serine endoprotease activity belonging to EC 3.4.21 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-48 and 144-145.

In some embodiments, proteins of the present disclosure exhibit glutamyl endoprotease activity belonging to EC 3.4.21.19 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 43.

In some embodiments, proteins of the present disclosure exhibit subtilisin activity belonging to EC 3.4.21.62 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 44-47 and 145.

In some embodiments, proteins of the present disclosure exhibit metalloendopeptidase activity belonging to EC 3.4.24 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 48.

In some embodiments, proteins of the present disclosure exhibit bacillolysin activity belonging to EC 3.4.24.28 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequences set forth herein as SEQ ID NO: 48.

In some embodiments, proteins of the present disclosure exhibit one or more hydrolase activities belonging to EC 3.5, such as amidohydrolase and amidase activities belonging to EC 3.5.1 (e.g., asparaginase activity belong to EC 3.5.1.1, glutaminase activities belonging to 3.5.1.2, amidase activities belonging to 3.5.1.4, urease activities belonging to 3.5.1.5, biotinidase activities belonging to 3.5.1.12, nicotinamidase activities belonging to 3.5.1.19, D-glutaminase activities belonging to 3.5.1.35, glutamin-(asparagin-)ase activities belonging to 3.5.1.38, chitin deacetylase activities belonging to 3.5.1.41, peptidyl-glutaminase activities belonging to 3.5.1.43, protein-glutamine glutaminase activities belonging to 3.5.1.44, pentanamidase activities belonging to 3.5.1.50).

In some embodiments, proteins of the present disclosure exhibit hydrolase activity belonging to EC 3.5 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 146-148.

In some embodiments, proteins of the present disclosure exhibit deacetylase activity belonging to EC 3.5.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-48 and 146-148.

In some embodiments, proteins of the present disclosure exhibit asparaginase activity belonging to EC 3.5.1.1 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 148.

In some embodiments, proteins of the present disclosure exhibit one or more lyase activities belonging to EC 4. For example, in some embodiments, proteins of the present disclosure exhibit lyase activity useful for preventing, treating, suppressing, eliminating and/or reducing the severity of infestations/infections of/by pests, such as acarids, bacteria, fungi, gastropods, insects, nematodes, oomycetes and protozoa.

In some embodiments, proteins of the present disclosure exhibit one or more lyase activities belonging to EC 4.2, such as polysaccharide lyase activities belonging to EC 4.2.2 (e.g., pectate lyase activity belong to EC 4.2.2.2, pectin lyase activity belonging to EC 4.2.2.10, glucan lyase activity belonging to EC 4.2.2.13, gellan lyase activity belonging to EC 4.2.2.25, oligo-alginase lyase activity belonging to EC 4.2.2.26, pectin monosaccharide-lyase activity belonging to EC 4.2.2.27).

In some embodiments, proteins of the present disclosure exhibit lyase activity belonging to EC 4.2 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 149.

In some embodiments, proteins of the present disclosure exhibit polysaccharide lyase activity belonging to EC 4.2.2 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 149.

In some embodiments, proteins of the present disclosure exhibit pectate lyase activity belonging to EC 4.2.2.2 and, optionally, comprise, consist essentially of, or consist of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to the amino acid sequence set forth herein as SEQ ID NO: 149.

It is to be understood that the present disclosure extends to proteins capable of exhibiting two, three, four, five or more distinct catalytic activities (e.g., a fusion protein comprising a first polypeptide having a first catalytic activity and a second polypeptide having a second catalytic activity).

It is to be further understood that proteins of the present disclosure needn't be toxic to be effective. As will be explained in further detail below, proteins of the present disclosure may exert their effects through various non-lethal means, such as reducing the attraction of a pest to a treated surface by degrading a food source, for example. Moreover, in many instances, otherwise toxic proteins of the present disclosure may be used in non-lethal doses to enhance the efficacy of and/or expand the target pest range of various chemical pesticides and biological pesticides.

Table 1 provides a non-exhaustive list of proteins useful for preventing, treating, suppressing, eliminating and/or reducing the severity of infestations/infections of/by one or more pests, such as acarids, bacteria, fungi, insects, nematodes, oomycetes and protozoa.

TABLE 1
Exemplary proteins of the present disclosure

| | | | Poly- | Poly- |
|---|---|---|---|---|
| | | | peptide | nucleotide |
| NZ | | | SEQ | SEQ |
| # | Enzyme Class | EC # | ID NO: | ID NO: |
| 1 | glucose oxidase | 1.1.3.4 | 1 | 49 |
| 2 | glucose oxidase | 1.1.3.4 | 2 | 50 |
| 3 | glucose oxidase | 1.1.3.4 | 3 | 51 |
| 4 | glucose oxidase | 1.1.3.4 | 4 | 52 |
| 5 | glucose oxidase | 1.1.3.4 | 5 | 53 |
| 6 | cellobiose oxidase | 1.1.3.25 | 6 | 54 |
| 7 | cellobiose oxidase | 1.1.3.25 | 7 | 55 |
| 8 | cellobiose oxidase | 1.1.3.25 | 8 | 56 |
| 9 | laccase | 1.10.3.2 | 9 | 57 |
| 10 | catalase | 1.11.1.6 | 10 | 58 |
| 11 | catalase | 1.11.1.6 | 11 | 59 |
| 11 | catalase | 1.11.1.6 | 11 | 60 |
| 12 | peroxidase | 1.11.1.7 | 12 | 61 |
| 99 | lytic cellulose monooxygenase | 1.14.99.56 | 99 | 152 |
| 100 | triacylglycerol lipase | 3.1.1.3 | 100 | 153 |
| 101 | triacylglycerol lipase | 3.1.1.3 | 101 | 154 |
| 102 | triacylglycerol lipase | 3.1.1.3 | 102 | 155 |
| 103 | triacylglycerol lipase | 3.1.1.3 | 103 | 156 |
| 13 | lysophospholipase | 3.1.1.5 | 13 | 62 |
| 105 | pectinesterase | 3.1.1.11 | 105 | 158 |
| 14 | alpha-amylase | 3.2.1.1 | 14 | 63 |
| 15 | alpha-amylase | 3.2.1.1 | 15 | 64 |
| 16 | alpha-amylase | 3.2.1.1 | 16 | 65 |
| 109 | alpha-amylase | 3.2.1.1 | 109 | 162 |
| 110 | alpha-amylase | 3.2.1.1 | 110 | 163 |
| 111 | alpha-amylase | 3.2.1.1 | 111 | 164 |
| 17 | glucan 1,4-alpha-glucosidase | 3.2.1.3 | 17 | 66 |
| 18 | glucan 1,4-alpha-glucosidase | 3.2.1.3 | 18 | 67 |
| 19 | cellulase | 3.2.1.4 | 19 | 68 |
| 114 | cellulase | 3.2.1.4 | 114 | 167 |
| 116 | cellulase | 3.2.1.4 | 116 | 169 |
| 20 | endo-1,3(4)-beta-glucanase | 3.2.1.6 | 20 | 69 |
| 117 | inulinase | 3.2.1.7 | 117 | 170 |
| 21 | endo-1,4-beta-xylanase | 3.2.1.8 | 21 | 70 |
| 22 | endo-1,4-beta-xylanase | 3.2.1.8 | 22 | 71 |
| 23 | endo-1,4-beta-xylanase | 3.2.1.8 | 23 | 72 |
| 24 | endo-1,4-beta-xylanase | 3.2.1.8 | 24 | 73 |
| 119 | endo-1,4-beta-xylanase | 3.2.1.8 | 119 | 172 |
| 25 | dextranase | 3.2.1.11 | 25 | 74 |
| 125 | endo-polygalacturonase | 3.2.1.15 | 125 | 178 |
| | (pectinase) | | | |
| 26 | lysozyme | 3.2.1.17 | 26 | 75 |
| 126 | beta-glucosidase | 3.2.1.21 | 126 | 179 |
| 27 | glucan endo-1,3-beta- | 3.2.1.39 | 27 | 76 |
| | glucosidase | | | |
| 28 | glucan endo-1,3-beta- | 3.2.1.39 | 28 | 77 |
| | glucosidase | | | |
| 29 | pullulanase | 3.2.1.41 | 29 | 78 |
| 129 | alpha-L-arabinofuranosidase | 3.2.1.55 | 129 | 182 |
| 30 | glucan endo-1,3-alpha- | 3.2.1.59 | 30 | 79 |
| | glucosidase | | | |
| 132 | licheninase | 3.2.1.73 | 132 | 185 |
| 31 | glucan endo-1,6-beta- | 3.2.1.75 | 31 | 80 |
| | glucosidase | | | |
| 32 | glucan endo-1,6-beta- | 3.2.1.75 | 32 | 81 |
| | glucosidase | | | |
| 33 | mannan endo-1,4-beta- | 3.2.1.78 | 33 | 82 |
| | mannosidase | | | |
| 34 | mannan endo-1,6-alpha- | 3.2.1.101 | 34 | 83 |
| | mannosidase | | | |
| 35 | endogalactosaminidase | 3.2.1.109 | 35 | 84 |
| 36 | endogalactosaminidase | 3.2.1.109 | 36 | 85 |
| 37 | endogalactosaminidase | 3.2.1.109 | 37 | 86 |
| 38 | endogalactosaminidase | 3.2.1.109 | 38 | 87 |
| 39 | endogalactosaminidase | 3.2.1.109 | 39 | 88 |
| 40 | endogalactosaminidase | 3.2.1.109 | 40 | 89 |
| 41 | glucan 1,4-alpha-maltohydrolase | 3.2.1.133 | 41 | 90 |
| 42 | serine endopeptidase | 3.4.21 | 42 | 91 |
| 43 | glutamyl endopeptidase | 3.4.21.19 | 43 | 92 |
| 44 | subtilisin | 3.4.21.62 | 44 | 93 |
| 45 | subtilisin | 3.4.21.62 | 45 | 94 |
| 46 | subtilisin | 3.4.21.62 | 46 | 95 |
| 47 | subtilisin | 3.4.21.62 | 47 | 96 |
| 48 | bacillolycin | 3.4.24.28 | 48 | 97 |
| 149 | pectate lyase | 4.2.2.2 | 149 | 202 |

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 1;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 1;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 49 or the cDNA sequence thereof;
d) a polypeptide derived from SEQ ID NO: 1 by substitution, deletion or insertion of one or more amino acids;
e) a polypeptide derived from a mature polypeptide of SEQ ID NO: 1 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 2;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 2;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 50 or the cDNA sequence thereof;
d) a polypeptide derived from SEQ ID NO: 2 by substitution, deletion or insertion of one or more amino acids;
e) a polypeptide derived from a mature polypeptide of SEQ ID NO: 2 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 3;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 3;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 51 or the cDNA sequence thereof;
d) a polypeptide derived from SEQ ID NO: 3 by substitution, deletion or insertion of one or more amino acids;
e) a polypeptide derived from a mature polypeptide of SEQ ID NO: 3 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 4;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 4;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 52 or the cDNA sequence thereof;
d) a polypeptide derived from SEQ ID NO: 4 by substitution, deletion or insertion of one or more amino acids;
e) a polypeptide derived from a mature polypeptide of SEQ ID NO: 4 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 5;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 5;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 53 or the cDNA sequence thereof;
d) a polypeptide derived from SEQ ID NO: 5 by substitution, deletion or insertion of one or more amino acids;
e) a polypeptide derived from a mature polypeptide of SEQ ID NO: 5 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 6;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 6;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 54 or the cDNA sequence thereof;
d) a polypeptide derived from SEQ ID NO: 6 by substitution, deletion or insertion of one or more amino acids;
e) a polypeptide derived from a mature polypeptide of SEQ ID NO: 6 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f) wherein the polypeptide has cellobiose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 7;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 7;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 55 or the cDNA sequence thereof;
d) a polypeptide derived from SEQ ID NO: 7 by substitution, deletion or insertion of one or more amino acids;
e) a polypeptide derived from a mature polypeptide of SEQ ID NO: 7 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has cellobiose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 8;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 8;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 56 or the cDNA sequence thereof;
d) a polypeptide derived from SEQ ID NO: 8 by substitution, deletion or insertion of one or more amino acids;
e) a polypeptide derived from a mature polypeptide of SEQ ID NO: 8 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f) wherein the polypeptide has cellobiose oxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 9;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 9;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 57 or the cDNA sequence thereof;
d) a polypeptide derived from SEQ ID NO: 9 by substitution, deletion or insertion of one or more amino acids;
e) a polypeptide derived from a mature polypeptide of SEQ ID NO: 9 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has laccase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 10;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 10;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 58 or the cDNA sequence thereof;
d) a polypeptide derived from SEQ ID NO: 10 by substitution, deletion or insertion of one or more amino acids;
e) a polypeptide derived from a mature polypeptide of SEQ ID NO: 10 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has catalase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 11;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 11;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 59 or the cDNA sequence thereof;
d) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 60 or the cDNA sequence thereof;
e) a polypeptide derived from SEQ ID NO: 11 by substitution, deletion or insertion of one or more amino acids;
f) a polypeptide derived from a mature polypeptide of SEQ ID NO: 11 by substitution, deletion or insertion of one or more amino acids;
g) a polypeptide derived from the polypeptide of any one of a) through f) wherein the N- and/or C-terminal end has been extended by the addition of one or more amino acids; and
h) a fragment of the polypeptide of any one of a) through g)
   wherein the polypeptide has catalase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 12;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 12;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 61 or the cDNA sequence thereof;
d) a polypeptide derived from SEQ ID NO: 12 by substitution, deletion or insertion of one or more amino acids;
e) a polypeptide derived from a mature polypeptide of SEQ ID NO: 12 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has peroxidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 13;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 13;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 62 or the cDNA sequence thereof;
d) a polypeptide derived from SEQ ID NO: 13 by substitution, deletion or insertion of one or more amino acids;
e) a polypeptide derived from a mature polypeptide of SEQ ID NO: 13 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has lysophospholipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 14;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 14;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 63 or the cDNA sequence thereof;
d) a polypeptide derived from SEQ ID NO: 14 by substitution, deletion or insertion of one or more amino acids;
e) a polypeptide derived from a mature polypeptide of SEQ ID NO: 14 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 15;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 15;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 64 or the cDNA sequence thereof;
d) a polypeptide derived from SEQ ID NO: 15 by substitution, deletion or insertion of one or more amino acids;
e) a polypeptide derived from a mature polypeptide of SEQ ID NO: 15 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 16;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 16;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 65 or the cDNA sequence thereof;
d) a polypeptide derived from SEQ ID NO: 16 by substitution, deletion or insertion of one or more amino acids;
e) a polypeptide derived from a mature polypeptide of SEQ ID NO: 16 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 17;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 17;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 66 or the cDNA sequence thereof;
d) a polypeptide derived from SEQ ID NO: 17 by substitution, deletion or insertion of one or more amino acids;
e) a polypeptide derived from a mature polypeptide of SEQ ID NO: 17 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 18;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 18;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 67 or the cDNA sequence thereof;
d) a polypeptide derived from SEQ ID NO: 18 by substitution, deletion or insertion of one or more amino acids;
e) a polypeptide derived from a mature polypeptide of SEQ ID NO: 18 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f) wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 19;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 19;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 68 or the cDNA sequence thereof;
d) a polypeptide derived from SEQ ID NO: 19 by substitution, deletion or insertion of one or more amino acids;
e) a polypeptide derived from a mature polypeptide of SEQ ID NO: 19 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has cellulase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 20;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 20;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 69 or the cDNA sequence thereof;
d) a polypeptide derived from SEQ ID NO: 20 by substitution, deletion or insertion of one or more amino acids;
e) a polypeptide derived from a mature polypeptide of SEQ ID NO: 20 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,3(4)-beta-glucanse activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 21;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 21;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 70 or the cDNA sequence thereof;
d) a polypeptide derived from SEQ ID NO: 21 by substitution, deletion or insertion of one or more amino acids;
e) a polypeptide derived from a mature polypeptide of SEQ ID NO: 21 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 22;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 22;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 71 or the cDNA sequence thereof;
d) a polypeptide derived from SEQ ID NO: 22 by substitution, deletion or insertion of one or more amino acids;
e) a polypeptide derived from a mature polypeptide of SEQ ID NO: 22 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 23;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 23;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 72 or the cDNA sequence thereof;
d) a polypeptide derived from SEQ ID NO: 23 by substitution, deletion or insertion of one or more amino acids;
e) a polypeptide derived from a mature polypeptide of SEQ ID NO: 23 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 24;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 24;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 73 or the cDNA sequence thereof;
d) a polypeptide derived from SEQ ID NO: 24 by substitution, deletion or insertion of one or more amino acids;
e) a polypeptide derived from a mature polypeptide of SEQ ID NO: 24 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 25;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 25;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 74 or the cDNA sequence thereof;
d) a polypeptide derived from SEQ ID NO: 25 by substitution, deletion or insertion of one or more amino acids;
e) a polypeptide derived from a mature polypeptide of SEQ ID NO: 25 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has dextranase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 26;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 26;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 75 or the cDNA sequence thereof;
d) a polypeptide derived from SEQ ID NO: 26 by substitution, deletion or insertion of one or more amino acids;
e) a polypeptide derived from a mature polypeptide of SEQ ID NO: 26 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has lysozyme activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 27;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 27;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 76 or the cDNA sequence thereof;
d) a polypeptide derived from SEQ ID NO: 27 by substitution, deletion or insertion of one or more amino acids;
e) a polypeptide derived from a mature polypeptide of SEQ ID NO: 27 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 28;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 28;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 77 or the cDNA sequence thereof;
d) a polypeptide derived from SEQ ID NO: 28 by substitution, deletion or insertion of one or more amino acids;
e) a polypeptide derived from a mature polypeptide of SEQ ID NO: 28 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 29;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 29;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 78 or the cDNA sequence thereof;
d) a polypeptide derived from SEQ ID NO: 29 by substitution, deletion or insertion of one or more amino acids;
e) a polypeptide derived from a mature polypeptide of SEQ ID NO: 29 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has pullulanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 30;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 30;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 79 or the cDNA sequence thereof;
d) a polypeptide derived from SEQ ID NO: 30 by substitution, deletion or insertion of one or more amino acids;
e) a polypeptide derived from a mature polypeptide of SEQ ID NO: 30 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-alpha-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 31;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 31;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 80 or the cDNA sequence thereof;
d) a polypeptide derived from SEQ ID NO: 31 by substitution, deletion or insertion of one or more amino acids;
e) a polypeptide derived from a mature polypeptide of SEQ ID NO: 31 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,6-beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 32;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 32;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 81 or the cDNA sequence thereof;
d) a polypeptide derived from SEQ ID NO: 32 by substitution, deletion or insertion of one or more amino acids;
e) a polypeptide derived from a mature polypeptide of SEQ ID NO: 32 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,6-beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 33;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 33;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 82 or the cDNA sequence thereof;
d) a polypeptide derived from SEQ ID NO: 33 by substitution, deletion or insertion of one or more amino acids;
e) a polypeptide derived from a mature polypeptide of SEQ ID NO: 33 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has mannan endo-1,4-beta-gluco-mannosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 34;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 34;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 83 or the cDNA sequence thereof;
d) a polypeptide derived from SEQ ID NO: 34 by substitution, deletion or insertion of one or more amino acids;
e) a polypeptide derived from a mature polypeptide of SEQ ID NO: 34 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has mannan endo-1,6-alpha-gluco-mannosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 35;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 35;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 84 or the cDNA sequence thereof;
d) a polypeptide derived from SEQ ID NO: 35 by substitution, deletion or insertion of one or more amino acids;
e) a polypeptide derived from a mature polypeptide of SEQ ID NO: 35 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 36;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 36;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 85 or the cDNA sequence thereof;
d) a polypeptide derived from SEQ ID NO: 36 by substitution, deletion or insertion of one or more amino acids;
e) a polypeptide derived from a mature polypeptide of SEQ ID NO: 36 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 37;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 37;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 86 or the cDNA sequence thereof;
d) a polypeptide derived from SEQ ID NO: 37 by substitution, deletion or insertion of one or more amino acids;
e) a polypeptide derived from a mature polypeptide of SEQ ID NO: 37 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 38;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 38;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 87 or the cDNA sequence thereof;
d) a polypeptide derived from SEQ ID NO: 38 by substitution, deletion or insertion of one or more amino acids;
e) a polypeptide derived from a mature polypeptide of SEQ ID NO: 38 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 39;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 39;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 88 or the cDNA sequence thereof;
d) a polypeptide derived from SEQ ID NO: 39 by substitution, deletion or insertion of one or more amino acids;
e) a polypeptide derived from a mature polypeptide of SEQ ID NO: 39 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 40;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 40;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 89 or the cDNA sequence thereof;
d) a polypeptide derived from SEQ ID NO: 40 by substitution, deletion or insertion of one or more amino acids;
e) a polypeptide derived from a mature polypeptide of SEQ ID NO: 40 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 41;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 41;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 90 or the cDNA sequence thereof;
d) a polypeptide derived from SEQ ID NO: 41 by substitution, deletion or insertion of one or more amino acids;
e) a polypeptide derived from a mature polypeptide of SEQ ID NO: 41 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan 1,4-alpha-maltohydrolase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 42;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 42;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 91 or the cDNA sequence thereof;
d) a polypeptide derived from SEQ ID NO: 42 by substitution, deletion or insertion of one or more amino acids;
e) a polypeptide derived from a mature polypeptide of SEQ ID NO: 42 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has serine endopeptidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 43;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 43;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 92 or the cDNA sequence thereof;
d) a polypeptide derived from SEQ ID NO: 43 by substitution, deletion or insertion of one or more amino acids;
e) a polypeptide derived from a mature polypeptide of SEQ ID NO: 43 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glutamyl endopeptidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 44;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 44;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 93 or the cDNA sequence thereof;
d) a polypeptide derived from SEQ ID NO: 44 by substitution, deletion or insertion of one or more amino acids;
e) a polypeptide derived from a mature polypeptide of SEQ ID NO: 44 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has subtilisin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 45;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 45;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 94 or the cDNA sequence thereof;
d) a polypeptide derived from SEQ ID NO: 45 by substitution, deletion or insertion of one or more amino acids;
e) a polypeptide derived from a mature polypeptide of SEQ ID NO: 45 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has subtilisin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 46;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 46;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 95 or the cDNA sequence thereof;
d) a polypeptide derived from SEQ ID NO: 46 by substitution, deletion or insertion of one or more amino acids;
e) a polypeptide derived from a mature polypeptide of SEQ ID NO: 46 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has subtilisin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 47;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 47;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 96 or the cDNA sequence thereof;
d) a polypeptide derived from SEQ ID NO: 47 by substitution, deletion or insertion of one or more amino acids;
e) a polypeptide derived from a mature polypeptide of SEQ ID NO: 47 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has subtilisin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 48;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 48;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 97 or the cDNA sequence thereof;
d) a polypeptide derived from SEQ ID NO: 48 by substitution, deletion or insertion of one or more amino acids;
e) a polypeptide derived from a mature polypeptide of SEQ ID NO: 48 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has bacillolysin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 98;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 98;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 151 or the cDNA sequence thereof;
d) a polypeptide derived from SEQ ID NO: 98 by substitution, deletion or insertion of one or more amino acids;
e) a polypeptide derived from a mature polypeptide of SEQ ID NO: 98 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has lytic cellulose monooxygenase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 99;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 99;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 152 or the cDNA sequence thereof;
d) a polypeptide derived from SEQ ID NO: 99 by substitution, deletion or insertion of one or more amino acids;
e) a polypeptide derived from a mature polypeptide of SEQ ID NO: 99 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has lytic cellulose monooxygenase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 100;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 100;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 153 or the cDNA sequence thereof;
d) a polypeptide derived from SEQ ID NO: 100 by substitution, deletion or insertion of one or more amino acids;
e) a polypeptide derived from a mature polypeptide of SEQ ID NO: 100 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 101;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 101;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 154 or the cDNA sequence thereof;
d) a polypeptide derived from SEQ ID NO: 101 by substitution, deletion or insertion of one or more amino acids;
e) a polypeptide derived from a mature polypeptide of SEQ ID NO: 101 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 102;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 102;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 155 or the cDNA sequence thereof;
d) a polypeptide derived from SEQ ID NO: 102 by substitution, deletion or insertion of one or more amino acids;
e) a polypeptide derived from a mature polypeptide of SEQ ID NO: 102 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 103;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 103;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 156 or the cDNA sequence thereof;
d) a polypeptide derived from SEQ ID NO: 103 by substitution, deletion or insertion of one or more amino acids;
e) a polypeptide derived from a mature polypeptide of SEQ ID NO: 6 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has triacylglycerol lipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 104;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 104;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 157 or the cDNA sequence thereof;
d) a polypeptide derived from SEQ ID NO: 104 by substitution, deletion or insertion of one or more amino acids;
e) a polypeptide derived from a mature polypeptide of SEQ ID NO: 104 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has lysophospholipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 105;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 105;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 158 or the cDNA sequence thereof;
d) a polypeptide derived from SEQ ID NO: 105 by substitution, deletion or insertion of one or more amino acids;
e) a polypeptide derived from a mature polypeptide of SEQ ID NO: 105 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has pectinesterase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 106;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 106;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 159 or the cDNA sequence thereof;
d) a polypeptide derived from SEQ ID NO: 106 by substitution, deletion or insertion of one or more amino acids;
e) a polypeptide derived from a mature polypeptide of SEQ ID NO: 106 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has phospholipase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 107;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 107;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 160 or the cDNA sequence thereof;
d) a polypeptide derived from SEQ ID NO: 107 by substitution, deletion or insertion of one or more amino acids;
e) a polypeptide derived from a mature polypeptide of SEQ ID NO: 107 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has phospholipase C activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 108;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 108;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 59 or the cDNA sequence thereof;
d) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 161 or the cDNA sequence thereof;
e) a polypeptide derived from SEQ ID NO: 108 by substitution, deletion or insertion of one or more amino acids;
f) a polypeptide derived from a mature polypeptide of SEQ ID NO: 108 by substitution, deletion or insertion of one or more amino acids;
g) a polypeptide derived from the polypeptide of any one of a) through f) wherein the N- and/or C-terminal end has been extended by the addition of one or more amino acids; and
h) a fragment of the polypeptide of any one of a) through g)
   wherein the polypeptide has phoshoinositide phospholipase C activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 109;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 109;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 162 or the cDNA sequence thereof;
d) a polypeptide derived from SEQ ID NO: 109 by substitution, deletion or insertion of one or more amino acids;
e) a polypeptide derived from a mature polypeptide of SEQ ID NO: 109 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 110;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 110;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 163 or the cDNA sequence thereof;
d) a polypeptide derived from SEQ ID NO: 110 by substitution, deletion or insertion of one or more amino acids;
e) a polypeptide derived from a mature polypeptide of SEQ ID NO: 110 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 111;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 111;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 164 or the cDNA sequence thereof;
d) a polypeptide derived from SEQ ID NO: 111 by substitution, deletion or insertion of one or more amino acids;
e) a polypeptide derived from a mature polypeptide of SEQ ID NO: 111 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 112;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 112;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 165 or the cDNA sequence thereof;
d) a polypeptide derived from SEQ ID NO: 112 by substitution, deletion or insertion of one or more amino acids;
e) a polypeptide derived from a mature polypeptide of SEQ ID NO: 12 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 113;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 113;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 166 or the cDNA sequence thereof;
d) a polypeptide derived from SEQ ID NO: 113 by substitution, deletion or insertion of one or more amino acids;
e) a polypeptide derived from a mature polypeptide of SEQ ID NO: 113 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-amylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 114;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 114;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 167 or the cDNA sequence thereof;
d) a polypeptide derived from SEQ ID NO: 114 by substitution, deletion or insertion of one or more amino acids;
e) a polypeptide derived from a mature polypeptide of SEQ ID NO: 114 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has cellulase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 115;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 115;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 168 or the cDNA sequence thereof;
d) a polypeptide derived from SEQ ID NO: 115 by substitution, deletion or insertion of one or more amino acids;
e) a polypeptide derived from a mature polypeptide of SEQ ID NO: 115 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has cellulase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 116;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 116;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 169 or the cDNA sequence thereof;
d) a polypeptide derived from SEQ ID NO: 116 by substitution, deletion or insertion of one or more amino acids;
e) a polypeptide derived from a mature polypeptide of SEQ ID NO: 116 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has cellulase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 117;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 117;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 170 or the cDNA sequence thereof;
d) a polypeptide derived from SEQ ID NO: 117 by substitution, deletion or insertion of one or more amino acids;
e) a polypeptide derived from a mature polypeptide of SEQ ID NO: 117 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has inulinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 118;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 118;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 171 or the cDNA sequence thereof;
d) a polypeptide derived from SEQ ID NO: 118 by substitution, deletion or insertion of one or more amino acids;
e) a polypeptide derived from a mature polypeptide of SEQ ID NO: 118 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 119;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 119;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 172 or the cDNA sequence thereof;
d) a polypeptide derived from SEQ ID NO: 119 by substitution, deletion or insertion of one or more amino acids;
e) a polypeptide derived from a mature polypeptide of SEQ ID NO: 119 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 120;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 120;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 173 or the cDNA sequence thereof;
d) a polypeptide derived from SEQ ID NO: 120 by substitution, deletion or insertion of one or more amino acids;
e) a polypeptide derived from a mature polypeptide of SEQ ID NO: 120 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,4-beta-xylanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 121;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 121;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 174 or the cDNA sequence thereof;
d) a polypeptide derived from SEQ ID NO: 121 by substitution, deletion or insertion of one or more amino acids;
e) a polypeptide derived from a mature polypeptide of SEQ ID NO: 121 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 122;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 122;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 175 or the cDNA sequence thereof;
d) a polypeptide derived from SEQ ID NO: 122 by substitution, deletion or insertion of one or more amino acids;
e) a polypeptide derived from a mature polypeptide of SEQ ID NO: 122 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 123;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 123;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 176 or the cDNA sequence thereof;
d) a polypeptide derived from SEQ ID NO: 123 by substitution, deletion or insertion of one or more amino acids;
e) a polypeptide derived from a mature polypeptide of SEQ ID NO: 123 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 124;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 124;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 177 or the cDNA sequence thereof;
d) a polypeptide derived from SEQ ID NO: 124 by substitution, deletion or insertion of one or more amino acids;
e) a polypeptide derived from a mature polypeptide of SEQ ID NO: 124 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 125;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 125;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 178 or the cDNA sequence thereof;
d) a polypeptide derived from SEQ ID NO: 125 by substitution, deletion or insertion of one or more amino acids;
e) a polypeptide derived from a mature polypeptide of SEQ ID NO: 125 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-polygalacturonase (pectinase) activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 126;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 126;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 179 or the cDNA sequence thereof;
d) a polypeptide derived from SEQ ID NO: 126 by substitution, deletion or insertion of one or more amino acids;
e) a polypeptide derived from a mature polypeptide of SEQ ID NO: 126 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 127;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 127;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 180 or the cDNA sequence thereof;
d) a polypeptide derived from SEQ ID NO: 127 by substitution, deletion or insertion of one or more amino acids;
e) a polypeptide derived from a mature polypeptide of SEQ ID NO: 127 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has xylan 1,4-beta-xylosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 128;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 128;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 181 or the cDNA sequence thereof;
d) a polypeptide derived from SEQ ID NO: 128 by substitution, deletion or insertion of one or more amino acids;
e) a polypeptide derived from a mature polypeptide of SEQ ID NO: 128 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-beta-D-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 129;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 129;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 182 or the cDNA sequence thereof;
d) a polypeptide derived from SEQ ID NO: 129 by substitution, deletion or insertion of one or more amino acids;
e) a polypeptide derived from a mature polypeptide of SEQ ID NO: 129 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has alpha-L-arabinofuranosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 130;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 130;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 183 or the cDNA sequence thereof;
d) a polypeptide derived from SEQ ID NO: 130 by substitution, deletion or insertion of one or more amino acids;
e) a polypeptide derived from a mature polypeptide of SEQ ID NO: 130 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-alpha-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 131;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 131;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 184 or the cDNA sequence thereof;
d) a polypeptide derived from SEQ ID NO: 131 by substitution, deletion or insertion of one or more amino acids;
e) a polypeptide derived from a mature polypeptide of SEQ ID NO: 132 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,3-alpha-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 132;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 132;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 185 or the cDNA sequence thereof;
d) a polypeptide derived from SEQ ID NO: 132 by substitution, deletion or insertion of one or more amino acids;
e) a polypeptide derived from a mature polypeptide of SEQ ID NO: 132 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has licheninase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 133;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 133;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 186 or the cDNA sequence thereof;
d) a polypeptide derived from SEQ ID NO: 133 by substitution, deletion or insertion of one or more amino acids;
e) a polypeptide derived from a mature polypeptide of SEQ ID NO: 133 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has glucan endo-1,6-beta-glucosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 134;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 134;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 187 or the cDNA sequence thereof;
d) a polypeptide derived from SEQ ID NO: 134 by substitution, deletion or insertion of one or more amino acids;
e) a polypeptide derived from a mature polypeptide of SEQ ID NO: 134 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has mannan endo-1,4-$-mannosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 135;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 135;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 188 or the cDNA sequence thereof;
d) a polypeptide derived from SEQ ID NO: 135 by substitution, deletion or insertion of one or more amino acids;
e) a polypeptide derived from a mature polypeptide of SEQ ID NO: 135 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has 1,4-beta-cellobiosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 136;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 136;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 189 or the cDNA sequence thereof;
d) a polypeptide derived from SEQ ID NO: 136 by substitution, deletion or insertion of one or more amino acids;
e) a polypeptide derived from a mature polypeptide of SEQ ID NO: 136 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has mannan endo-1,6-alpha-mannosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 137;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 137;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 190 or the cDNA sequence thereof;
d) a polypeptide derived from SEQ ID NO: 137 by substitution, deletion or insertion of one or more amino acids;
e) a polypeptide derived from a mature polypeptide of SEQ ID NO: 137 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 138;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 138;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 191 or the cDNA sequence thereof;
d) a polypeptide derived from SEQ ID NO: 138 by substitution, deletion or insertion of one or more amino acids;
e) a polypeptide derived from a mature polypeptide of SEQ ID NO: 138 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endogalactosaminidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 139;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 139;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 192 or the cDNA sequence thereof;
d) a polypeptide derived from SEQ ID NO: 139 by substitution, deletion or insertion of one or more amino acids;
e) a polypeptide derived from a mature polypeptide of SEQ ID NO: 139 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitosanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 140;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 140;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 193 or the cDNA sequence thereof;
d) a polypeptide derived from SEQ ID NO: 140 by substitution, deletion or insertion of one or more amino acids;
e) a polypeptide derived from a mature polypeptide of SEQ ID NO: 140 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitosanase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 141;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 141;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 194 or the cDNA sequence thereof;
d) a polypeptide derived from SEQ ID NO: 141 by substitution, deletion or insertion of one or more amino acids;
e) a polypeptide derived from a mature polypeptide of SEQ ID NO: 141 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has chitinase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 142;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 142;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 195 or the cDNA sequence thereof;
d) a polypeptide derived from SEQ ID NO: 142 by substitution, deletion or insertion of one or more amino acids;
e) a polypeptide derived from a mature polypeptide of SEQ ID NO: 142 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has 1,4-beta-cellobiosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 143;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 143;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 196 or the cDNA sequence thereof;
d) a polypeptide derived from SEQ ID NO: 143 by substitution, deletion or insertion of one or more amino acids;
e) a polypeptide derived from a mature polypeptide of SEQ ID NO: 143 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has 1,4-beta-cellobiosidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 144;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 144;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 197 or the cDNA sequence thereof;
d) a polypeptide derived from SEQ ID NO: 144 by substitution, deletion or insertion of one or more amino acids;
e) a polypeptide derived from a mature polypeptide of SEQ ID NO: 144 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has serine endopeptidase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 145;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 145;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 198 or the cDNA sequence thereof;
d) a polypeptide derived from SEQ ID NO: 145 by substitution, deletion or insertion of one or more amino acids;
e) a polypeptide derived from a mature polypeptide of SEQ ID NO: 145 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has subtilisin activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 146;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 146;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 199 or the cDNA sequence thereof;
d) a polypeptide derived from SEQ ID NO: 146 by substitution, deletion or insertion of one or more amino acids;
e) a polypeptide derived from a mature polypeptide of SEQ ID NO: 146 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has deacetylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 147;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 147;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 200 or the cDNA sequence thereof;
d) a polypeptide derived from SEQ ID NO: 147 by substitution, deletion or insertion of one or more amino acids;
e) a polypeptide derived from a mature polypeptide of SEQ ID NO: 147 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has deacetylase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 148;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 148;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 201 or the cDNA sequence thereof;
d) a polypeptide derived from SEQ ID NO: 148 by substitution, deletion or insertion of one or more amino acids;
e) a polypeptide derived from a mature polypeptide of SEQ ID NO: 148 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has asparaginase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 149;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 149;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 202 or the cDNA sequence thereof;
d) a polypeptide derived from SEQ ID NO: 149 by substitution, deletion or insertion of one or more amino acids;
e) a polypeptide derived from a mature polypeptide of SEQ ID NO: 149 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has pectate lyase activity.

In some embodiments, the protein is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 150;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of SEQ ID NO: 150;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to SEQ ID NO: 203 or the cDNA sequence thereof;
d) a polypeptide derived from SEQ ID NO: 150 by substitution, deletion or insertion of one or more amino acids;
e) a polypeptide derived from a mature polypeptide of SEQ ID NO: 150 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f)
   wherein the polypeptide has endo-1,3(4)-beta-glucanase activity.

In some embodiments, the protein comprises, consists essentially of, or consists of a wild-type polypeptide. For example, in some embodiments, the protein comprises, consists essentially of, or consists of a wild-type polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150 or a mature polypeptide thereof.

In some embodiments, the protein comprises, consists essentially of, or consists of a variant polypeptide. For example, in some embodiments, the protein comprises, consists essentially of, or consists of a variant polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150 or a mature polypeptide thereof.

In some embodiments, the protein comprises, consists essentially of or consists of a catalytic domain, a binding module and a linker between said catalytic domain and said binder module.

In some embodiments, the protein comprises two or more catalytic domains.

In some embodiments, the protein comprises two or more binding modules.

In some embodiments, the protein is a fusion protein comprising a first polypeptide and a second polypeptide, said second polypeptide being distinct from said first polypeptide, wherein said first polypeptide is selected from the group consisting of:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof; d) a polypeptide derived from any one of SEQ ID NOs: 1-48 and 98-150 by substitution, deletion or insertion of one or more amino acids;
e) a polypeptide derived from a mature polypeptide any one of SEQ ID NOs: 1-48 and 98-150 by substitution, deletion or insertion of one or more amino acids;
f) a polypeptide derived from the polypeptide of any one of a) through e) wherein the N- and/or C-terminal end has been extended by the addition of one or more amino acids; and
g) a fragment of the polypeptide of any one of a) through f), and, optionally, wherein said second polypeptide is selected from the group consisting of:
h) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150;
i) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150;
j) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof;
k) a polypeptide derived from any one of SEQ ID NOs: 1-48 and 98-150 by substitution, deletion or insertion of one or more amino acids;
l) a polypeptide derived from a mature polypeptide any one of SEQ ID NOs: 1-48 and 98-150 by substitution, deletion or insertion of one or more amino acids;
m) a polypeptide derived from the polypeptide of any one of h) through 1) wherein the N- and/or C-terminal end has been extended by the addition of one or more amino acids; and
n) a fragment of the polypeptide of any one of h) through m).

In preferred embodiments, proteins of the present disclosure comprise, consist essentially of or consist of the amino acid sequence of any one of SEQ ID NOs: 1-48 and 98-150 or a mature polypeptide thereof.

In preferred embodiments, proteins of the present disclosure are encoded by a polynucleotide that comprises, consists essentially of or consists of one of SEQ ID NOs: 49-97 and 151-203 or the cDNA thereof.

In some embodiments, proteins of the present disclosure comprise, consist essentially of or consist of a fragment of one of SEQ ID NOs: 1-48 and 98-150 or a mature peptide thereof. For example, the protein may be a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

As noted above, in some embodiments, proteins of the present disclosure comprise, consist essentially of or consist of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant molecules are tested for catalytic activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide, and/or be inferred from sequence homology and conserved catalytic machinery with a related polypeptide or within a polypeptide or protein family with polypeptides/proteins descending from a common ancestor, typically having similar three-dimensional structures, functions, and significant sequence similarity. Additionally or alternatively, protein structure prediction tools can be used for protein structure modelling to identify essential amino acids and/or active sites of polypeptides. See, for example, Jumper et al., 2021, “Highly accurate protein structure prediction with AlphaFold”, Nature 596: 583-589.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

In some embodiments, the protein is a fusion protein (e.g., a fusion protein comprising a first polypeptide having a first enzymatic activity and a second polypeptide having a second enzymatic activity).

In some embodiments, the protein is a hybrid protein.

In some embodiments, the protein is isolated.

In some embodiments, the protein is purified.

It is to be understood that proteins of the present disclosure may be obtained from microorganisms of any genus. For purposes of the present disclosure, the term “obtained from” as used herein in connection with a given source shall mean that the protein encoded by a polynucleotide is produced by the source or by a strain in which the polynucleotide of the disclosure has been inserted. In one aspect, the protein obtained from a given source is secreted extracellularly.

In some embodiments, the protein is obtained from a Gram-negative bacteria, such as Campylobacter, Dicytoglomus (e.g., D. thermophilum), Escherichia (e.g., E. coli), Flavobacterium, Fusobacterium, Helicobacter, Ilyobacter, Neisseria, Pseudomonas, Salmonella or Ureaplasma.

In some embodiments, the protein is obtained from a Gram-positive bacteria, such as Bacillus (e.g., B. agaradhaerens, Bacillus alkalophilus, Bacillus amyloliquefaciens, Bacillus brevis, Bacillus circulans, Bacillus clausii, Bacillus coagulans, B. deramificans, Bacillus firmus, Bacillus lautus, Bacillus lentus, Bacillus licheniformis, Bacillus megaterium, Bacillus pumilus, Bacillus stearothermophilus, Bacillus subtilis, Bacillus thuringiensis), Clostridium, Enterococcus, Geobacillus, Lactobacillus, Lactococcus, Oceanobacillus (e.g., O. barbara), Staphylococcus, Streptococcus (e.g., Streptococcus equisimilis, Streptococcus pyogenes, Streptococcus uberis, and Streptococcus equi subsp. Zooepidemicus) or Streptomyces (e.g., Streptomyces achromogenes, Streptomyces avermitilis, Streptomyces coelicolor, Streptomyces griseus, Streptomyces lividans).

In some embodiments, the protein is obtained from a fungus, such as Acremonium, Aspergillus (e.g., A. aculeatus, Aspergillus awamori, Aspergillus foetidus, Aspergillus fumigatus, Aspergillus japonicus, Aspergillus nidulans, Aspergillus niger, Aspergillus oryzae), Aureobasidium, Bjerkandera (e.g., Bjerkandera adusta), Ceriporiopsis (e.g., Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora), Chaetomium (e.g., C. erraticum), Chrysosporium (e.g., Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum), Coprinus (e.g., Coprinus cinereus), Coriolus (e.g., Coriolus hirsutus), Cryptococcus, Filibasidium, Fusarium (e.g., Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, F. solani, Fusarium sporotrichioides, Fusarium sulphureum, Fusarium torulosum, Fusarium trichothecioides, Fusarium venenatum), Humicola (e.g., Humicola insolens, Humicola lanuginosa), Magnaporthe, Microdochium (e.g., M. nivale), Mucor (e.g., Mucor miehei), Myceliophthora (e.g., Myceliophthora thermophila), Neocallimastix, Neurospora (e.g., Neurospora crassa), Paecilomyces, Penicillium (e.g., Penicillium purpurogenum), Phanerochaete (e.g., Phanerochaete chrysosporium), Phlebia (e.g., Phlebia radiata), Piromyces, Pleurotus (e.g., Pleurotus eryngii), Schizophyllum, Talaromyces (e.g., Talaromyces emersonii), Thermoascus (e.g., T. aurantiacus), Thielavia (e.g., Thielavia terrestris), Tolypocladium, Trametes (e.g., Trametes villosa, Trametes versicolor), or Trichoderma (e.g., T. atroviride, Trichoderma harzianum, Trichoderma koningii, Trichoderma longibrachiatum, Trichoderma reesei, Trichoderma viride).

In some embodiments, the protein is obtained from a yeast, such as Candida, Hansenula, Kluyveromyces (e.g., Kluyveromyces lactis), Pichia, Saccharomyces (e.g., Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis), Schizosaccharomyces, or Yarrowia (e.g., Yarrowia lipolytica).

It will be understood that for the aforementioned species, the disclosure encompasses both the perfect and imperfect states, and other taxonomic equivalents, e.g., anamorphs, regardless of the species name by which they are known. Those skilled in the art will readily recognize the identity of appropriate equivalents.

The proteins may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding the protein may then be obtained by similarly screening a genomic DNA or cDNA library of another microorganism or mixed DNA sample. Once a polynucleotide encoding a protein has been detected with the probe(s), the polynucleotide can be isolated or cloned by utilizing techniques that are known to those of ordinary skill in the art (see, e.g., Davis et al., 2012, Basic Methods in Molecular Biology, Elsevier).

It is to be understood that proteins of the present disclosure may be produced using any suitable method(s), including, but not limited to, shake flask cultivation and large-scale fermentation (including continuous, batch, fed-batch, solid-state and/or microcarrier-based fermentation) methods.

The present disclosure extends to methods of producing a protein of the present disclosure, comprising (a) cultivating a cell, which in its wild-type form produces the protein, under conditions conducive for production of the protein; and optionally, (b) recovering the protein.

In some embodiments, the cell is a Gram-negative bacterial cell, such as Campylobacter, Escherichia (e.g., E. coli), Flavobacterium, Fusobacterium, Helicobacter, Ilyobacter, Neisseria, Pseudomonas, Salmonella or Ureaplasma.

In some embodiments, the cell is a Gram-positive bacterial cell, such as Bacillus (e.g., Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, Bacillus thuringiensis), Clostridium, Enterococcus, Geobacillus, Lactobacillus, Lactococcus, Oceanobacillus, Staphylococcus, Streptococcus (e.g., Streptococcus equisimilis, Streptococcus pyogenes, Streptococcus uberis, and Streptococcus equi subsp. Zooepidemicus) or Streptomyces (e.g., Streptomyces achromogenes, Streptomyces avermitilis, Streptomyces coelicolor, Streptomyces griseus, Streptomyces lividans).

In some embodiments, the cell is a fungal cell, such as Acremonium, Aspergillus (e.g., Aspergillus awamori, Aspergillus foetidus, Aspergillus fumigatus, Aspergillus japonicus, Aspergillus nidulans, Aspergillus niger, Aspergillus oryzae), Aureobasidium, Bjerkandera (e.g., Bjerkandera adusta), Ceriporiopsis (e.g., Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora), Chrysosporium (e.g., Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum), Coprinus (e.g., Coprinus cinereus), Coriolus (e.g., Coriolus hirsutus), Cryptococcus, Filibasidium, Fusarium (e.g., Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum), Humicola (e.g., Humicola insolens, Humicola lanuginosa), Magnaporthe, Mucor (e.g., Mucor miehei), Myceliophthora (e.g., Myceliophthora thermophila), Neocallimastix, Neurospora (e.g., Neurospora crassa), Paecilomyces, Penicillium (e.g., Penicillium purpurogenum), Phanerochaete (e.g., Phanerochaete chrysosporium), Phlebia (e.g., Phlebia radiata), Piromyces, Pleurotus (e.g., Pleurotus eryngii), Schizophyllum, Talaromyces (e.g., Talaromyces emersonii), Thermoascus, Thielavia (e.g., Thielavia terrestris), Tolypocladium, Trametes (e.g., Trametes villosa, Trametes versicolor), or Trichoderma (e.g., Trichoderma harzianum, Trichoderma koningii, Trichoderma longibrachiatum, Trichoderma reesei, Trichoderma viride).

In some embodiments, the cell is a yeast cell, such as Candida, Hansenula, Kluyveromyces (e.g., Kluyveromyces lactis), Pichia, Saccharomyces (e.g., Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis), Schizosaccharomyces, or Yarrowia (e.g., Yarrowia lipolytica).

The present disclosure also extends to methods of producing a protein of the present disclosure, comprising (a) cultivating a recombinant host cell of the present disclosure under conditions conducive for production of the protein; and optionally, (b) recovering the protein.

Cells are cultivated in a nutrient medium suitable for production of the protein using methods known in the art. For example, the cell may be cultivated by shake flask cultivation, or small-scale or large-scale fermentation (including continuous, batch, fed-batch, or solid-state, and/or microcarrier-based fermentations) in laboratory or industrial fermentors in a suitable medium and under conditions allowing the protein to be expressed and/or isolated. Suitable media are available from commercial suppliers or may be prepared according to published compositions (e.g., in catalogues of the American Type Culture Collection). If the protein is secreted into the nutrient medium, the protein can be recovered directly from the medium. If the protein is not secreted, it can be recovered from cell lysates.

The protein may be detected using methods known in the art that are specific for the protein, including, but not limited to, the use of specific antibodies, formation of an enzyme product, disappearance of an enzyme substrate, or an assay determining the relative or specific activity of the protein.

The protein may be recovered from the medium using methods known in the art, including, but not limited to, collection, centrifugation, filtration, extraction, spray-drying, evaporation, or precipitation. In one aspect, a whole fermentation broth comprising the protein is recovered. In another aspect, a cell-free fermentation broth comprising the protein is recovered.

The protein may be purified by a variety of procedures known in the art to obtain substantially pure proteins and/or protein fragments (see, e.g., Wingfield, 2015, Current Protocols in Protein Science; 80(1): 6.1.1-6.1.35; Labrou, 2014, Protein Downstream Processing, 1129: 3-10).

In an alternative aspect, the protein is not recovered.

Proteins of the present disclosure may be used to prevent and/or treat infestations/infections of/by horticultural pests at any time—including prior to planting, at the time of planting, after planting, prior to germination, after germination, prior to seedling emergence, at the time of seedling emergence, after seedling emergence, prior to the vegetative stage, during the vegetative stage, after the vegetative stage, prior to the reproductive stage, during the reproductive stage, after the reproductive stage, prior to flowering, at the time of flowering, after flowering, prior to fruiting, at the time of fruiting, after fruiting, prior to ripening, at the time of ripening, after ripening, prior to harvest, at the time of harvest, and after harvesting. Accordingly, proteins of the present disclosure may be formulated for use at any stage in the horticultural process and by any suitable method of application, including, but not limited to, on-seed application, in-furrow application, foliar application, preharvest application, and postharvest application.

Proteins of the present disclosure may be incorporated into formulations comprising any suitable carrier, including, but not limited to, seed-compatible carriers, soil-compatible carriers, foliar-compatible carriers, preharvest carriers, and postharvest carriers. Selection of appropriate carrier materials will depend on the intended application(s) and the protein(s) to be included in the formulation, as well as any other components that may be present in and/or added to the formulation. In some embodiments, the carrier is a liquid, a gel, a slurry, or a solid. In some embodiments, the carrier consists essentially of or consists of one or more protein-stabilizing compounds.

In some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 11, 12, 13, 14, 15, 16, 17, 18, 19, 20, 21, 22, 23, 24, 25% or more protein (i.e., total amount of one or more proteins of the present disclosure) w/w, based upon the total weight of the formulation. For example, in some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 11, 12, 13, 14, 15, 16, 17, 18, 19, 20, 21, 22, 23, 24, 25% w/w or more of one or more proteins selected from the group consisting of:
a) polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof;
b) polypeptides encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof;
c) polypeptides derived from any one of SEQ ID NOs: 1-48 and 98-150 by substitution, deletion or insertion of one or more amino acids;
d) polypeptides derived from a mature polypeptide of any one of SEQ ID NOs: 1-48 and 98-150 by substitution, deletion or insertion of one or more amino acids;
e) polypeptides derived from any one of a) through d) above wherein the N- and/or C-terminal end has been extended by the addition of one or more amino acids;
f) fragments of any one of a) through e) above; and
g) enzymatically active fragments/mutants/variants of any one of SEQ ID NOs: 1-48 and 98-150 or mature polypeptides thereof.

In some embodiments, formulations of the present disclosure comprise about 0.0001 to about 40% protein (i.e., total amount of one or more proteins of the present disclosure) w/w, based upon the total weight of the formulation. For example, in some embodiments, formulations of the present disclosure comprise about 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9 or 5% w/w to about 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 11, 12, 13, 14, 15, 16, 17, 18, 19, 20, 21, 22, 23, 24 or 25% w/w (e.g., about 0.0001 to about 1% w/w) of one or more pH control components selected from the group consisting of proteins selected from the group consisting of:
a) polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof;
b) polypeptides encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof;
c) polypeptides derived from any one of SEQ ID NOs: 1-48 and 98-150 by substitution, deletion or insertion of one or more amino acids;
d) polypeptides derived from a mature polypeptide of any one of SEQ ID NOs: 1-48 and 98-150 by substitution, deletion or insertion of one or more amino acids;
e) polypeptides derived from any one of a) through d) above wherein the N- and/or C-terminal end has been extended by the addition of one or more amino acids;
f) fragments of any one of a) through e) above; and
g) enzymatically active fragments/mutants/variants of any one of SEQ ID NOs: 1-48 and 98-150 or mature polypeptides thereof.

The present disclosure extends to granules/particles comprising one or more proteins of the disclosure. In an embodiment, the granule comprises a core, and optionally one or more coatings (outer layers) surrounding the core.

The core may have a diameter, measured as equivalent spherical diameter (volume based average particle size), of 20-2000 μm, particularly 50-1500 μm, 100-1500 μm or 250-1200 μm. The core diameter, measured as equivalent spherical diameter, can be determined using laser diffraction, such as using a Malvern Mastersizer and/or the method described under ISO13320 (2020).

In an embodiment, the core comprises one or more proteins of the present disclosure.

The core may include additional materials such as fillers, fiber materials (cellulose or synthetic fibers), stabilizing agents, solubilizing agents, suspension agents, viscosity regulating agents, light spheres, plasticizers, salts, lubricants and fragrances.

The core may include a binder, such as synthetic polymer, wax, fat, or carbohydrate.

The core may include a salt of a multivalent cation, a reducing agent, an antioxidant, a peroxide decomposing catalyst and/or an acidic buffer component, typically as a homogenous blend.

The core may include an inert particle with the protein absorbed into it, or applied onto the surface, e.g., by fluid bed coating.

The core may have a diameter of 20-2000 μm, particularly 50-1500 μm, 100-1500 μm or 250-1200 μm.

The core may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA).

The coating may be applied in an amount of at least 0.1% by weight of the core, e.g., at least 0.5%, at least 1%, at least 5%, at least 10%, or at least 15%. The amount may be at most 100%, 70%, 50%, 40% or 30%.

The coating is preferably at least 0.1 μm thick, particularly at least 0.5 μm, at least 1 μm or at least 5 μm. In some embodiments, the thickness of the coating is below 100 μm, such as below 60 μm, or below 40 μm.

The coating should encapsulate the core unit by forming a substantially continuous layer. A substantially continuous layer is to be understood as a coating having few or no holes, so that the core unit has few or no uncoated areas.

The layer or coating should, in particular, be homogeneous in thickness.

The coating can further contain other materials as known in the art, e.g., fillers, antisticking agents, pigments, dyes, plasticizers and/or binders, such as titanium dioxide, kaolin, calcium carbonate or talc.

A salt coating may comprise at least 60% by weight of a salt, e.g., at least 65%, at least 70%, at least 75%, at least 80%, at least 85%, at least 90%, at least 95% or at least 99% by weight.

To provide acceptable protection, the salt coating is preferably at least 0.1 μm thick, e.g., at least 0.5 μm, at least 1 μm, at least 2 μm, at least 4 μm, at least 5 μm, or at least 8 μm. In a particular embodiment, the thickness of the salt coating is below 100 μm, such as below 60 μm, or below 40 μm.

The salt may be added from a salt solution where the salt is completely dissolved or from a salt suspension wherein the fine particles are less than 50 μm, such as less than 10 μm or less than 5 μm.

The salt coating may comprise a single salt or a mixture of two or more salts. The salt may be water soluble, in particular, having a solubility at least 0.1 g in 100 g of water at 20° C., preferably at least 0.5 g per 100 g water, e.g., at least 1 g per 100 g water, e.g., at least 5 g per 100 g water.

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salts are alkali or earth alkali metal ions, the ammonium ion or metal ions of the first transition series, such as sodium, potassium, magnesium, calcium, zinc or aluminum. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate or gluconate. In particular, alkali- or earth alkali metal salts of sulfate, sulfite, phosphate, phosphonate, nitrate, chloride or carbonate or salts of simple organic acids such as citrate, malonate or acetate may be used.

The salt in the coating may have a constant humidity at 20° C. above 60%, particularly above 70%, above 80% or above 85%, or it may be another hydrate form of such a salt (e.g., anhydrate). The salt coating may be as described in WO 00/01793 or WO 2006/034710.

Specific examples of suitable salts are NaCl (CH_{20° C.}=76%), Na₂CO₃ (CH_{20° C.}=92%), NaNO₃ (CH_{20° C.}=73%), Na₂HPO₄ (CH_{20° C.}=95%), Na₃PO₄ (CH_{25° C.}=92%), NH₄Cl (CH_{20° C.}=79.5%), (NH₄)₂HPO₄(CH_{20° C.}=93.0%), NH₄H₂PO₄ (CH_{20° C.}=93.1%), (NH₄)₂SO₄ (CH_{20° C.}=81.1%), KCl (CH_{20° C.}=85%), K₂HPO₄(CH_{20° C.}=92%), KH₂PO₄ (CH_{20° C.}=96.5%), KNO₃ (CH_{20° C.}=93.5%), Na₂SO₄ (CH_{20° C.}=93%), K₂SO₄(CH_{20° C.}=98%), KHSO₄ (CH_{20° C.}=86%), MgSO₄ (CH_{20° C.}=90%), ZnSO₄ (CH_{20° C.}=90%) and sodium citrate (CH_{25° C.}=86%). Other examples include NaH₂PO₄, (NH₄)H₂PO₄, CuSO₄, Mg(NO₃)₂ and magnesium acetate.

The salt may be in anhydrous form, or it may be a hydrated salt, i.e., a crystalline salt hydrate with bound water(s) of crystallization, such as described in WO 99/32595. Specific examples include anhydrous sodium sulfate (Na₂SO₄), anhydrous magnesium sulfate (MgSO₄), magnesium sulfate heptahydrate (MgSO₄·7H₂O), zinc sulfate heptahydrate (ZnSO₄·7H₂O), sodium phosphate dibasic heptahydrate (Na₂HPO₄·7H₂O), magnesium nitrate hexahydrate (Mg(NO₃)₂(6H₂O)), sodium citrate dihydrate and magnesium acetate tetrahydrate.

Preferably the salt is applied as a solution of the salt, e.g., using a fluid bed.

The coating materials can be waxy coating materials and film-forming coating materials. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The granule may optionally have one or more additional coatings. Examples of suitable coating materials are polyethylene glycol (PEG), methyl hydroxy-propyl cellulose (MHPC) and polyvinyl alcohol (PVA). Examples of enzyme granules with multiple coatings are described in WO 93/07263 and WO 97/23606.

The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation.

Methods for preparing the core can be found in the Handbook of Powder Technology; Particle size enlargement by C. E. Capes; Vol. 1; 1980; Elsevier. Preparation methods include known feed and granule formulation technologies, e.g.,
(a) Spray dried products, wherein a liquid protein-containing solution is atomized in a spray drying tower to form small droplets which during their way down the drying tower dry to form a protein-containing particulate material. Very small particles can be produced this way (Michael S. Showell (editor); Powdered detergents; Surfactant Science Series; 1998; Vol. 71; pages 140-142; Marcel Dekker).
(b) Layered products, wherein the protein is coated as a layer around a pre-formed inert core particle, wherein a protein-containing solution is atomized, typically in a fluid bed apparatus wherein the pre-formed core particles are fluidized, and the protein-containing solution adheres to the core particles and dries up to leave a layer of dry protein on the surface of the core particle. Particles of a desired size can be obtained this way if a useful core particle of the desired size can be found. This type of product is described in, e.g., WO 97/23606.
(c) Absorbed core particles, wherein rather than coating the protein as a layer around the core, the protein is absorbed onto and/or into the surface of the core. Such a process is described in WO 97/39116.
(d) Extrusion or pelletized products, wherein a protein-containing paste is pressed to pellets or under pressure is extruded through a small opening and cut into particles which are subsequently dried. Such particles usually have a considerable size because of the material in which the extrusion opening is made (usually a plate with bore holes) sets a limit on the allowable pressure drop over the extrusion opening. Also, very high extrusion pressures when using a small opening increase heat generation in the protein paste, which is harmful to the protein (Michael S. Showell (editor); Powdered detergents; Surfactant Science Series; 1998; Vol. 71; pages 140-142; Marcel Dekker).
(e) Prilled products, wherein a protein-containing powder is suspended in molten wax and the suspension is sprayed, e.g., through a rotating disk atomizer, into a cooling chamber where the droplets quickly solidify (Michael S. Showell (editor); Powdered detergents; Surfactant Science Series; 1998; Vol. 71; pages 140-142; Marcel Dekker). The product obtained is one wherein the protein is uniformly distributed throughout an inert material instead of being concentrated on its surface. U.S. Pat. Nos. 4,016,040 and 4,713,245 describe this technique.
(f) Mixer granulation products, wherein a protein-containing liquid is added to a dry powder composition of conventional granulating components. The liquid and the powder in a suitable proportion are mixed and as the moisture of the liquid is absorbed in the dry powder, the components of the dry powder will start to adhere and agglomerate and particles will build up, forming granulates comprising the protein. Such a process is described in U.S. Pat. No. 4,106,991, EP 170360, EP 304332, EP 304331, WO 90/09440 and WO 90/09428. Ina particular aspect of this process, various high-shear mixers can be used as granulators. Granulates consisting of protein, fillers and binders etc. are mixed with cellulose fibers to reinforce the particles to produce a so-called T-granulate. Reinforced particles, are more robust, and release less enzymatic dust.
(g) Size reduction, wherein the cores are produced by milling or crushing of larger particles, pellets, tablets, briquettes etc. containing the protein. The wanted core particle fraction is obtained by sieving the milled or crushed product. Over and undersized particles can be recycled. Size reduction is described in Martin Rhodes (editor); Principles of Powder Technology; 1990; Chapter 10; John Wiley & Sons.
(h) Fluid bed granulation. Fluid bed granulation involves suspending particulates in an air stream and spraying a liquid onto the fluidized particles via nozzles. Particles hit by spray droplets get wetted and become tacky. The tacky particles collide with other particles and adhere to them to form a granule.
(i) The cores may be subjected to drying, such as in a fluid bed drier. Other known methods for drying granules in the feed or enzyme industry can be used by the skilled person. The drying preferably takes place at a product temperature of from 25 to 90° C. For some proteins, it is important the cores comprising the protein contain a low amount of water before coating with the salt. If water sensitive proteins are coated with a salt before excessive water is removed, the excessive water will be trapped within the core and may affect the activity of the protein negatively. After drying, the cores preferably contain 0.1-10% w/w water.

Non-dusting granulates may be produced, e.g., as disclosed in U.S. Pat. Nos. 4,106,991 and 4,661,452 and may optionally be coated by methods known in the art.

The granulate may further comprise one or more additional enzymes, e.g., hydrolase, isomerase, ligase, lyase, oxidoreductase, and transferase. The one or more additional enzymes are preferably selected from the group consisting of acetylxylan esterase, acylglycerol lipase, amylase, alpha-amylase, beta-amylase, arabinofuranosidase, cellobiohydrolases, cellulase, feruloyl esterase, galactanase, alpha-galactosidase, beta-galactosidase, beta-glucanase, beta-glucosidase, lysophospholipase, lysozyme, alpha-mannosidase, beta-mannosidase (mannanase), phytase, phospholipase A1, phospholipase A2, phospholipase D, protease, pullulanase, pectin esterase, triacylglycerol lipase, xylanase, beta-xylosidase or any combination thereof. Each enzyme will then be present in more granules securing a more uniform distribution of the enzymes, and also reduces the physical segregation of different enzymes due to different particle sizes. Methods for producing multi-enzyme co-granulates is disclosed in the ip.com disclosure IPCOM000200739D. Another example of formulation of proteins using co-granulates is disclosed in WO 2013/188331.

The present disclosure also relates to protected proteins prepared according to the method(s) disclosed in EP 238216.

The present disclosure also extends to liquid formulations comprising one or more proteins of the disclosure. In some embodiments, the formulation comprises one or more enzyme stabilizers, one or more pH control components, one or more rain fasteners, and, optionally, one or more preservatives.

Formulations of the present disclosure may comprise any suitable enzyme stabilizer(s), including, but not limited to, sugars (e.g., monosaccharides, such as fructose, galactose and glucose; disaccharides, such as lactose, maltose and sucrose; oligosaccharides, such as maltodextrins; and polysaccharides, such as celluloses and starches), polyols (e.g., sugar alcohols, such as arabitol, erythritol, ethylene glycol, glycerol, mannitol, sorbitol and xylitol; and polymeric polyols, such as polyethylene glycols and polypropylene glycols), polyvinyl alcohols, lactic acid, lactic acid derivatives, boric acids, boric acid derivatives (e.g., aromatic borate esters and phenyl boronic acid derivatives, such as 4-formylphenyl boronic acid), and reversible protease inhibitors. See generally, e.g., WO 2007/113241; WO 01/04279; WO 2013/004636; WO 95/02046; WO 2009/118375; WO 2020/115179; WO 96/41859; WO 2007/025549; WO 96/23062; WO 2018/130654; WO 96/22366; WO 92/17571; WO 2017/044473; WO 2017/044545, WO 2017/116837, WO 2017/116846, WO 2017/210163, WO 2017/210166, WO 2018/118740, WO 2018/175681, WO 2018/183491, WO 2018/218008, WO 2018/218016; WO 2018/218035. It is to be understood that certain enzyme stabilizers may impart other beneficial properties to formulations of the present disclosure, such as enhanced flowability and/or improved adhesion to a plant surface.

In some embodiments, formulations of the present disclosure comprise about/at least 5, 10, 15, 20, 25, 30, 35, 40, 45, 50, 55, 60, 65, 70, 75, 80, 85, 90, 95% or more polyol (i.e., total amount of one or more polyols) w/w, based upon the total weight of the formulation. For example, in some embodiments, formulations of the present disclosure comprise about/at least 5, 10, 15, 20, 25, 30, 35, 40, 45, 50, 55, 60, 65, 70, 75, 80, 85, 90, 95% w/w or more of one or more polyols selected from the group consisting of glycerol, sorbitol, propylene glycol (MPG), ethylene glycol, diethylene glycol, triethylene glycol, 1,2-propylene glycol or 1,3-propylene glycol, dipropylene glycol, polyethylene glycols (PEG) having an average molecular weight below about 600, and polypropylene glycols (PPG) having an average molecular weight below about 600, preferably glycerol, sorbitol and/or propylene glycol (MPG).

In some embodiments, formulations of the present disclosure comprise about 5 to about 95% polyol (i.e., total amount of one or more polyols) w/w, based upon the total weight of the formulation. For example, in some embodiments, formulations of the present disclosure comprise about 5, 10, 15, 20, 25, 30, 40, 45 or 50% w/w to about 50, 55, 60, 65, 70, 75, 80, 85, 90 or 95% w/w (e.g., about 20 to about 40% w/w) of one or more polyols selected from the group consisting of glycerol, sorbitol, propylene glycol (MPG), ethylene glycol, diethylene glycol, triethylene glycol, 1,2-propylene glycol or 1,3-propylene glycol, dipropylene glycol, polyethylene glycols (PEG) having an average molecular weight below about 600, and polypropylene glycols (PPG) having an average molecular weight below about 600, preferably glycerol, sorbitol and/or propylene glycol (MPG).

Formulations of the present disclosure may comprise any suitable pH control component(s), including, but not limited to, acetate, carbonate, citrate, phosphate and other salts capable of buffering the formulation at a desired pH and having an aqueous solubility of more than 1% w/w. Preferred pH control components in some embodiments are phosphate buffers containing the ionic species HPO₄²⁻ and H₂PO₄⁻.

A pH control component may be a single ionic species, that can maintain a constant pH but only provide a buffering effect towards either acidification or basification. An example of such, is HPO₄²⁻ which can ensure an alkaline pH (of approximately 9) and provide a buffering effect against acidification. This may be beneficial in an agricultural setting to keep the pH constant at an alkaline pH, as most environmental factors will cause acidification of a droplet and deposit.

In preferred embodiments, the pH control component does not significantly change pH (+/−0.5 pH units) or change in a desired direction upon drying when the solvent evaporates from a droplet on a plant surface. Some buffers will, upon drying, change pH as a result of differences in solubility of the buffer components. As an example, the pH of a sodium phosphate buffer constituting of Na₂HPO₄ and NaH₂PO₄ can reduce to pH 4 or lower upon drying since the dibasic form (Na₂HPO₄) will crystallize to a larger degree. On the contrary, the pH of a potassium phosphate buffer constituting of K₂HPO₄ and KH₂PO₄ will approach pH 9 upon drying since the monobasic form (KH₂PO₄) has the lowest solubility (Sarciaux 1999).

A pH control component is most effective (highest buffer capacity) when the pKa is close to the desired pH of the composition. This will reduce the amount of buffer needed to maintain a desired pH. In an embodiment, the buffer includes salts having a neutral/alkaline pKa, such as a pKa in the range of 6.5 to 10.

As a rule of thumb, a pH control component can be used to control the pH of a solution at a pH+/−1 pH-unit from its pKa value. For example, pH control components with a pKa value above 6.5 are useful for controlling the pH at 7.5 or above. Examples of suitable pH control components include, but are not limited to sodium or potassium phosphate (pKa₁ 2.12, pKa₂ 7.21, pKa₃ 12.67), sodium or potassium carbonate (pKa₁ 6.37, pKa₂ 10.32), 2-amino-2-(hydroxymethyl)-1,3-propanediol (TRIS) (pKa 8.1), [Bis(2-hydroxyethyl)amino]acetic acid (Bicine) (pKa 8.35), N-[tris(hydroxymethyl)methyl]glycine (Tricine) (pKa 8.15), 4-(2-hydroxyethyl)-1-piperazineethanesulfonic acid (HEPES) (pKa₁ 3.0, pKa₂ 7.5), N-[tris(hydroxymethyl)methyl]-2-aminoethanesulfonic acid (TES) (pKa 7.55), 3-(N-morpholino)propanesulfonic acid (MOPS) (pKa 7.2), tris(hydroxymethyl)methylamino]propanesulfonic acid (TAPS) (pKa 8.44), N-[tris(hydroxymethyl)methyl]-3-amino-2-hydroxypropanesulfonic acid (TAPSO) (pKa 7.6), glycylglycine (pKa₁ 3.14 pKa₂ 8.17), 2-(N-cyclohexylamino)ethanesulfonic acid (CHES) (pKa 9.3), sodium or potassium borate (pKa₁ 9.24, pKa₂ 12.4, pKa₃ 13.3), 2-amino-2-methyl-1,3-propanediol (ammediol) (pKa 8.8), triethanol amine (pKa 7.74), 2-amino-2-methyl-1-propanol (pKa 9.7), glycine (pKa₁ 2.34, pKa₂ 9.6), histidine (pKa₁ 1.82, pKa₂ 6.00, pKa₃ 9.17), and other amino acid buffers.

Non-preferred pH control components include, but are not limited to, pH control components with an unfavorable pKa (e.g., pKa<6.5 for an enzyme that requires an alkaline pH or pKa>7.5 for an enzyme that requires an acidic pH), volatile pH control component, pH control component that display significant phytotoxicity (this may sometimes include the above-mentioned “suitable” pH control components, as phytotoxicity is depended on buffer concentration, pH and target crop), and pH control components that are unwanted in the environment and therefore regulated by authorities (this may sometimes include the above-mentioned “suitable” pH control component, as regulations vary throughout the world).

In some embodiments, pH control components may be used to provide formulations of the present disclosure that maintain an alkaline pH. For example, in some preferred embodiments, formulations of the present disclosure comprise one or more pH control components selected to provide a composition having an alkaline pH, preferably at least 7.5, more preferably between 7.5 and 10, most preferably between 8 and 9.5. Thus, in some embodiments, formulations of the present disclosure comprise a pH control component, such as a buffer, where an 1% w/w aqueous solution of the pH control component (buffer) has an alkaline pH (e.g., above 7.5, preferably above 8, and below 10, preferably below 9.5).

In some embodiments, pH control components may be used to provide formulations of the present disclosure that maintain a neutral pH. For example, in some preferred embodiments, formulations of the present disclosure comprise one or more pH control components selected to provide a composition having a neutral pH, preferably between 6.5 and 7.5, more preferably between 6.75 and 7.25, most preferably about 7. Thus, in some embodiments, formulations of the present disclosure comprise a pH control component, such as a buffer, where an 1% w/w aqueous solution of the pH control component (buffer) has a neutral pH (e.g., above 6.5 and below 7.5, preferably above 6.75 and below 7.25, more preferably about 7).

In some embodiments, pH control components may be used to provide formulations of the present disclosure that maintain an acidic pH. For example, in some preferred embodiments, formulations of the present disclosure comprise one or more pH control components selected to provide a composition having an acidic pH, preferably below 6.5, more preferably between 4 and 6.5, most preferably between 4.5 and 6. Thus, in some embodiments, formulations of the present disclosure comprise a pH control component, such as a buffer, where an 1% w/w aqueous solution of the pH control component (buffer) has an acidic pH (e.g., below 6.5, preferably below 6, and above 4, preferably above 4.5).

In some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5% or more pH control component (i.e., total amount of one or more pH control components) w/w, based upon the total weight of the formulation. For example, in some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5% w/w or more of one or more pH control components selected from the group consisting of acetate, citrate, carbonate and phosphate buffers, preferably sodium acetate, sodium citrate, sodium carbonate and/or potassium phosphate buffers.

In some embodiments, formulations of the present disclosure comprise about 0.001 to about 10% pH control component (i.e., total of one or more pH control components) w/w, based upon the total weight of the formulation. For example, in some embodiments, formulations of the present disclosure comprise about 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1% w/w to about 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9 or 5% w/w (e.g., about 0.01 to about 1% w/w) of one or more pH control components selected from the group consisting of acetate, carbonate, citrate and phosphate buffers, preferably sodium acetate, sodium carbonate, sodium citrate and/or potassium phosphate buffers.

Formulations of the present disclosure may comprise any suitable rain fastener(s), including, but not limited to, organo-modified siloxanes (organosiloxanes), such as organo-modified trisiloxanes (e.g., polyether-modified trisiloxanes, such as polyalkyleneoxide-modified heptamethyltrisiloxane) and organo-modified polysiloxanes (e.g., polyether-modified polysiloxanes,). See generally, e.g., EPO 0245970; U.S. Pat. No. 5,496,568; WO 2008/144024; WO 2009/135049; WO 2011/126832; WO 2017/083049; WO 2020/225276; WO 2021/055316; WO 2022/096688; WO 2022/096691; WO 2022/096692; WO 2022/096693; WO 2022/096694; WO/2022/096695; WO 2022/096696.

In some embodiments, formulations of the present disclosure comprise one or more organo-modified siloxanes having the general molecular structure of Formula 1:

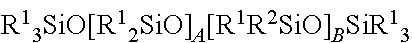

in which
R¹ represents identical or different from each other hydrocarbon substituents of 1-10 carbons or hydrogen, preferred are methyl, ethyl, propyl and phenyl substituents, particularly preferred are methyl substituents;
R² represents identical or different from each other polyether substituents of the general Formula II:

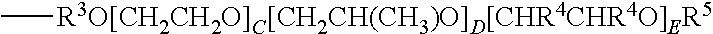

wherein
R³ represents identical or different from each other hydrocarbon moieties of 1-8 carbons, which optionally is interrupted by oxygen atoms. Preferred is linear hydrocarbons of 2-4 carbons, particularly preferred is —CH₂—CH₂—CH₂—
R⁴ represents identical or different from each other hydrocarbon substituents of 1-12 carbons or hydrogen, preferred is methyl, ethyl, phenyl or hydrogen substituents
R⁵ represents identical or different from each other hydrocarbon substituents of 1-16 carbons, which optionally contains urethane, carbonyl or carboxylic acid functionality, or hydrogen.

Methyl or hydrogen substituents are preferred, with hydrogen being most preferred. A is 0-200, preferably 0-1, more preferably 0. B is 0-200, preferably 0.5-2, more preferably 1. In preferred embodiments, A+B>0. C is 0-60, preferably 1-15. D is 0-60, preferably 0-10. E is 0-20, preferably 0-10, more preferably 0. In preferred embodiments, C+D+E>0.

A trisiloxane may be defined as a molecule of the general Formula I with A=0 and B=1, whereas a polysiloxane is a molecule of the general formula I with A+B>1 and A>1.

Examples of commercially available organo-modified siloxanes include, but are not limited to BIOSPREAD® surfactants (Grosafe Chemicals Ltd., New Zealand); BREAK-THRU® surfactants (Evonik Operations Gmbh, Essen, Germany), such as BREAK-THRU® AF 5503, BREAK-THRU® AF 9902, BREAK-THRU® AF 9903, BREAK-THRU® OE 440, BREAK-THRU® OE 444, BREAK-THRU® OE 446, BREAK-THRU® S 200, BREAK-THRU® S 233, BREAK-THRU® S 240, BREAK-THRU® S 255, BREAK-THRU® S 279, BREAK-THRU® S 301, BREAK-THRU® SD 260, and BREAK-THRU® UNION; BYK® surfactants (BYK-Chemie GmbH, Wesel, Germany), such as BYK®-348; ECOSPREAD® surfactants (Grosafe Chemicals Ltd., New Zealand); HI-WETT® surfactants (Loveland Products, Inc., Greeley, CO, USA); and SILWET™ surfactants (Momentive, Inc., Waterford, NY, USA), such as SILWET™ L-77, SILWET™ HS-312, SILWET™ 408, SILWET™ 618, SILWET™ 625, SILWET™ 636, SILWET™ 641, SILWET™ 806, SILWET™ DA-40, SILWET™ DRS-60, SILWET™ ECO, SILWET™ FUSION, SILWET™ HS 312, SILWET™ HS 604, SILWET™ HSEC, SILWET™ LF, SILWET™ OC, and SILWET™ STIK 2.

In some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 6, 7, 8, 9, 10, 11, 12, 13, 14, 15, 16, 17, 18, 19, 20, 21, 22, 23, 24, 25, 30, 35, 40, 45, 50% or more rain fastener (i.e., total amount of one or more rain fasteners) w/w, based upon the total weight of the formulation. For example, in some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 6, 7, 8, 9, 10% w/w or more of one or more rain fasteners selected from the group consisting of organo-modified siloxanes, preferably organo-modified trisiloxanes and organo-modified polysiloxanes, more preferably organo-modified trisiloxanes and polysiloxanes comprising one or more polyether groups, most preferably trisiloxane (poly)ethoxylates and polysiloxane (poly)ethoxylates.

In some embodiments, formulations of the present disclosure comprise about 0.001 to about 50% rain fastener (i.e., total amount of one or more rain fasteners) w/w, based upon the total weight of the formulation. For example, in some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1% w/w to about 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 6, 7, 8, 9 or 10% w/w of one or more rain fasteners selected from the group consisting of organo-modified siloxanes, preferably organo-modified trisiloxanes and organo-modified polysiloxanes, more preferably organo-modified trisiloxanes and polysiloxanes comprising one or more polyether groups, most preferably trisiloxane (poly)ethoxylates and polysiloxane (poly)ethoxylates.

Formulations of the present disclosure may comprise any suitable preservative(s), including, but not limited to, potassium benzoate, potassium sorbate, sodium benzoate and sodium sorbate.

In some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 6, 7, 8, 9, 10% or more preservative (i.e., total amount of one or more preservatives) w/w, based upon the total weight of the formulation. For example, in some embodiments, formulations of the present disclosure comprise about/at least 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5% w/w or more of one or more preservatives selected from the group consisting of potassium benzoate, potassium sorbate, sodium benzoate and sodium sorbate, preferably potassium sorbate and/or sodium benzoate.

In some embodiments, formulations of the present disclosure comprise about 0.001 to about 10% preservative (i.e., total amount of one or more preservatives) w/w, based upon the total weight of the formulation. For example, in some embodiments, formulations of the present disclosure comprise about 0.001, 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1% w/w to about 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9 or 5% w/w of one or more preservatives selected from the group consisting of potassium benzoate, potassium sorbate, sodium benzoate and sodium sorbate, preferably potassium sorbate and/or sodium benzoate.

Proteins of the present disclosure may be incorporated into formulations comprising myriad components, including, but not limited to, adhesives (stickers), chemical actives, dispersants (spreaders), drying agents, emulsifiers, microbes, nutrients, pest attractants and feeding stimulants, pH control components, postharvest treatments, rhealogical agents, safeners, UV protectants and/or wetting agents.

Examples of adhesives (stickers) that may be included in formulations of the present disclosure include, but not are not limited to, disaccharides (e.g. maltose, sucrose, trehalose), gums (e.g., cellulose gum, guar gum, gum arabic, gum combretum, xantham gum), maltodextrins (e.g., maltodextrins having a DEV of about 10 to about 20), monosaccharides, oils (e.g., mineral oil, olive oil, peanut oil, soybean oil and/or sunflower oil), and oligosaccharides. See generally, e.g., POWERBLOX™ (Dow, Midland, MI, USA), such as POWERBLOX™ ADJ-65 and POWERBLOX™ ADJ-65; EPO 0245970; U.S. Pat. No. 5,496,568; WO 2008/144024; WO 2009/135049; WO 2011/126832; WO 2017/083049; WO 2020/225276; WO 2021/055316; WO 2022/096688; WO 2022/096691; WO 2022/096692; WO 2022/096693; WO 2022/096694; WO/2022/096695; WO 2022/096696.

Examples of chemical actives that may be included in formulations of the present disclosure include, but not are not limited to, acaracides and miticides (e.g., carvacrol, sanguinarine, azobenzene, benzoximate, benzyl benzoate, bromopropylate, chlorbenside, chlorfenethol, chlorfenson, chlorfensulphide, chlorobenzilate, chloropropylate, cyflumetofen, DDT, dicofol, diphenyl sulfone, dofenapyn, fenson, fentrifanil, fluorbenside, genit, hexachlorophene, phenproxide, proclonol, tetradifon, tetrasul, benomyl, carbanolate, carbaryl, carbofuran, methiocarb, metolcarb, promacyl, propoxur, aldicarb, butocarboxim, oxamyl, thiocarboxime, thiofanox, bifenazate, binapacryl, dinex, dinobuton, dinocap-4, dinocap-6, dinocton, dinopenton, dinosulfon, dinoterbon, DNOC, amitraz, chlordimeform, chloromebuform, formetanate, formparanate, medimeform, semiamitraz, afoxolaner, fluralaner, sarolaner, tetranactin oavermectin acaricides, abamectin, doramectin, eprinomectin, ivermectin, selamectin, milbemectin, milbemycin oxime, moxidectin, clofentezine, cyromazine, diflovidazin, dofenapyn, fluazuron, flubenzimine, flucycloxuron, flufenoxuron, hexythiazox, bromocyclen, camphechlor, DDT, dienochlor, endosulfan, lindane, chlorfenvinphos, crotoxyphos, dichlorvos, heptenophos, mevinphos, monocrotophos, naled, TEPP, tetrachlorvinphos, amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton-O, demeton-S, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion, trichlorfon, isocarbophos, methamidophos, propetamphos, dimefox, mipafox, schradan, azocyclotin, cyhexatin, fenbutatin oxide, phostin, dichlofluanid, dialifos, phosmet, cyenopyrafen, fenpyroximate, pyflubumide, tebufenpyrad, acetoprole, fipronil, vaniliprole, acrinathrin, bifenthrin, brofluthrinate, cyhalothrin, alpha-cypermethrin, fenpropathrin, fenvalerate, flucythrinate, flumethrin, tau-fluvalinate, permethrin, halfenprox, pyrimidifen, chlorfenapyr, sanguinarine, chinomethionat, thioquinox, bifujunzhi, fluacrypyrim, flufenoxystrobin, pyriminostrobin, aramite, propargite, spirodiclofen, clofentezine, diflovidazin, flubenzimine, hexythiazox, fenothiocarb, chloromethiuron, diafenthiuron, acequinocyl, amidoflumet, arsenous oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene, and combinations thereof); fungicides (e.g., strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide; carboxamides, such as carboxanilides (e.g., benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyra-zole-4-carboxamide, N-(2-(1,3,3-trimethylbutyl)-phenyl)-1,3-dimethyl-5-fluoro-1H-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, oxytetracyclin, silthiofam and N-(6-methoxy-pyridin-3-yl) cyclopropanecarboxylic acid amide; azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cf.D1b), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimate, cyprodinil, diflumetorim, fenarimol, ferimzone, mepanipyrim, nitrapyrin, nuarimol, pyrimethanil), piperazines (e.g., triforine), pirroles (e.g., fenpiclonil, fludioxonil), morpholines (e.g., aldimorph, dodemorph, dodemorph-acetate, fenpropimorph, tridemorph), piperidines (e.g., fenpropidin), dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate and iminoctadine-tris(albesilate); antibiotics (e.g., kasugamycin, kasugamycin hydrochloride-hydrate, streptomycin, polyoxine and validamycin A); nitrophenyl derivates (e.g., binapacryl, dicloran, dinobuton, dinocap, nitrothal-isopropyl, tecnazen); organometal compounds (e.g., fentin salts, such as fentin-acetate, fentin chloride, fentin hydroxide); sulfur-containing heterocyclyl compounds (e.g., dithianon, isoprothiolane); organophosphorus compounds (e.g., edifenphos, fosetyl, fosetyl-aluminum, iprobenfos, phosphorus acid and its salts, pyrazophos, tolclofos-methyl); organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanate, tolylfluanid, N-(4-chloro-2-nitro-phenyl)-N-ethyl-4-methyl-benzenesulfonamide), inorganic active substances (e.g., Bordeaux mixture, copper acetate, copper hydroxide, copper oxychloride, basic copper sulfate, phosphite salt, sulfur, zinc sulfate), natamycin, and combinations thereof); gastropodicides (e.g., methiocarb, metaldehyde, carbaryl, spinosad, copper sulfate in combination with lime, boric acid, iron phosphate, and combinations thereof); herbicides (e.g., 2,4-dichlorophenoxyacetic acid (2,4-D), 2,4,5-trichlorophenoxyacetic acid (2,4,5-T), ametryn, amicarbazone, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diuron, dithiopyr, fenoxaprop, fluazifop, fluazifop-P, fluometuron, flufenpyr-ethyl, flumiclorac-pentyl, flumioxazin, fluoroglycofen, fluthiacet-methyl, fomesafe, fomesafen, glyphosate, glufosinate, haloxyfop, hexazinone, imazamox, imazaquin, imazethapyr, ioxynil, isoproturon, isoxaflutole, lactofen, linuron, mecoprop, mecoprop-P, mesotrion, metamitron, metazochlor, methibenzuron, metolachlor (and S-metolachlor), metoxuron, metribuzin, monolinuron, oxadiargyl, oxadiazon, oxyfluorfen, phenmedipham, pretilachlor, profoxydim, prometon, prometry, propachlor, propanil, propaquizafop, propisochlor, pyraflufen-ethyl, pyrazon, pyrazolynate, pyrazoxyfen, pyridate, quizalofop, quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thenylchlor, tralkoxydim, triclopyr, trietazine, tropramezone, salts and esters thereof; racemic mixtures and resolved isomers thereof and combinations thereof); and insecticides and nematicides (e.g., antibiotic insecticides such as allosamidin and thuringiensin; macrocyclic lactone insecticides such as spinosad, spinetoram, and other spinosyns including the 21-butenyl spinosyns and their derivatives; avermectin insecticides such as abamectin, doramectin, emamectin, eprinomectin, ivermectin and selamectin; milbemycin insecticides such as lepimectin, milbemectin, milbemycin oxime and moxidectin; arsenical insecticides such as calcium arsenate, copper acetoarsenite, copper arsenate, lead arsenate, potassium arsenite and sodium arsenite; other biological insecticides, plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as .alpha.-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, imicyafos, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, biopermethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetronic acid insecticides such as spirodiclofen, spiromesifen and spirotetramat; thiourea insecticides such as diafenthiuron; urea insecticides such as flucofuron and sulcofuron; and unclassified insecticides such as AKD-3088, chlorantraniliprole, closantel, crotamiton, cyflumetofen, E2Y45, EXD, fenazaflor, fenazaquin, fenoxacrim, fenpyroximate, FKI-1033, flubendiamide, HGW86, hydramethylnon, IKI-2002, isoprothiolane, malonoben, metaflumizone, metoxadiazone, nifluridide, NNI-9850, NNI-0101, pymetrozine, pyridaben, pyridalyl, pyrifluquinazon, Qcide, rafoxanide, Rynaxypyr™, SYJ-159, triarathene and triazamate, and combinations thereof). It is to be understood that formulation of the present disclosure may comprise any suitable combination of chemical actives and may therefore comprise two, three, four, five, six, seven, eight, nine, ten or more of the aforementioned actives. Conversely, in some embodiments, one, two, three, four, five, six, seven, eight, nine, ten or more of the aforementioned actives are expressly excluded from formulation of the present disclosure.

Non-limiting examples of chemical active compositions that may be incorporated into formulations of the present disclosure—or into which proteins and other compositions of the present disclosure may be incorporated—include, but are not limited to, commercial products sold under the tradenames AGCELENCE®, REVYSOL®, XEMIUM®, INITIUM®, F 500®, CLEARFIELD®, KIXOR and SERIFEL® from BASF (Ludwigshafen, Germany); CORVUS®, POWERMAX®, DELARO®, PROSARO®, BAYTHROID®, SIVANTO®, FINISH®, GINSTAR®, ACCELERON®, RAXIL®, AERIS®, EVERGOL®, TRILEX®, ALLEGIANCE®, BUTEO, EMESTO®, GAUCHO®, PONCHO® and THIRAM® from Bayer Crop Science (Creve Coeur, MO, USA); ABUNDIT®, ACCENT®, AFFORIA®, APROACH®, BASIS®, BEXFOND®, BLACKHAWK®, CANOPY®, CINCH®, CLINHER®, CURTAIL®, CURZATE®, DELEGATE®, RAINSHIELD®, DITHANE®, FEXAPAN®, VAPORGRIP®, LANNATE®, TANOS®, DURANGO®, DMA®, ELEVORE®, EMBED®, ENABLE®, ENLIST DUO®, ENLIST ONE®, ENLITE®, ENTRUST®, ENVIVE®, EVERPLEX®, FONTELIS®, FULTIME®, GOLDSKY®, GRANDSTAND®, GRANITE®, GRASP®, HEARKEN®, INDAR®, NXTGEN®, INSTINCT®, INTREPID 2F®, INTREPID EDGE®, KERB®, KEYSTONE®, KYBER®, LEADOFF®, LOYANT®, MATRIX®, N-SERVE®, NOVIXID®, OPENSKY®, PERFECTMATCH®, PINDAR®, PIXXARO®, POWERFLEX®, QUELEX®, RADIANT®, RALLY®, REALM®, REBELEX®, RESICORE®, RESOLVE®, REVULIN®, REZUVANT®, RIDGEBACK®, SEQUOIA®, SIMPLICITY®, SONIC®, STARANE®, STEADFAST®, STINGER®, STRONGARM®, SUCCESS®, SURESTART®, SURPASS®, SURVEIL®, SYNCHRONY®, TARZEC®, TRANSFORM®, TRELLIS®, TRIVENCE®, UTRISHA®, VERTISAN®, VYDATE®, WIDEARMATCH®, WIDEMATCH® and ZEST® from Corteva Agroscience (Indianapolis, IN, USA); BIO-SAVE® from Decco U.S. Post-Harvest, Inc. (Monrovia, CA, USA); ALTACOR®, ATHENA®, AVAUNT®, BELEAF®, BRIGADE®, CARBINE®, CORAGEN®, ELEVEST®, EXIREL®, GLADIATOR®, HERO®, MUSTANG®, PREVATHON®, STEWARD®, VANTACOR®, VERIMARK®, LUCENTO®, RHYME®, ROVRAL®, TOPGUARD®, TERRA®, XYWAY®, AFFINITY®, AGILITY®, AIM®, ALLY®, ANTHEM®, AUTHORITY®, CAPTURE®®, ETHOS®, TEMITRY®, CADET®, COMMAND®, DISPLAY®, EXPRESS®, FINESSE®, FIRSTSHOT®, HARMONY®, MARVEL®, OBEY®, PANOFLEX®, SHARK®, SOLIDA®, SPARTAN®, UPBEET®, and ZEUS®, from FMC Corporation (Philadelphia, PA, USA); PENTIA®, ABAMEX®, AGRI TIN®, CHAMP®, CHIPTOX®, GIN OUT®, KAISO®, MEPEX®, NUPRID®, RAPPORT®, TERMINATE®, THISTROL®, ULTRA FLOURISH®, GOAL®, GOALTENDER®, GRAPPLE®, TUSCANY®, CHAMPION++, AGRI-MYCIN®, PHOSTROL®, BLIGHTBAN®, CHEETAH®, MYCOSHIELD®, RITEWAY®, TAZER®, MYSTIC®, CUPROXAT® and TYPY® from Nufarm Limited (Victoria, Australia); BIOSPECTRA®, PACRITE®, EFOG®, SHIELD-BRITE®, FUNGAFLOR®, PENBOTEC, and SOPP from Pace International (Wapato, WA, USA); ALUMNI®, CHAIRMAN®, GRADUATE®, GRADUATEA+®, MENTOR®, MERTECT®, SCHOLAR® and STADIUM® from Syngenta Crop Protection (Basel, Switzerland); and ASULOX®, BALISTIK®, BEETUP®, BELLMAC®, BETASANA®, BETTIX®, BUGUIS®, CENTURION®, CLIOPHAR®, COLZAMID®, CORZAL®, DEFIANT®, DEVRINOL®, MINSTREL®, AFFIX®, AXIDOR®, BUZZ®, MIMIX®, DIOZINOS®, DIPROSPERO®, EVITO®, MANZATE®, MICROTHIOL®, NAUTILE®, PENNCOZEB®, PROMESS®, PROPLANT®, PROXANIL®, PYRUS®, SACRON®, SYLLIT®, TEBUZOL®, THIOPRON®, TOKYO®, UNIZEB®, VACCIPLANT®, VIDEO®, ZOXIS®, CYTHRIN®, DIMILIN®, FORESTER®, FUMICYP®, TALISMA®, B-NINE®, FAZOR®, GYRO®, HIMALAYA®, ICENI®, TRINEXIS®, IODUS®, AUDIT®, BASAGRAN®, BATLIUM®, BOYCOTT®, BROADLOOM®, COYOTE®, COLLIDE®, DUET®, ETHOTRON®, EVEREST®, IMIFLEX®, LIFELINE®, METRICOR®, MOCCASIN®, MOTIF®, PRE-PARE®, SATELLITE®, SHADOW®, SHUTDOWN®, STAM®, SUPERWHAM!®, SUPREMACY®, TRICOR®, TRIZENTA®, CUPROFIX®, DEXTER®, ELEVATE®, ELIXIR®, FORTIX®, FROGHORN®, METEOR®, MICROTHI®, ORANIL®, PH-D®, PROCURE®, RANCOVA®, TEPERA®, TERRAGUARD®, TERRAMASTER®, TERRAZOLE®, TOPSIN®, TRIONIC®, ZIRAM®, ZOLERA®, ADIOS®, GOLDWING®, OFF-SHOOT-T®, PACZOL®, ROYAL®, ROYALTAC®, ACENTHRIN®, ACEPHATE®, ACRAMITE®, ADEPT®, ARGYLE®, ASSAIL®, BANTER®, BIFENTURE®, BIOMITE®, COMITE®, DIMILIN®, ENKOUNTER®, INTRUDER®, KANEMITE®, LAMBDA-CY®, MICROMITE®, OMITE®, PEDESTAL®, PERM-UP®, RIMON®, STRAFER®, TURNSTYLE®, UP-CYDE®, VENDEX®, VIGILANT®, ZYLO®, ATTENDANT®, BEAN GUARD®, ALLEGIANCE®, BELMONT®, ENHANCE®, GRAINGUARD®, MESH®, PRO-GRO®, RANCONA®, STARTUP®, THIRAM®, VITAFLO®, VITAVAX®, MAGNAPHOS®, WEEVIL-CIDE®, AQUASTRIKE®, AQUATHOL®, PEGASUS, GOLIATH, POACONSTRICTO®, RAVEN, T-BIRD, UP-END®, UP-START®, ETHEPHON PEGASUS, GOLIATH, POACONSTRICTO®, RAVEN, T-BIRD, UP-END®, UP-START®, ZEBA® and FLORAMITE® from UPL Limited (Mumbai, Maharashtra, India).

Examples of dispersants (spreaders) that may be included in formulations of the present disclosure include, but not are not limited to, anionic surfactants, cationic surfactants and non-ionic surfactants. See generally, e.g., EP 0245970; U.S. Pat. No. 5,496,568; WO 2008/144024; WO 2009/135049; WO 2011/126832; WO 2017/083049; WO 2020/225276; WO 2021/055316; WO 2022/096688; WO 2022/096691; WO 2022/096692; WO 2022/096693; WO 2022/096694; WO/2022/096695; WO 2022/096696.

In some embodiments, formulations of the present disclosure comprise one or more anionic surfactants. For example, in some embodiments, formulations of the present disclosure comprise one or more anionic surfactants selected from the group consisting of alkyl carboxylates (e.g., sodium stearate), alkyl sulfates (e.g., alkyl lauryl sulfate, sodium lauryl sulfate), alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, alkyl benzene sulfonates, alkyl diphenyloxide sulfonate, alpha-olefin sulfonates, alkyl naphthalene sulfonates, paraffin sulfonates, alkyl sulfosuccinates, alkyl ether sulfosuccinates, alkylamide sulfosuccinates, alkyl sulfosuccinamates, alkyl sulfoacetates, alkyl phosphates, alkyl ether phosphates, acyl sarconsinates, acyl isethionates, N-acyl taurates, N-acyl-N-alkyltaurates, benzene sulfonates, cumene sulfonates, dioctyl sodium sulfosuccinate, ethoxylated sulfosuccinates, lignin sulfonates, linear alkylbenzene sulfonates, monoglyceride sulfates, perfluorobutanesulfonate, perfluorooctanesulfonate, phosphate ester, styrene acrylic polymers, toluene sulfonates and xylene sulfonates.

In some embodiments, formulations of the present disclosure comprise one or more cationic surfactants. For example, in some embodiments, formulations of the present disclosure comprise one or more cationic surfactants selected from the group consisting of alkyltrimethylammonium salts (e.g., cetyl trimethylammonium bromide, cetyl trimethylammonium chloride), cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide and/or octenidine dihydrochloride.

In some embodiments, formulations of the present disclosure comprise one or more nonionic surfactants. For example, in some embodiments, formulations of the present disclosure comprise one or more nonionic surfactants selected from the group consisting of alcohol ethoxylates (e.g., TERGITOL™ 15-S surfactants (The Dow Chemical Company, Midland, MI), such as TERGITOL™15-S-9, alkanolamides, alkanolamine condensates, carboxylic acid esters, cetostearyl alcohol, cetyl alcohol, cocamide DEA, dodecyldimethylamine oxides, ethanolamides, ethoxylates of glycerol ester and glycol esters, ethylene oxide polymers, ethylene oxide-propylene oxide copolymers, glucoside alkyl ethers, glycerol alkyl ethers, glycerol esters, glycol alkyl ethers (e.g., polyoxyethylene glycol alkyl ethers, polyoxypropylene glycol alkyl ethers), glycol alkylphenol ethers (e.g., polyoxyethylene glycol alkylphenol ethers,), glycol esters, monolaurin, pentaethylene glycol monododecyl ethers, poloxamer, polyamines, polyglycerol polyricinoleate, polysorbate, polyoxyethylenated fatty acids, polyoxyethylenated mercaptans, polyoxyethylenated polyoxyproylene glycols, polyoxyethylene glycol sorbitan alkyl esters, polyethylene glycol-polypropylene glycol copolymers, polyoxyethylene glycol octylphenol ethers, polyvinyl pynolidones, sugar-based alkyl polyglycosides, sulfoanylamides, sorbitan fatty acid alcohol ethoxylates, sorbitan fatty acid ester ethoxylates, sorbitan fatty acid ester and/or tertiary acetylenic glycols.

In some embodiments, formulations of the present disclosure comprise one or more zwitterionic surfactants. For example, in some embodiments, formulations of the present disclosure comprise one or more zwitterionic surfactants selected from the group consisting of 3-[(3-cholamidopropyl)dimethylammonio]-1-propanesulfonate, cocamidopropyl betaine, cocamidopropyl hydroxysultaine, phosphatidylserine, phosphatidylethanolamine, phosphatidylcholine and/or one or more sphingomyelins.

In some embodiments, formulations of the present disclosure comprise one or more soaps and/or organosilicone surfactants.

Non-limiting examples of dispersants that may be incorporated into formulations of the present disclosure—or into which proteins and other compositions of the present disclosure may be incorporated—include ATLOX™ (e.g., 4916, 4991; Croda International PLC, Edison, NJ), ATLOX METASPERSE™ (Croda International PLC, Edison, NJ), BIO-SOFT® (e.g., N series, such as N1-3, N1-7, N1-5, N1-9, N23-3, N2.3-6.5, N25-3, N25-7, N25-9, N91-2.5, N91-6, N91-8; Stepan Company, Northfield, IL), MAKON® nonionic surfactants (e.g., DA-4, DA-6 and DA-9; Stepan Company, Northfield, IL), MORWET® powders (Akzo Nobel Surface Chemistry LLC, Chicago, IL), MULTIWET™ surfactants (e.g., MO-85P-PW-(AP); Croda International PLC, Edison, NJ), SILWET® L-77 (Helena Chemical Company, Collierville, TN), SPAN™ surfactants (e.g., 20, 40, 60, 65, 80 and 85; Croda Inc., Edison NJ), TAMOL™ dispersants (The Dow Chemical Company, Midland, MI), TERGITOL™ surfactants (e.g., TMN-6 and TMN-100X; The Dow Chemical Company, Midland, MI), TERSPERSE surfactants (e.g., 2001, 2020, 2100, 2105, 2158, 2700, 4894 and 4896; Hunstman Corp., The Woodlands, TX), TRITON™ surfactants (e.g., X-100; The Dow Chemical Company, Midland, MI), TWEEN® surfactants (e.g., TWEEN® 20, 21, 22, 23, 28, 40, 60, 61, 65, 80, 81 and 85; Croda International PLC, Edison, NJ) and combinations thereof. Additional examples of dispersants may be found in BAIRD & ZUBLENA. 1993. SOIL FACTS: USING WETTING AGENTS (NONIONIC SURFACTANTS) ON SOIL (North Carolina Cooperative Extension Service Publication AG-439-25) (1993); BURGES, FORMULATION OF MICROBIAL BIOPESTICIDES: BENEFICIAL MICROORGANISMS, NEMATODES AND SEED TREATMENTS (Springer Science & Business Media) (2012); MCCARTY, WETTING AGENTS (Clemson University Cooperative Extension Service Publication) (2001).

Examples of drying agents that may be included in formulations of the present disclosure include, but not are not limited to, drying powders. Non-limiting examples of drying agents include AEROSIL® hydrophobic fumed silica powders (Evonik Corporation, Parsippany, NJ), BENTOLITE® powders (BYK-Chemie GmbH, Wesel, Germany), INCOTEC® powders (INCOTEC Inc., Salinas, CA), SIPERNAT® silica powders (Evonik Corporation, Parsippany, NJ) and combinations thereof. Additional examples of drying agents may be found in BURGES, FORMULATION OF MICROBIAL BIOPESTICIDES: BENEFICIAL MICROORGANISMS, NEMATODES AND SEED TREATMENTS (Springer Science & Business Media) (2012). In some embodiments, compositions of the present disclosure comprise calcium stearate, clay (e.g., attapulgite clay, montmorillonite clay), graphite, magnesium stearate, magnesium sulfate, powdered milk, silica (e.g., fumed silica, hydrophobically-coated silica, precipitated silica), soy lecithin and/or talc.

Examples of microbes that may be included in formulations of the present disclosure include, but not are not limited to, diazotrophs, phosphate-solubilizing microorganisms and biopesticides. See generally, e.g., WO 92/08355; US 2003/082164; US 2008/320615; US 2016/345588; US 2018/168168; US 2005/187107; US 2006/258534; US 2018/279624; U.S. Ser. No. 10/820,594; US 2019/014786; U.S. Ser. No. 10/874,109; U.S. Ser. No. 10/856,552; US 2019/014787; U.S. Ser. No. 11/076,603; US 2020/093125; US 2020/085065; US 2020/000098; US 2019/345572; US 2020/263734; WO 2021/101949; WO 2021/101937; WO 2016/201284; WO 2018/186307; WO 2007/142543; WO 2017/205800; WO 2015/003908; WO 2021/018321; WO 2003/016510; WO 2016/044542; WO 92/11856.

In some embodiments, formulations of the present disclosure comprise one or more of the following: Azospirillum brasilense INTA Az-39, Bacillus amyloliquefaciens D747, Bacillus amyloliquefaciens NRRL B 50349, Bacillus amyloliquefaciens TJ1000, Bacillus amyloliquefaciens FZB24, Bacillus amyloliquefaciens FZB42, Bacillus amyloliquefaciens IN937a, Bacillus amyloliquefaciens IT-45, Bacillus amyloliquefaciens TJ1000, Bacillus amyloliquefaciens MBI600, Bacillus amyloliquefaciens BS27 (deposited as NRRL B-5015), Bacillus amyloliquefaciens BS2084 (deposited as NRRL B-50013), Bacillus amyloliquefaciens 15AP4 (deposited as ATCC PTA-6507), Bacillus amyloliquefaciens 3AP4 (deposited as ATCC PTA-6506), Bacillus amyloliquefaciens LSSA01 (deposited as NRRL B-50104), Bacillus amyloliquefaciens ABP278 (deposited as NRRL B-50634), Bacillus amyloliquefaciens 1013 (deposited as NRRL B-50509), Bacillus amyloliquefaciens 918 (deposited as NRRL B-50508), Bacillus amyloliquefaciens 22CP1 (deposited as ATCC PTA-6508) and Bacillus amyloliquefaciens BS18 (deposited as NRRL B-50633), Bacillus cereus I-1562, Bacillus firmus I-1582, Bacillus lichenformis BA842 (deposited as NRRL B-50516), Bacillus lichenformis BL21 (deposited as NRRL B-50134), Bacillus mycoides NRRL B-21664, Bacillus pumilus NRRL B 21662, Bacillus pumilus NRRL B-30087, Bacillus pumilus ATCC 55608, Bacillus pumilus ATCC 55609, Bacillus pumilus GB34, Bacillus pumilus KFP9F, Bacillus pumilus QST 2808, Bacillus subtilis ATCC 55078, Bacillus subtilis ATCC 55079, Bacillus subtilis MBI 600, Bacillus subtilis NRRL B-21661, Bacillus subtilis NRRL B-21665, Bacillus subtilis CX-9060, Bacillus subtilis GB03, Bacillus subtilis GB07, Bacillus subtilis QST-713, Bacillus subtilis FZB24, Bacillus subtilis D747, Bacillus subtilis 3BP5 (deposited as NRRL B-50510), Bacillus thuringiensis ATCC 13367, Bacillus thuringiensis GC-91, Bacillus thuringiensis NRRL B-21619, Bacillus thuringiensis ABTS-1857, Bacillus thuringiensis SAN 401 I, Bacillus thuringiensis ABG-6305, Bacillus thuringiensis ABG-6346, Bacillus thuringiensis AM65-52, Bacillus thuringiensis SA-12, Bacillus thuringiensis SB4, Bacillus thuringiensis ABTS-351, Bacillus thuringiensis HD-1, Bacillus thuringiensis EG 2348, Bacillus thuringiensis EG 7826, Bacillus thuringiensis EG 7841, Bacillus thuringiensis DSM 2803, Bacillus thuringiensis NB-125, Bacillus thuringiensis NB-176, Bradyrhizobium spp. 8A57, Bradyrhizobium elkanii SEMIA 501, Bradyrhizobium elkanii SEMIA 587, Bradyrhizobium elkanii SEMIA 5019, Bradyrhizobium japonicum 61A227, Bradyrhizobium japonicum 61A228, Bradyrhizobium japonicum 61A273, Bradyrhizobium japonicum E-109, Bradyrhizobium japonicum NRRL B-50586 (also deposited as NRRL B-59565), Bradyrhizobium japonicum NRRL B-50587 (also deposited as NRRL B-59566), Bradyrhizobium japonicum NRRL B-50588 (also deposited as NRRL B-59567), Bradyrhizobium japonicum NRRL B-50589 (also deposited as NRRL B-59568), Bradyrhizobium japonicum NRRL B-50590 (also deposited as NRRL B-59569), Bradyrhizobium japonicum NRRL B-50591 (also deposited as NRRL B-59570), Bradyrhizobium japonicum NRRL B-50592 (also deposited as NRRL B-59571), Bradyrhizobium japonicum NRRL B-50593 (also deposited as NRRL B-59572), Bradyrhizobium japonicum NRRL B-50594 (also deposited as NRRL B-50493), Bradyrhizobium japonicum NRRL B-50608, Bradyrhizobium japonicum NRRL B-50609, Bradyrhizobium japonicum NRRL B-50610, Bradyrhizobium japonicum NRRL B-50611, Bradyrhizobium japonicum NRRL B-50612, Bradyrhizobium japonicum NRRL B-50726, Bradyrhizobium japonicum NRRL B-50727, Bradyrhizobium japonicum NRRL B-50728, Bradyrhizobium japonicum NRRL B-50729, Bradyrhizobium japonicum NRRL B-50730, Bradyrhizobium japonicum SEMIA 566, Bradyrhizobium japonicum SEMIA 5079, Bradyrhizobium japonicum SEMIA 5080, Bradyrhizobium japonicum USDA 6, Bradyrhizobium japonicum USDA 110, Bradyrhizobium japonicum USDA 122, Bradyrhizobium japonicum USDA 123, Bradyrhizobium japonicum USDA 127, Bradyrhizobium japonicum USDA 129, Bradyrhizobium japonicum USDA 532C, Gliocladium virens ATCC 52045, Gliocladium virens GL-21, Glomus intraradices RTI-801, Metarhizium anisopliae F52, Penicillium bilaiae ATCC 18309, Penicillium bilaiae ATCC 20851, Penicillium bilaiae ATCC 22348, Penicillium bilaiae NRRL 50162, Penicillium bilaiae NRRL 50169, Penicillium bilaiae NRRL 50776, Penicillium bilaiae NRRL 50777, Penicillium bilaiae NRRL 50778, Penicillium bilaiae NRRL 50777, Penicillium bilaiae NRRL 50778, Penicillium bilaiae NRRL 50779, Penicillium bilaiae NRRL 50780, Penicillium bilaiae NRRL 50781, Penicillium bilaiae NRRL 50782, Penicillium bilaiae NRRL 50783, Penicillium bilaiae NRRL 50784, Penicillium bilaiae NRRL 50785, Penicillium bilaiae NRRL 50786, Penicillium bilaiae NRRL 50787, Penicillium bilaiae NRRL 50788, Penicillium bilaiae RS7B-SD1, Penicillium brevicompactum AgRF18, Penicillium canescens ATCC 10419, Penicillium expansum ATCC 24692, Penicillium expansum YT02, Penicillium fellatanum ATCC 48694, Penicillium gaestrivorus NRRL 50170, Penicillium glabrum DAOM 239074, Penicillium glabrum CBS 229.28, Penicillium janthinellum ATCC 10455, Penicillium lanosocoeruleum ATCC 48919, Penicillium radicum ATCC 201836, Penicillium radicum FRR 4717, Penicillium radicum FRR 4719, Penicillium radicum N93/47267, Penicillium raistrickii ATCC 10490, Pseudomonas jessenii PS06, Rhizobium leguminosarum SO12A-2 (IDAC 080305-01), Sinorhizobium fredii CCBAU114, Sinorhizobium fredii USDA 205, Trichoderma asperellum SKT-1, Trichoderma asperellum ICC 012, Trichoderma atroviride LC52, Trichoderma atroviride CNCM 1-1237, Trichoderma fertile JM41R, Trichoderma gamsii ICC 080, Trichoderma hamatum ATCC 52198, Trichoderma harzianum ATCC 52445, Trichoderma harzianum KRL-AG2, Trichoderma harzianum T-22, Trichoderma harzianum TH-35, Trichoderma harzianum T-39, Trichoderma harzianum ICC012, Trichoderma reesi ATCC 28217, Trichoderma virens ATCC 58678, Trichoderma virens Gl-3, Trichoderma virens GL-21, Trichoderma virens G-41, Trichoderma viridae ATCC 52440, Trichoderma viridae ICC080, Trichoderma viridae TV1, Yersinia entomophaga strain O43NEW (NRRL B-67598), Yersinia entomophaga strain O24G3R (NRRL B-67599), Yersinia entomophaga strain O24KEK (NRRL B-67600) and Yersinia entomophaga strain O333A4 (NRRL B-67601).

Non-limiting examples of microbial compositions that may be incorporated into formulations of the present disclosure—or into which proteins and other compositions of the present disclosure may be incorporated—include, but are not limited to, commercial products sold under the tradenames SERIFEL® from BASF (Ludwigshafen, Germany); VITIVO® from Bayer Crop Science (Creve Coeur, MO, USA); BIONIQ®, CELL-TECH®, JUMPSTART®, NITRAGIN®, OPTIMIZE®, QUICKROOTS® and TAGTEAM® from Novozymes North America, Inc. (Durham, NC, USA).

Examples of nutrients that may be included in formulations of the present disclosure include, but not are not limited to, organic acids (e.g., acetic acid, citric acid, lactic acid, malic acid, taurine, etc.), macrominerals (e.g., phosphorous, calcium, magnesium, potassium, sodium, iron, etc.), trace minerals (e.g., boron, cobalt, chloride, chromium, copper, fluoride, iodine, manganese, molybdenum, selenium, zinc, etc.), vitamins, (e.g., vitamin A, vitamin B complex (i.e., vitamin B₁, vitamin B₂, vitamin B₃, vitamin B₅, vitamin B₆, vitamin B₇, vitamin B₈, vitamin B₉, vitamin B₁₂, choline) vitamin C, vitamin D, vitamin E, vitamin K, carotenoids (α-carotene, β-carotene, cryptoxanthin, lutein, lycopene, zeaxanthin, etc.), and combinations thereof. See also, generally, e.g., US 2014/235447; WO 2022/029224; WO 2022/029221; WO 2021/255118; WO 2021/247915; US 2021/300837; US 2020/148605; US 2012/247164; US 2016/355443; US 2020/055794; US 2011/154873; US 2006/243009; US 2017/088474.

Examples of pest attractants and feeding stimulants that may be included in formulations of the present disclosure include, but not are not limited to, brevicomin, ceralure, codlelure, cue-lure, disparlure, dominicalure, eugenol, frontalin, gossyplure, grandlure, hexalure, ipsdienol, ipsenol, japonilure, latitlure, lineatin, litlure, looplure, medlure, megatomic acid, methyl eugenol, moguchun, α-multistriatin, muscalure, orfalure, oryctalure, ostramone, rescalure, siglure, sulcatol, trimedlure, trunc-call, and combinations thereof. See generally, e.g., WO 00/28824; U.S. Pat. Nos. 5,607,684; 4,510,133; 5,290,556; U.S. 60/774,634; U.S. Pat. No. 6,773,727; WO 2022/051661; EP 0563963; WO 2013/164384; WO 2003/020030; U.S. Pat. Nos. 8,420,070; 5,401,506; WO 92/11856.

Examples of postharvest treatments that may be included in formulations of the present disclosure include, but not are not limited to, essential oils, ethylene biosynthesis inhibitors (e.g., cyclopropenes), pesticides and waxes. See generally, e.g., WO 00/10386; WO 01/43548; US 2002/058592; US 2002/061822; US 2002/043730; US 2002/198107; US 2004/072694; US 2003/100450; US 2004/077502; US 2005/043179; US 2005/250649; US 2005/261131; US 2005/261132; US 2005/288189; CA 2512254; CA 2512256; US 2007/117720; US 2007/265166; US 2008/113867; US 2010/144533; US 2008/206823; US 2009/035380; US2009/077684; US 2009/118492; US 2009/230350; US 2010/047408; US 2011/321191; US 2011/034335; US 2011/014334; US 2012/272572; US 2012/282380; US2011/293801; US2012/004108; US2013/065764; US2012/258220; US2012/142534; US 2014/127309; US 2013/004634; US 2014/011679; US 2015/208679; WO 2014/120715; WO 2015/175157; WO 2017/180695; US 2014/080710; US 2015/237877; US 2015/272115; US 2016/000072; US 2015/366189; US 2014/242235; US 2014/271758; US 2016/066568; US 2016/095311; US 2015/018430; US 2015/087520; US 2015/231588; US 2015/366230; US 2016/235070; US 2016/324147; US 2017/251673; US 2017/251662; US 2017/251669; US 2017/265462; US 2017/318804; US 2018/139975; US 2018/356384; US 2021/102245; US 2021/238201; WO 2022/094214; EP 2468107; ES 2439616; WO 2014/128321; WO 2018/116027; WO 2018/128807; WO 2019/058211; WO 2020/157714; US 2009/253578; US 2009/253579; US 2004/146617; US 2022/087261; WO 2020/016728; US 2010/173773; US 2010/292080; U.S. Pat. No. 5,858,436; EP 0972450; U.S. Pat. Nos. 6,221,414; 6,723,364; WO 00/49880; U.S. Pat. No. 6,403,139; US 2005/129662; US 2006/228458; US 2005/137090; US 2006/276336; US 2008/175926; US 2008/016766; US 2008/145499; US 2010/092631; US 2010/081636; US 2011/003694; US 2011/008475; US 2010/298147; US 2013/072383; US 2013/156835; US 2013/266670; US 2013/236562; US 2013/178489; US 2014/187570; US 2013/306158; US 2013/341809; US 2016/330987; WO 2017/001502; US 2019/159469; WO 2017/220581; US 2020/060300; US 2020/221719; WO 2020/016154; WO 2020/225066; WO 2021/233900; WO 2005/058014.

Non-limiting examples of postharvest treatment compositions that may be incorporated into formulations of the present disclosure—or into which proteins and other compositions of the present disclosure may be incorporated—include commercial products sold under the tradenames ACTISEAL™, ETHYLBLOC, FRESHSTART, SMARTCITRUS, TEYCER, VITAFRESH from AgroFresh, Inc. (Philadelphia, PA, USA); CERAXEL®, CERASULFUR®, CERAQUINT®, ELIM®, MUSACARE® and CERAFRUTA from CERADIS Crop Protection (Ceradis B.V., Netherlands); APL-LUSTR®, APL-BRITE, BIO-SAVE®, CITRUBLUSH, CITRUS BRITE, CITRUS FIX™, CITRUS LUSTR®, DECCO and DECCONATUR™ from Decco U.S. Post-Harvest, Inc. (Monrovia, CA, USA); SEMPERFRESH, LUSTRE DRY, NATURAL SHINE®, PACRITE®, PRIMAFRESH®, SHIELD-BRITE®, EFOG® and XEDAQUIN from Pace International (Wapato, WA, USA); ALUMNI®, CHAIRMAN®, GRADUATE®, GRADUATEA+®, MENTOR®, MERTECT®, SCHOLAR® and STADIUM® from Syngenta Crop Protection (Basel, Switzerland); and MAGNAPHOS, QUICKPHLO-R, QUICKPHOS from UPL Limited (Mumbai, Maharashtra, India).

It is to be understood that many of the compounds described above as “chemical actives” and “chemical active compositions” may be applied to plants and plant parts both preharvest and postharvest and may therefore also be considered “postharvest treatments” and “postharvest treatment compositions.”

Examples of suitable UV protectants include, but not are not limited to, aromatic amino acids (e.g., tryptophan, tyrosine), carotenoids, cinnamates, lignosulfonates (e.g., calcium lignosulfonate, sodium lignosulfonate), melanins, mycosporines, polyphenols and/or salicylates). Non-limiting examples of UV protectants include Borregaard LignoTech™ lignosulfonates (e.g., Borresperse 3A, Borresperse CA, Borresperse NA, Marasperse AG, Norlig A, Norlig I1D, Ufoxane 3A, Ultrazine NA, Vanisperse CB; Borregaard Lignotech, Sarpsborg, Norway) and combinations thereof. Additional examples of UV protectants may be found in BURGES, FORMULATION OF MICROBIAL BIOPESTICIDES: BENEFICIAL MICROORGANISMS, NEMATODES AND SEED TREATMENTS (Springer Science & Business Media) (2012).

Examples of suitable wetting agents include, but are not limited to, naphthalene sulfonates, such as alkyl naphthalene sulfonates (e.g., sodium alkyl naphthalene sulfonate), isopropyl naphthalene sulfonates (e.g., sodium isopropyl naphthalene sulfonate) and butyl naphthalene sulfonates (e.g., sodium n-butyl naphthalene sulfonate).

It is to be understood that formulations of the present disclosure may comprise combinations of the enzymes, including, but not limited to combinations of enzymes expressly disclosed herein and combinations with enzymes that are not expressly disclosed herein.

In some embodiments, formulations of the present disclosure comprise 2, 3, 4, 5, 6, 7, 8, 9, 10 or more proteins of the present disclosure. For example, in some embodiments, formulations of the present disclosure comprise 2, 3, 4, 5, 6, 7, 8, 9, 10 or more of the polypeptides set forth herein as SEQ ID Nos: 1-48 and 98-150 or a mature polypeptide thereof.

It is to be understood that formulations of the present disclosure may comprise one or more filler and/or carrier materials to increase the volume and improve the handleability of the formulations. Suitable filler or carrier materials for granule/particle formulations include, but are not limited to, various salts of carbonate, chloride, silicate and sulfate, as well as talc, clay and the like. Suitable filler or carrier materials for liquid formulation include, but are not limited to, water or low molecular weight primary and secondary alcohols including polyols and diols. Examples of such alcohols include, but are not limited to, methanol, ethanol, propanol and isopropanol. In some embodiments, formulations of the present disclosure comprise about 5% to about 90% w/w of such filler/carrier materials.

In some preferred embodiments, formulations of the present disclosure, comprise, consist essentially of or consist of:
a) about 0.0001 to about 25% w/w protein (e.g., one or more proteins of the present disclosure), more preferably about 0.0001 to about 5% w/w, even more preferably about 0.001 to about 1% w/w;
b) about 25 to about 75% w/w enzyme stabilizer (e.g., one or more polyols, such as glycerol and/or sorbitol), more preferably about 25 to about 50% w/w, even more preferably about 35 to about 45% w/w;
c) about 0.001 to about 1% w/w preservative (e.g., potassium sorbate and/or sodium benzoate), more preferably about 0.01 to about 1% w/w, even more preferably 0.1 to about 0.5%; and
d) water.

In some preferred embodiments, formulations of the present disclosure, comprise, consist essentially of or consist of:
a) about 0.0001 to about 25% w/w protein (e.g., one or more proteins of the present disclosure), more preferably about 0.0001 to about 5% w/w, even more preferably about 0.001 to about 1% w/w;
b) about 0.001 to about 1% w/w preservative (e.g., potassium sorbate and/or sodium benzoate), more preferably about 0.01 to about 1% w/w, even more preferably 0.1 to about 0.5%; and
c) water.

In some preferred embodiments, formulations of the present disclosure, comprise, consist essentially of or consist of:
a) about 0.0001 to about 25% w/w protein (e.g., one or more proteins of the present disclosure), more preferably about 0.0001 to about 5% w/w, even more preferably about 0.001 to about 1% w/w;
b) about 25 to about 75% w/w enzyme stabilizer (e.g., one or more polyols, such as glycerol and/or sorbitol), more preferably about 25 to about 50% w/w, even more preferably about 35 to about 45% w/w; and
c) water.

In some preferred embodiments, formulations of the present disclosure, comprise, consist essentially of or consist of:
a) about 0.0001 to about 5% w/w protein (e.g., one or more proteins of the present disclosure), more preferably about 0.0001 to about 1% w/w, even more preferably about 0.0001 to about 0.5% w/w;
b) about 0.001 to about 10% w/w rain fastener (e.g., one or more organo-modified siloxanes, such as organo-modified trisiloxanes and organo-modified polysiloxanes), more preferably about 0.025 to about 1% w/w, even more preferably about 0.025 to about 0.5% w/w;
c) about 0.001 to about 5% w/w pH control component (e.g., one or more acetate, carbonate, citrate and/or phosphate buffers), more preferably about 0.01 to about 1% w/w, even more preferably 0.05 to about 0.5%; and
d) water.

In some preferred embodiments, formulations of the present disclosure, comprise, consist essentially of or consist of:
a) about 0.0001 to about 5% w/w protein (e.g., one or more proteins of the present disclosure), more preferably about 0.0001 to about 1% w/w, even more preferably about 0.0001 to about 0.5% w/w;
b) about 0.001 to about 10% w/w rain fastener (e.g., one or more organo-modified siloxanes, such as organo-modified trisiloxanes and organo-modified polysiloxanes), more preferably about 0.025 to about 1% w/w, even more preferably about 0.025 to about 0.5% w/w;
c) about 0.001 to about 5% w/w pH control component (e.g., one or more acetate, carbonate, citrate and/or phosphate buffers), more preferably about 0.01 to about 1% w/w, even more preferably 0.05 to about 0.5%;
d) about 1 to about 5% w/w enzyme stabilizer (e.g., one or more polyols, such as glycerol and/or sorbitol), more preferably about 1 to about 2.5% w/w, even more preferably about 1 to about 2% w/w; and
e) water.

As demonstrated in the Examples set forth below, combinations of enzymes may be particularly useful for preventing, treating, suppressing, eliminating and/or reducing the severity of infestations/infections of/by horticultural pests, such as acarids, bacteria, fungi, gastropods, insects, nematodes, oomycetes, protozoa and weeds.

In some embodiments, formulations of the present disclosure comprise two or more distinct cellulases.

In some embodiments, formulations of the present disclosure comprise two or more distinct glucanases.

In some embodiments, formulations of the present disclosure comprise two or more distinct hemicellulases.

In some embodiments, formulations of the present disclosure comprise two or more distinct pectinases.

In some embodiments, formulations of the present disclosure comprise two or more distinct peptidases.

In some embodiments, formulations of the present disclosure comprise two or more distinct proteases.

In some embodiments, formulations of the present disclosure comprise two or more distinct xylanases.

In some embodiments, formulations of the present disclosure comprise at least one cellulase and at least one hemicellulase.

In some embodiments, formulations of the present disclosure comprise at least one amylase, at least one glucanase, and at least one bacillolycin.

In some embodiments, formulations of the present disclosure comprise at least one cellulase, at least one hemicellulase, and at least one xylanase.

In some embodiments, formulations of the present disclosure comprise at least one cellulase, at least one glucanase, and at least one pectinase.

In some embodiments, formulations of the present disclosure comprise at least one cellulase, at least one glucanase, and at least one xylanase.

In some embodiments, formulations of the present disclosure comprise at least one cellulase and at least one xylanase.

In some embodiments, formulations of the present disclosure comprise at least one furanosidase and at least one xylanase.

In some embodiments, formulations of the present disclosure comprise at least one hemicellulase and at least one xylanase.

In some embodiments, formulations of the present disclosure comprise at least one peptidase and at least one protease.

In some embodiments, formulations of the present disclosure comprise a fermentation broth that comprises 2, 3, 4, 5, 6, 7, 8, 9, 10 or more enzymes.

In some embodiments, formulations of the present disclosure comprise a fermentation broth that comprises 2, 3, 4, 5, 6, 7, 8, 9, 10 or more proteins of the present disclosure.

The present disclosure also provides polynucleotides encoding proteins of the present disclosure, including, but not limited to, nucleic acid constructs, recombinant expression vectors and recombinant host cells that encode one or more enzymes of the present disclosure, as well as methods of producing such polynucleotides.

The polynucleotide may be a genomic DNA, a cDNA, a synthetic DNA, a synthetic RNA, a mRNA, or a combination thereof.

The polynucleotide may be cloned from any suitable genus, species or strain.

In some embodiments, the protein is cloned from a Gram-negative bacteria, such as Campylobacter, Dicytoglomus (e.g., D. thermophilum), Escherichia (e.g., E. coli), Flavobacterium, Fusobacterium, Helicobacter, Ilyobacter, Neisseria, Pseudomonas, Salmonella or Ureaplasma.

In some embodiments, the polynucleotide is cloned from a Gram-positive bacteria, such as Bacillus (e.g., B. agaradhaerens, Bacillus alkalophilus, Bacillus amyloliquefaciens, Bacillus brevis, Bacillus circulans, Bacillus clausii, Bacillus coagulans, B. deramificans, Bacillus firmus, Bacillus lautus, Bacillus lentus, Bacillus licheniformis, Bacillus megaterium, Bacillus pumilus, Bacillus stearothermophilus, Bacillus subtilis, Bacillus thuringiensis), Clostridium, Enterococcus, Geobacillus, Lactobacillus, Lactococcus, Oceanobacillus (e.g., O. barbara), Staphylococcus, Streptococcus (e.g., Streptococcus equisimilis, Streptococcus pyogenes, Streptococcus uberis, and Streptococcus equi subsp. Zooepidemicus) or Streptomyces (e.g., Streptomyces achromogenes, Streptomyces avermitilis, Streptomyces coelicolor, Streptomyces griseus, Streptomyces lividans).

In some embodiments, the polynucleotide is cloned from a fungus, such as Acremonium, Aspergillus (e.g., A. aculeatus, Aspergillus awamori, Aspergillus foetidus, Aspergillus fumigatus, Aspergillus japonicus, Aspergillus nidulans, Aspergillus niger, Aspergillus oryzae), Aureobasidium, Bjerkandera (e.g., Bjerkandera adusta), Ceriporiopsis (e.g., Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora), Chaetomium (e.g., C. erraticum), Chrysosporium (e.g., Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum), Coprinus (e.g., Coprinus cinereus), Coriolus (e.g., Coriolus hirsutus), Cryptococcus, Filibasidium, Fusarium (e.g., Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, F. solani, Fusarium sporotrichioides, Fusarium sulphureum, Fusarium torulosum, Fusarium trichothecioides, Fusarium venenatum), Humicola (e.g., Humicola insolens, Humicola lanuginosa), Magnaporthe, Microdochium (e.g., M. nivale), Mucor (e.g., Mucor miehei), Myceliophthora (e.g., Myceliophthora thermophila), Neocallimastix, Neurospora (e.g., Neurospora crassa), Paecilomyces, Penicillium (e.g., Penicillium purpurogenum), Phanerochaete (e.g., Phanerochaete chrysosporium), Phlebia (e.g., Phlebia radiata), Piromyces, Pleurotus (e.g., Pleurotus eryngii), Schizophyllum, Talaromyces (e.g., Talaromyces emersonii), Thermoascus (e.g., T. aurantiacus), Thielavia (e.g., Thielavia terrestris), Tolypocladium, Trametes (e.g., Trametes villosa, Trametes versicolor), or Trichoderma (e.g., T. atroviride, Trichoderma harzianum, Trichoderma koningii, Trichoderma longibrachiatum, Trichoderma reesei, Trichoderma viride).

In some embodiments, the polynucleotide is cloned from a yeast, such as Candida, Hansenula, Kluyveromyces (e.g., Kluyveromyces lactis), Pichia, Saccharomyces (e.g., Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis), Schizosaccharomyces, or Yarrowia (e.g., Yarrowia lipolytica).

In some embodiments, the polynucleotide encodes:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150;
c) a polypeptide derived from any one of SEQ ID NOs: 1-48 and 98-150 by substitution, deletion or insertion of one or more amino acids;
e) a polypeptide derived from a mature polypeptide any one of SEQ ID NOs: 1-48 and 98-150 by substitution, deletion or insertion of one or more amino acids;
f) a polypeptide derived from the polypeptide of any one of a) through e) wherein the N- and/or C-terminal end has been extended by the addition of one or more amino acids; and/or
g) a fragment of the polypeptide of any one of a) through f).

In preferred embodiments, the polynucleotide encodes a polypeptide that comprises, consists essentially of or consists of the amino acid sequence of any one of SEQ ID NOs: 1-48 and 98-150 or a mature polypeptide thereof.

In some embodiments, the polynucleotide comprises, consists essentially of or consists of a nucleic acid sequence having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof; In preferred embodiments, the polynucleotide comprises, consists essentially of or consists of the nucleic acid sequence of any one of SEQ ID NOs: 49-97 and 151-203 or a cDNA sequence thereof.

In some embodiments, the polynucleotide encodes a polypeptide that comprises, consists essentially of or consists of a fragment of one of SEQ ID NOs: 1-48 and 98-150 or a mature peptide thereof. For example, the polynucleotide may encode a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

In some embodiments, polynucleotides of the present disclosure encode a polypeptide that comprises, consists essentially of or consists of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

Polynucleotides of the present disclosure may be mutated by introduction of nucleotide substitutions that do not result in a change in the amino acid sequence of the protein, but which correspond to the codon usage of the host organism intended for production of the enzyme, or by introduction of nucleotide substitutions that may give rise to a different amino acid sequence. For a general description of nucleotide substitution, see, e.g., Ford et al., 1991, Protein Expression and Purification 2: 95-107.

In an aspect, the polynucleotide is isolated.

In another aspect, the polynucleotide is purified.

The present disclosure also relates to nucleic acid constructs comprising a polynucleotide of the present disclosure, wherein the polynucleotide is operably linked to one or more control sequences that direct the expression of the coding sequence in a suitable host cell under conditions compatible with the control sequences.

The polynucleotide may be manipulated in a variety of ways to provide for expression of the protein. Manipulation of the polynucleotide prior to its insertion into a vector may be desirable or necessary depending on the expression vector.

Techniques for modifying polynucleotides utilizing recombinant DNA methods are well known in the art.

The control sequence may be a promoter, a polynucleotide that is recognized by a host cell for expression of a polynucleotide encoding a protein of the present disclosure. The promoter contains transcriptional control sequences that mediate the expression of the protein. The promoter may be any polynucleotide that shows transcriptional activity in the host cell including mutant, truncated, and hybrid promoters, and may be obtained from genes encoding extracellular or intracellular proteins either homologous or heterologous to the host cell.

Examples of suitable promoters for directing transcription of the polynucleotide of the present disclosure in a bacterial host cell are described in Sambrook et al., 1989, Molecular Cloning: A Laboratory Manual, Cold Spring Harbor Lab., NY, Davis et al., 2012, supra, and Song et al., 2016, PLOS One 11(7): e0158447.

Examples of suitable promoters for directing transcription of the polynucleotide of the present disclosure in a filamentous fungal host cell are promoters obtained from Aspergillus, Fusarium, Rhizomucor and Trichoderma cells, such as the promoters described in Mukherjee et al., 2013, “Trichoderma: Biology and Applications”, and by Schmoll and Dattenböck, 2016, “Gene Expression Systems in Fungi: Advancements and Applications”, Fungal Biology.

For expression in a yeast host, examples of useful promoters are described by Smolke et al., 2018, “Synthetic Biology: Parts, Devices and Applications” (Chapter 6: Constitutive and Regulated Promoters in Yeast: How to Design and Make Use of Promoters in S. cerevisiae), and by Schmoll and Dattenböck, 2016, “Gene Expression Systems in Fungi: Advancements and Applications”, Fungal Biology.

The control sequence may also be a transcription terminator, which is recognized by a host cell to terminate transcription. The terminator is operably linked to the 3′-terminus of the polynucleotide encoding the protein. Any terminator that is functional in the host cell may be used in the present disclosure.

Preferred terminators for bacterial host cells may be obtained from the genes for Bacillus clausii alkaline protease (aprH), Bacillus licheniformis alpha-amylase (amyL), and Escherichia coli ribosomal RNA (rrnB).

Preferred terminators for filamentous fungal host cells may be obtained from Aspergillus or Trichoderma species, such as obtained from the genes for Aspergillus niger glucoamylase, Trichoderma reesei beta-glucosidase, Trichoderma reesei cellobiohydrolase I, and Trichoderma reesei endoglucanase I, such as the terminators described in Mukherjee et al., 2013, “Trichoderma: Biology and Applications”, and by Schmoll and Dattenböck, 2016, “Gene Expression Systems in Fungi: Advancements and Applications”, Fungal Biology.

Preferred terminators for yeast host cells may be obtained from the genes for Saccharomyces cerevisiae enolase, Saccharomyces cerevisiae cytochrome C (CYC1), and Saccharomyces cerevisiae glyceraldehyde-3-phosphate dehydrogenase. Other useful terminators for yeast host cells are described by Romanos et al., 1992, Yeast 8: 423-488.

The control sequence may also be an mRNA stabilizer region downstream of a promoter and upstream of the coding sequence of a gene which increases expression of the gene.

Examples of suitable mRNA stabilizer regions are obtained from a Bacillus thuringiensis cryIIIA gene (WO 94/25612) and a Bacillus subtilis SP82 gene (Hue et al., 1995, J. Bacteriol. 177: 3465-3471).

Examples of mRNA stabilizer regions for fungal cells are described in Geisberg et al., 2014, Cell 156(4): 812-824, and in Morozov et al., 2006, Eukaryotic Cell 5(11): 1838-1846.

The control sequence may also be a leader, a non-translated region of an mRNA that is important for translation by the host cell. The leader is operably linked to the 5′-terminus of the polynucleotide encoding the protein. Any leader that is functional in the host cell may be used.

Suitable leaders for bacterial host cells are described by Hambraeus et al., 2000, Microbiology 146(12): 3051-3059, and by Kaberdin and Blasi, 2006, FEMS Microbiol. Rev. 30(6): 967-979.

Preferred leaders for filamentous fungal host cells may be obtained from the genes for Aspergillus oryzae TAKA amylase and Aspergillus nidulans triose phosphate isomerase.

Suitable leaders for yeast host cells may be obtained from the genes for Saccharomyces cerevisiae enolase (ENO-1), Saccharomyces cerevisiae 3-phosphoglycerate kinase, Saccharomyces cerevisiae alpha-factor, and Saccharomyces cerevisiae alcohol dehydrogenase/glyceraldehyde-3-phosphate dehydrogenase (ADH2/GAP).

The control sequence may also be a polyadenylation sequence, a sequence operably linked to the 3′-terminus of the polynucleotide which, when transcribed, is recognized by the host cell as a signal to add polyadenosine residues to transcribed mRNA. Any polyadenylation sequence that is functional in the host cell may be used.

Preferred polyadenylation sequences for filamentous fungal host cells are obtained from the genes for Aspergillus nidulans anthranilate synthase, Aspergillus niger glucoamylase, Aspergillus niger alpha-glucosidase, Aspergillus oryzae TAKA amylase, and Fusarium oxysporum trypsin-like protease.

Useful polyadenylation sequences for yeast host cells are described by Guo and Sherman, 1995, Mol. Cellular Biol. 15: 5983-5990.

The control sequence may also be a signal peptide coding region that encodes a signal peptide linked to the N-terminus of a protein and directs the protein into the cell's secretory pathway. The 5′-end of the coding sequence of the polynucleotide may inherently contain a signal peptide coding sequence naturally linked in translation reading frame with the segment of the coding sequence that encodes the protein. Alternatively, the 5′-end of the coding sequence may contain a signal peptide coding sequence that is heterologous to the coding sequence. A heterologous signal peptide coding sequence may be required where the coding sequence does not naturally contain a signal peptide coding sequence.

Alternatively, a heterologous signal peptide coding sequence may simply replace the natural signal peptide coding sequence to enhance secretion of the protein. Any signal peptide coding sequence that directs the expressed protein into the secretory pathway of a host cell may be used.

Effective signal peptide coding sequences for bacterial host cells are the signal peptide coding sequences obtained from the genes for Bacillus NCIB 11837 maltogenic amylase, Bacillus licheniformis subtilisin, Bacillus licheniformis beta-lactamase, Bacillus stearothermophilus alpha-amylase, Bacillus stearothermophilus neutral proteases (nprT, nprS, nprM), and Bacillus subtilis prsA. Further signal peptides are described by Freudl, 2018, Microbial Cell Factories 17: 52.

Effective signal peptide coding sequences for filamentous fungal host cells are the signal peptide coding sequences obtained from the genes for Aspergillus niger neutral amylase, Aspergillus niger glucoamylase, Aspergillus oryzae TAKA amylase, Humicola insolens cellulase, Humicola insolens endoglucanase V, Humicola lanuginosa lipase, and Rhizomucor miehei aspartic proteinase, such as the signal peptide described by Xu et al., 2018, Biotechnology Letters 40: 949-955 Useful signal peptides for yeast host cells are obtained from the genes for Saccharomyces cerevisiae alpha-factor and Saccharomyces cerevisiae invertase. Other useful signal peptide coding sequences are described by Romanos et al., 1992, supra.

The control sequence may also be a propeptide coding sequence that encodes a propeptide positioned at the N-terminus of a protein. The resultant protein is known as a proenzyme or proprotein (or a zymogen in some cases). A proprotein is generally inactive and can be converted to an active protein by catalytic or autocatalytic cleavage of the propeptide from the proprotein. The propeptide coding sequence may be obtained from the genes for Bacillus subtilis alkaline protease (aprE), Bacillus subtilis neutral protease (nprT), Myceliophthora thermophila laccase (WO 95/33836), Rhizomucor miehei aspartic proteinase, and Saccharomyces cerevisiae alpha-factor.

Where both signal peptide and propeptide sequences are present, the propeptide sequence is positioned next to the N-terminus of a protein and the signal peptide sequence is positioned next to the N-terminus of the propeptide sequence. Additionally or alternatively, when both signal peptide and propeptide sequences are present, the protein may comprise only a part of the signal peptide sequence and/or only a part of the propeptide sequence. Alternatively, the final or isolated protein may comprise a mixture of mature proteins and proteins which comprise, either partly or in full length, a propeptide sequence and/or a signal peptide sequence.

It may also be desirable to add regulatory sequences that regulate expression of the protein relative to the growth of the host cell. Examples of regulatory sequences are those that cause expression of the gene to be turned on or off in response to a chemical or physical stimulus, including the presence of a regulatory compound. Regulatory sequences in prokaryotic systems include the lac, tac, and trp operator systems. In yeast, the ADH2 system or GAL1 system may be used. In filamentous fungi, the Aspergillus niger glucoamylase promoter, Aspergillus oryzae TAKA alpha-amylase promoter, and Aspergillus oryzae glucoamylase promoter, Trichoderma reesei cellobiohydrolase I promoter, and Trichoderma reesei cellobiohydrolase II promoter may be used. Other examples of regulatory sequences are those that allow for gene amplification. In fungal systems, these regulatory sequences include the dihydrofolate reductase gene that is amplified in the presence of methotrexate, and the metallothionein genes that are amplified with heavy metals.

The control sequence may also be a transcription factor, a polynucleotide encoding a polynucleotide-specific DNA-binding protein that controls the rate of the transcription of genetic information from DNA to mRNA by binding to a specific polynucleotide sequence. The transcription factor may function alone and/or together with one or more other proteins or transcription factors in a complex by promoting or blocking the recruitment of RNA polymerase. Transcription factors are characterized by comprising at least one DNA-binding domain which often attaches to a specific DNA sequence adjacent to the genetic elements which are regulated by the transcription factor. The transcription factor may regulate the expression of a protein of interest either directly, i.e., by activating the transcription of the gene encoding the protein of interest by binding to its promoter, or indirectly, i.e., by activating the transcription of a further transcription factor which regulates the transcription of the gene encoding the protein of interest, such as by binding to the promoter of the further transcription factor. Suitable transcription factors for fungal host cells are described in WO 2017/144177. Suitable transcription factors for prokaryotic host cells are described in Seshasayee et al., 2011, Subcellular Biochemistry 52: 7-23, as well in Balleza et al., 2009, FEMS Microbiol. Rev. 33(1): 133-151.

The present disclosure also relates to recombinant expression vectors comprising a polynucleotide of the present disclosure, a promoter, and transcriptional and translational stop signals. The various nucleotide and control sequences may be joined together to produce a recombinant expression vector that may include one or more convenient restriction sites to allow for insertion or substitution of the polynucleotide encoding the protein at such sites. Alternatively, the polynucleotide may be expressed by inserting the polynucleotide or a nucleic acid construct comprising the polynucleotide into an appropriate vector for expression. In creating the expression vector, the coding sequence is located in the vector so that the coding sequence is operably linked with the appropriate control sequences for expression.

The recombinant expression vector may be any vector (e.g., a plasmid or virus) that can be conveniently subjected to recombinant DNA procedures and can bring about expression of the polynucleotide. The choice of the vector will typically depend on the compatibility of the vector with the host cell into which the vector is to be introduced. The vector may be a linear or closed circular plasmid.

The vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome. The vector may contain any means for assuring self-replication. Alternatively, the vector may be one that, when introduced into the host cell, is integrated into the genome and replicated together with the chromosome(s) into which it has been integrated. Furthermore, a single vector or plasmid or two or more vectors or plasmids that together contain the total DNA to be introduced into the genome of the host cell, or a transposon, may be used.

The vector preferably contains one or more selectable markers that permit easy selection of transformed, transfected, transduced, or the like cells. A selectable marker is a gene the product of which provides for biocide or viral resistance, resistance to heavy metals, prototrophy to auxotrophs, and the like.

The vector preferably contains at least one element that permits integration of the vector into the host cell's genome or autonomous replication of the vector in the cell independent of the genome.

For integration into the host cell genome, the vector may rely on the polynucleotide's sequence encoding the protein or any other element of the vector for integration into the genome by homologous recombination, such as homology-directed repair (HDR), or non-homologous recombination, such as non-homologous end-joining (NHEJ).

For autonomous replication, the vector may further comprise an origin of replication enabling the vector to replicate autonomously in the host cell in question. The origin of replication may be any plasmid replicator mediating autonomous replication that functions in a cell. The term “origin of replication” or “plasmid replicator” means a polynucleotide that enables a plasmid or vector to replicate in vivo.

More than one copy of a polynucleotide of the present disclosure may be inserted into a host cell to increase production of a protein. For example, 2 or 3 or 4 or 5 or more copies are inserted into a host cell. An increase in the copy number of the polynucleotide can be obtained by integrating at least one additional copy of the sequence into the host cell genome or by including an amplifiable selectable marker gene with the polynucleotide where cells containing amplified copies of the selectable marker gene, and thereby additional copies of the polynucleotide, can be selected for by cultivating the cells in the presence of the appropriate selectable agent.

The present disclosure also provides cells expressing one or more proteins of the present disclosure, including microorganisms that naturally express one or more enzymes of the present disclosure and microorganisms that have been engineered to express one or more enzymes of the present disclosure.

In some embodiments, the cell expresses:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof;
d) a polypeptide derived from any one of SEQ ID NOs: 1-48 and 98-150 by substitution, deletion or insertion of one or more amino acids;
e) a polypeptide derived from a mature polypeptide any one of SEQ ID NOs: 1-48 and 98-150 by substitution, deletion or insertion of one or more amino acids;
f) a polypeptide derived from the polypeptide of any one of a) through e) wherein the N- and/or C-terminal end has been extended by the addition of one or more amino acids; and/or
g) a fragment of the polypeptide of any one of a) through f).

In preferred embodiments, the cell expresses a polypeptide that comprises, consists essentially of or consists of the amino acid sequence of any one of SEQ ID NOs: 1-48 and 98-150 or a mature polypeptide thereof.

In some embodiments, the cell expresses a polypeptide that comprises, consists essentially of or consists of a fragment of one of SEQ ID NOs: 1-48 and 98-150 or a mature peptide thereof. For example, the microorganism may express a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

In some embodiments, the cell expresses a polypeptide that comprises, consists essentially of or consists of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

In some embodiments, the cell comprises a homologous or heterologous nucleic acid sequence that is at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the nucleic acid sequences set forth herein as SEQ ID Nos: 49-97 and 151-203 or the cDNA sequence thereof.

In preferred embodiments, the cell comprises a polynucleotide encodes a polypeptide that comprises, consists essentially of or consists of the amino acid sequence of any one of SEQ ID NOs: 1-48 and 98-150 or a mature polypeptide thereof.

In some embodiments, the cell comprises a polynucleotide that comprises, consists essentially of or consists of a nucleic acid sequence encoding a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150.

In some embodiments, the cell comprises a polynucleotide that comprises, consists essentially of or consists of a nucleic acid sequence encoding a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150.

In preferred embodiments, the cell comprises a polynucleotide that comprises, consists essentially of or consists of the nucleic acid sequence of any one of SEQ ID NOs: 49-97 and 151-203 or a cDNA sequence thereof.

In some embodiments, the cell comprises a polynucleotide that encodes a polypeptide that comprises, consists essentially of or consists of a fragment of one of SEQ ID NOs: 1-48 and 98-150 or a mature peptide thereof. For example, the microorganism comprises a polynucleotide that encodes a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

In some embodiments, the cell comprises a polynucleotide that encodes a polypeptide that comprises, consists essentially of or consists of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

The present disclosure thus extends to recombinant host cells, comprising a polynucleotide of the present disclosure operably linked to one or more control sequences that direct the production of a protein of the present disclosure.

A construct or vector comprising a polynucleotide is introduced into a host cell so that the construct or vector is maintained as a chromosomal integrant or as a self-replicating extra-chromosomal vector as described earlier. The choice of a host cell will to a large extent depend upon the gene encoding the protein and its source. The protein can be native or heterologous to the recombinant host cell. Also, at least one of the one or more control sequences can be heterologous to the polynucleotide encoding the protein. The recombinant host cell may comprise a single copy, or at least two copies, e.g., three, four, five, or more copies of the polynucleotide of the present disclosure.

The host cell may be any microbial cell useful in the recombinant production of a protein of the present disclosure, e.g., a prokaryotic cell or a fungal cell.

The prokaryotic host cell may be any Gram-positive or Gram-negative bacterium. Gram-positive bacteria include, but are not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but are not limited to, Campylobacter, E. coli, Flavobacterium, Fusobacterium, Helicobacter, Ilyobacter, Neisseria, Pseudomonas, Salmonella, and Ureaplasma.

The bacterial host cell may be any Bacillus cell including, but not limited to, Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus lichenformis, Bacillus megaterium, Bacillus pumilus, Bacillus stearothermophilus, Bacillus subtilis, and Bacillus thuringiensis cells. In an embodiment, the Bacillus cell is a Bacillus amyloliquefaciens, Bacillus licheniformis and Bacillus subtilis cell.

For purposes of this disclosure, Bacillus classes/genera/species shall be defined as described in Patel and Gupta, 2020, Int. J. Syst. Evol. Microbiol. 70: 406-438.

The bacterial host cell may also be any Streptococcus cell including, but not limited to, Streptococcus equisimilis, Streptococcus pyogenes, Streptococcus uberis, and Streptococcus equi subsp. Zooepidemicus cells.

The bacterial host cell may also be any Streptomyces cell including, but not limited to, Streptomyces achromogenes, Streptomyces avermitilis, Streptomyces coelicolor, Streptomyces griseus, and Streptomyces lividans cells.

Methods for introducing DNA into prokaryotic host cells are well-known in the art, and any suitable method can be used including but not limited to protoplast transformation, competent cell transformation, electroporation, conjugation, transduction, with DNA introduced as linearized or as circular polynucleotide. Persons skilled in the art will be readily able to identify a suitable method for introducing DNA into a given prokaryotic cell depending, e.g., on the genus. Methods for introducing DNA into prokaryotic host cells are for example described in Heinze et al., 2018, BMC Microbiology 18:56, Burke et al., 2001, Proc. Natl. Acad. Sci. USA 98: 6289-6294, Choi et al., 2006, J. Microbiol. Methods 64: 391-397, and Donald et al., 2013, J. Bacteriol. 195(11): 2612-2620.

The host cell may be a fungal cell. “Fungi” as used herein includes the phyla Ascomycota, Basidiomycota, Chytridiomycota, and Zygomycota as well as the Oomycota and all mitosporic fungi (as defined by Hawksworth et al., In, Ainsworth and Bisby's Dictionary of The Fungi, 8th edition, 1995, CAB International, University Press, Cambridge, UK).

Fungal cells may be transformed by a process involving protoplast-mediated transformation, Agrobacterium-mediated transformation, electroporation, biolistic method and shock-wave-mediated transformation as reviewed by Li et al., 2017, Microbial Cell Factories 16: 168 and procedures described in EP 238023, Yelton et al., 1984, Proc. Natl. Acad. Sci. USA 81: 1470-1474, Christensen et al., 1988, Bio/Technology 6: 1419-1422, and Lubertozzi and Keasling, 2009, Biotechn. Advances 27: 53-75. However, any method known in the art for introducing DNA into a fungal host cell can be used, and the DNA can be introduced as linearized or as circular polynucleotide.

The fungal host cell may be a yeast cell. “Yeast” as used herein includes ascosporogenous yeast (Endomycetales), basidiosporogenous yeast, and yeast belonging to the Fungi Imperfecti (Blastomycetes). For purposes of this disclosure, yeast shall be defined as described in Biology and Activities of Yeast (Skinner, Passmore, and Davenport, editors, Soc. App. Bacteriol. Symposium Series No. 9, 1980).

The yeast host cell may be a Candida, Hansenula, Kluyveromyces, Pichia, Saccharomyces, Schizosaccharomyces, or Yarrowia cell, such as a Kluyveromyces lactis, Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell. In a preferred embodiment, the yeast host cell is a Pichia or Komagataella cell, e.g., a Pichia pastoris cell (Komagataella phaffii).

The fungal host cell may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungal host cell may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell. In a preferred embodiment, the filamentous fungal host cell is an Aspergillus, Trichoderma or Fusarium cell. In a further preferred embodiment, the filamentous fungal host cell is an Aspergillus niger, Aspergillus oryzae, Trichoderma reesei, or Fusarium venenatum cell.

For example, the filamentous fungal host cell may be an Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Talaromyces emersonii, Thielavia terrestris, Trametes villosa, Trametes versicolor, Trichoderma harzianum, Trichoderma koningii, Trichoderma longibrachiatum, Trichoderma reesei, or Trichoderma viride cell.

In an aspect, the host cell is isolated.

In another aspect, the host cell is purified.

The present disclosure also provides plants and plant parts expressing one or more proteins of the present disclosure, including plants that naturally express one or more enzymes of the present disclosure and plants that have been engineered to express one or more enzymes of the present disclosure.

In some embodiments, the plant or plant part expresses:
a) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150;
b) a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150;
c) a polypeptide encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof;
d) a polypeptide derived from any one of SEQ ID NOs: 1-48 and 98-150 by substitution, deletion or insertion of one or more amino acids;
e) a polypeptide derived from a mature polypeptide any one of SEQ ID NOs: 1-48 and 98-150 by substitution, deletion or insertion of one or more amino acids;
f) a polypeptide derived from the polypeptide of any one of a) through e) wherein the N- and/or C-terminal end has been extended by the addition of one or more amino acids; and/or
g) a fragment of the polypeptide of any one of a) through f).

In preferred embodiments, the plant or plant part expresses a polypeptide that comprises, consists essentially of or consists of the amino acid sequence of any one of SEQ ID NOs: 1-48 and 98-150 or a mature polypeptide thereof.

In some embodiments, the plant or plant part expresses a polypeptide that comprises, consists essentially of or consists of a fragment of one of SEQ ID NOs: 1-48 and 98-150 or a mature peptide thereof. For example, the microorganism may express a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

In some embodiments, the plant or plant part expresses a polypeptide that comprises, consists essentially of or consists of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

In some embodiments, the plant or plant part comprises a homologous or heterologous nucleic acid sequence that is at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the nucleic acid sequences set forth herein as SEQ ID Nos: 49-97 and 151-203 or the cDNA sequence thereof.

In preferred embodiments, the plant or plant part comprises a polynucleotide encodes a polypeptide that comprises, consists essentially of or consists of the amino acid sequence of any one of SEQ ID NOs: 1-48 and 98-150 or a mature polypeptide thereof.

In some embodiments, the plant or plant part comprises a polynucleotide that comprises, consists essentially of or consists of a nucleic acid sequence encoding a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 1-48 and 98-150.

In some embodiments, the plant or plant part comprises a polynucleotide that comprises, consists essentially of or consists of a nucleic acid sequence encoding a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to a mature polypeptide of any one or more of SEQ ID NOs: 1-48 and 98-150.

In preferred embodiments, the plant or plant part comprises a polynucleotide that comprises, consists essentially of or consists of the nucleic acid sequence of any one of SEQ ID NOs: 49-97 and 151-203 or a cDNA sequence thereof.

In some embodiments, the plant or plant part comprises a polynucleotide that encodes a polypeptide that comprises, consists essentially of or consists of a fragment of one of SEQ ID NOs: 1-48 and 98-150 or a mature peptide thereof. For example, the microorganism comprises a polynucleotide that encodes a fragment of any one of SEQ ID NOs: 1-48 and 98-150 or a mature peptide thereof, said fragment comprising at least 85, 86, 87, 88, 89, 90, 91, 92, 93, 94, 95, 96, 97, 98 or 99% of the amino acids found in the original protein.

In some embodiments, the plant or plant part comprises a polynucleotide that encodes a polypeptide that comprises, consists essentially of or consists of any one of SEQ ID NOs: 1-48 and 98-150 or a mature polypeptide thereof with an N-terminal extension of one or more amino acids (e.g., 1, 2, 3, 4, 5, 6, 7, 8, 9, 10, 11, 12, 13, 14, 15, 16, 17, 18, 19, 20 or more amino acids), a C-terminal extension of one or more amino acids (e.g., 1, 2, 3, 4, 5, 6, 7, 8, 9, 10, 11, 12, 13, 14, 15, 16, 17, 18, 19, 20 or more amino acids), one or more substitutions (e.g., 1, 2, 3, 4, 5, 6, 7, 8, 9, 10, 11, 12, 13, 14, 15, 16, 17, 18, 19, 20 or more substitutions), one or more insertions (e.g., 1, 2, 3, 4, 5, 6, 7, 8, 9, 10, 11, 12, 13, 14, 15, 16, 17, 18, 19, 20 or more insertions), and/or one or more deletions (e.g., 1, 2, 3, 4, 5, 6, 7, 8, 9, 10, 11, 12, 13, 14, 15, 16, 17, 18, 19, 20 or more deletions). The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding module.

The present disclosure also extends to plants, e.g., a transgenic plant, plant part, or plant cell, comprising a polynucleotide of the present disclosure so as to express and produce a protein of the present disclosure in recoverable quantities. The protein may be recovered from the plant or plant part. Alternatively, the plant or plant part containing the protein may be used as such for improving the quality of a food or feed, e.g., improving nutritional value, palatability, and rheological properties, or to destroy an antinutritive factor.

The transgenic plant can be dicotyledonous (a dicot) or monocotyledonous (a monocot). Examples of monocot plants are grasses, such as meadow grass (blue grass, Poa), forage grass such as Festuca, Lolium, temperate grass, such as Agrostis, and cereals, e.g., wheat, oats, rye, barley, rice, sorghum, and maize (corn).

Examples of dicot plants are tobacco, legumes, such as lupins, potato, sugar beet, pea, bean and soybean, and cruciferous plants (family Brassicaceae), such as cauliflower, rape seed, and the closely related model organism Arabidopsis thaliana.

Examples of plant parts are stem, callus, leaves, root, fruits, seeds, and tubers as well as the individual tissues comprising these parts, e.g., epidermis, mesophyll, parenchyme, vascular tissues, meristems. Specific plant cell compartments, such as chloroplasts, apoplasts, mitochondria, vacuoles, peroxisomes and cytoplasm are also considered to be a plant part. Furthermore, any plant cell, whatever the tissue origin, is considered to be a plant part. Likewise, plant parts such as specific tissues and cells isolated to facilitate the utilization of the invention are also considered plant parts, e.g., embryos, endosperms, aleurone and seed coats.

Also included within the scope of the present disclosure are the progeny of such plants, plant parts, and plant cells.

The transgenic plant or plant cell expressing the protein may be constructed in accordance with methods known in the art. In short, the plant or plant cell is constructed by incorporating one or more expression constructs encoding the protein into the plant host genome or chloroplast genome and propagating the resulting modified plant or plant cell into a transgenic plant or plant cell. In an embodiment, a plant cell does not belong to plant varieties.

The expression construct is conveniently a nucleic acid construct that comprises a polynucleotide encoding a protein, wherein the polynucleotide is operably linked with appropriate regulatory sequences required for expression of the polynucleotide in the plant or plant part of choice. Furthermore, the expression construct may comprise a selectable marker useful for identifying plant cells into which the expression construct has been integrated and DNA sequences necessary for introduction of the construct into the plant in question (the latter depends on the DNA introduction method to be used).

The choice of regulatory sequences, such as promoter and terminator sequences and optionally signal or transit sequences, is determined, for example, on the basis of when, where, and how the protein is desired to be expressed (Sticklen, 2008, Nature Reviews 9: 433-443). For instance, the expression of the gene encoding a protein may be constitutive or inducible, or may be developmental, stage or tissue specific, and the gene product may be targeted to a specific tissue or plant part such as seeds or leaves. Regulatory sequences are, for example, described by Tague et al., 1988, Plant Physiology 86: 506.

For constitutive expression, the 35S-CaMV, the maize ubiquitin 1, or the rice actin 1 promoter may be used (Franck et al., 1980, Cell 21: 285-294; Christensen et al., 1992, Plant Mol. Biol. 18: 675-689; Zhang et al., 1991, Plant Cell 3: 1155-1165). Organ-specific promoters may be, for example, a promoter from storage sink tissues such as seeds, potato tubers, and fruits (Edwards and Coruzzi, 1990, Ann. Rev. Genet. 24: 275-303), or from metabolic sink tissues such as meristems (Ito et al., 1994, Plant Mol. Biol. 24: 863-878), a seed specific promoter such as the glutelin, prolamin, globulin, or albumin promoter from rice (Wu et al., 1998, Plant Cell Physiol. 39: 885-889), a Vicia faba promoter from the legumin B4 and the unknown seed protein gene from Vicia faba (Conrad et al., 1998, J. Plant Physiol. 152: 708-711), a promoter from a seed oil body protein (Chen et al., 1998, Plant Cell Physiol. 39: 935-941), the storage protein napA promoter from Brassica napus, or any other seed specific promoter known in the art, e.g., as described in WO 91/14772. Furthermore, the promoter may be a leaf specific promoter such as the rbcs promoter from rice or tomato (Kyozuka et al., 1993, Plant Physiol. 102: 991-1000), the chlorella virus adenine methyltransferase gene promoter (Mitra and Higgins, 1994, Plant Mol. Biol. 26: 85-93), the aldP gene promoter from rice (Kagaya et al., 1995, Mol. Gen. Genet. 248: 668-674), or a wound inducible promoter such as the potato pin2 promoter (Xu et al., 1993, Plant Mol. Biol. 22: 573-588). Likewise, the promoter may be induced by abiotic treatments such as temperature, drought, or alterations in salinity or induced by exogenously applied substances that activate the promoter, e.g., ethanol, oestrogens, plant hormones such as ethylene, abscisic acid, and gibberellic acid, and heavy metals.

A promoter enhancer element may also be used to achieve higher expression of a protein in the plant. For instance, the promoter enhancer element may be an intron that is placed between the promoter and the polynucleotide encoding a protein. For instance, Xu et al., 1993, supra, disclose the use of the first intron of the rice actin 1 gene to enhance expression.

The selectable marker gene and any other parts of the expression construct may be chosen from those available in the art.

The nucleic acid construct is incorporated into the plant genome according to conventional techniques known in the art, including Agrobacterium-mediated transformation, virus-mediated transformation, microinjection, particle bombardment, biolistic transformation, and electroporation (Gasser et al., 1990, Science 244: 1293; Potrykus, 1990, Bio/Technology 8: 535; Shimamoto et al., 1989, Nature 338: 274).

Agrobacterium tumefaciens-mediated gene transfer is a method for generating transgenic dicots (for a review, see Hooykas and Schilperoort, 1992, Plant Mol. Biol. 19: 15-38) and for transforming monocots, although other transformation methods may be used for these plants. A method for generating transgenic monocots is particle bombardment (microscopic gold or tungsten particles coated with the transforming DNA) of embryonic calli or developing embryos (Christou, 1992, Plant J. 2: 275-281; Shimamoto, 1994, Curr. Opin. Biotechnol. 5: 158-162; Vasil et al., 1992, Bio/Technology 10: 667-674). An alternative method for transformation of monocots is based on protoplast transformation as described by Omirulleh et al., 1993, Plant Mol. Biol. 21: 415-428. Additional transformation methods include those described in U.S. Pat. Nos. 6,395,966 and 7,151,204 (both of which are herein incorporated by reference in their entirety).

Following transformation, the transformants having incorporated the expression construct are selected and regenerated into whole plants according to methods well known in the art. Often the transformation procedure is designed for the selective elimination of selection genes either during regeneration or in the following generations by using, for example, co-transformation with two separate T-DNA constructs or site-specific excision of the selection gene by a specific recombinase.

In addition to direct transformation of a particular plant genotype with a construct of the present disclosure, transgenic plants may be made by crossing a plant having the construct to a second plant lacking the construct. For example, a construct encoding a protein can be introduced into a particular plant variety by crossing, without the need for ever directly transforming a plant of that given variety. Therefore, the present disclosure encompasses not only a plant directly regenerated from cells which have been transformed in accordance with the present disclosure, but also the progeny of such plants. As used herein, progeny may refer to the offspring of any generation of a parent plant prepared in accordance with the present disclosure. Such progeny may include a DNA construct prepared in accordance with the present disclosure. Crossing results in the introduction of a transgene into a plant line by cross pollinating a starting line with a donor plant line. Non-limiting examples of such steps are described in U.S. Pat. No. 7,151,204.

Plants may be generated through a process of backcross conversion. For example, plants include plants referred to as a backcross converted genotype, line, inbred, or hybrid.

Genetic markers may be used to assist in the introgression of one or more transgenes of the disclosure from one genetic background into another. Marker assisted selection offers advantages relative to conventional breeding in that it can be used to avoid errors caused by phenotypic variations. Further, genetic markers may provide data regarding the relative degree of elite germplasm in the individual progeny of a particular cross. For example, when a plant with a desired trait which otherwise has a non-agronomically desirable genetic background is crossed to an elite parent, genetic markers may be used to select progeny which not only possess the trait of interest, but also have a relatively large proportion of the desired germplasm. In this way, the number of generations required to introgress one or more traits into a particular genetic background is minimized.

The present disclosure also relates to methods of producing a protein of the present disclosure comprising (a) cultivating a transgenic plant or a plant cell comprising a polynucleotide encoding the protein under conditions conducive for production of the protein; and (b) recovering the protein.

The present disclosure also extends to methods of producing a mutant of a parent cell, which comprises disrupting or deleting a polynucleotide, or a portion thereof, encoding a protein of the present disclosure, which results in the mutant cell producing less of the protein than the parent cell when cultivated under the same conditions.

The mutant cell may be constructed by reducing or eliminating expression of the polynucleotide using methods well known in the art, for example, one or more nucleotide insertions, one or more gene disruptions, one or more nucleotide replacements, or one or more nucleotide deletions.

The polynucleotide to be modified or inactivated may be, for example, the coding region or a part thereof essential for activity, or a regulatory or control element required for expression of the coding region, e.g., a functional part of a promoter sequence, and/or a regulatory or control element required for the transcription or translation of the polynucleotide. Other control sequences for possible modification include, but are not limited to, a leader, polyadenylation sequence, propeptide sequence, signal peptide sequence, transcription terminator, and transcriptional activator.

Modification or inactivation of the polynucleotide may be performed by subjecting the parent cell to mutagenesis and selecting for mutant cells in which expression of the polynucleotide has been reduced or eliminated. The mutagenesis, which may be specific or random, may be performed, for example, by use of a suitable physical or chemical mutagenizing agent, by use of a suitable oligonucleotide, or by subjecting the DNA sequence to PCR generated mutagenesis. Furthermore, the mutagenesis may be performed by use of any combination of these mutagenizing agents.

Examples of a physical or chemical mutagenizing agent include ultraviolet (UV) irradiation, hydroxylamine, N-methyl-N′-nitro-N-nitrosoguanidine (MNNG), O-methyl hydroxylamine, nitrous acid, ethyl methane sulphonate (EMS), sodium bisulphite, formic acid, and nucleotide analogues (see J. L. Bose, Springer Protocols 2016, Methods in Molecular Biology, The Genetic Manipulation of Staphylococci).

Additionally or alternatively, nucleotides may be inserted or removed so as to result in the introduction of a stop codon, the removal of the start codon, or a change in the open reading frame. Such modification or inactivation may be accomplished by site-directed mutagenesis or PCR generated mutagenesis in accordance with methods known in the art, or by targeted gene editing using one or more nucleases, e.g., zinc-finger nucleases or CRISPR-associated nucleases. Additionally or alternatively, the modification or inactivation may be achieved by gene silencing, genetic repression, genetic activation, and/or post-translational mutagenesis, e.g., by methods employing non-coding RNA, RNAi, siRNA, miRNA, ribozymes, catalytically inactive nucleases, CRISPRi, nucleotide methylation, and/or histone acetylation. The modification may be transient and/or reversible, irreversible and/or stable, or the modification may be dependent on chemical inducers or dependent on cultivation conditions, such as the cultivation temperature.

The modification may be performed in vivo, i.e., directly on the cell expressing the polynucleotide to be modified, or the modification be performed in vitro.

An example of a convenient way to eliminate or reduce expression of a polynucleotide is based on techniques of gene replacement, gene deletion, or gene disruption. For example, in the gene disruption method, a nucleic acid sequence corresponding to the endogenous polynucleotide is mutagenized in vitro to produce a defective nucleic acid sequence that is then transformed into the parent cell to produce a defective gene. By homologous recombination, the defective nucleic acid sequence replaces the endogenous polynucleotide. It may be desirable that the defective polynucleotide also encodes a marker that may be used for selection of transformants in which the polynucleotide has been modified or destroyed. In an aspect, the polynucleotide is disrupted with a selectable marker such as those described herein.

The present disclosure further relates to a mutant cell of a parent cell that comprises a disruption or deletion of a polynucleotide encoding the protein or a control sequence thereof or a silenced gene encoding the protein, which results in the mutant cell producing less of the protein or no protein compared to the parent cell.

The protein-deficient mutant cells are useful as host cells for expression of native and heterologous proteins. Therefore, the present disclosure further relates to methods of producing a native or heterologous protein, comprising (a) cultivating the mutant cell under conditions conducive for production of the protein; and (b) recovering the protein. The term “heterologous proteins” means proteins that are not native to the host cell, e.g., a variant of a native protein. The host cell may comprise more than one copy of a polynucleotide encoding the native or heterologous protein.

The methods of the present disclosure for producing an essentially [enzyme]-free product are of interest in the production of proteins, e.g., proteins such as enzymes. The [enzyme]-deficient cells may also be used to express heterologous proteins of pharmaceutical interest such as hormones, growth factors, receptors, and the like.

In some embodiments, the present disclosure relates to a protein product essentially free from [enzyme] activity that is produced by a method of the present disclosure.

Compositions of the present disclosure are useful for preventing, treating, suppressing, eliminating and/or reducing the severity of infestations/infections of/by myriad pests, including, but not limited to, horticultural pests, such as acarids, bacteria, fungi, gastropods, insects, nematodes, oomycetes, protozoa and weeds.

Compositions of the present disclosure (i.e., proteins, formulations, polynucleotides and organisms of the present disclosure) may be used to prevent, treat, suppress, eliminate and/or reduce the severity of acarid infestations by, for example, reducing attraction of an acarid to a surface, inhibiting entry of an acarid into a material, inhibiting inhabitation by an acarid, inhibiting feeding of an acarid, inhibiting the growth of an acarid, inhibiting the reproduction and/or proliferation of an acarid, degrading on one or more structural components of an acarid (e.g. procuticle components, such as chitin, and epicuticle components, such as lipoproteins, hydrocarbons, polyphenols and esters of fatty acids and alcohols), killing an acarid, and/or reducing one or more symptoms of an acarid infestation. In some embodiments, such inhibition is complete or substantially complete, such that the acarid fails to inhabit/feed/grow/reproduce/proliferate at a rate effective to initiate and/or sustain an appreciable infestation. For example, spraying a plant with an enzyme of the present disclosure may reduce the attractiveness of the plant to an acarid, reduce an acarid's desire/ability to inhabit the plant, inhibit an acarid's desire/ability to feed on the plant, inhibiting the growth of an acarid after it inhabits/feeds on the plant, inhibit the reproduction and/or proliferation of an acarid on/in the plant, degrade one or more structural components of an acarid (e.g. one or more chitins, one or more lipoproteins and/or one or more long chain hydrocarbons) on/in the plant, and/or kill an acarid on/in the plant, thereby reducing one or more symptoms of infestation and/or enhancing one or more characteristics of growth and/or yield in the plant, as compared to an untreated control plant.

Compositions of the present disclosure may be used to prevent, treat, suppress, eliminate and/or reduce the severity of infestations of/by myriad acarids, including, but not limited to, herbivorous acarids, such as broad mites, bulb mites, cyclamen mites, earth mites, eriophyid mites, Lewis mites, russet mites, rust mites, and spider mites. In some embodiments, enzymes of the present disclosure are used to prevent and/or treat an infestation of a plant or plant part by one or more Auculops, (e.g., A. lycopersici), Calacarus (e.g., C. flagelliseta), Eutetranychus (e.g., E. lewesi), Halotydeus (e.g., H. destructor), Polyphagotarsonemus (e.g., P. latus), Rhizoglyphus, Tarsonemus (e.g., T. pallidus), and/or Tetranychus (e.g., T. cinnabarinus, T. evansi, T. ludeni, T. urticae).

Compositions of the present disclosure may be used to prevent, treat, suppress, eliminate and/or reduce the severity of bacterial infestations/infections by, for example, inhibiting adhesion of a bacterium to a surface, inhibiting entry of a bacterium into a material, inhibiting habitation by a bacterium, inhibiting the growth of a bacterium, inhibiting the reproduction and/or proliferation of a bacterium, degrading on one or more structural components of a bacterium (e.g. cell wall components, such as peptidoglycans and lipopolysaccharides), killing a bacterium, and/or reducing one or more symptoms of a bacterial infestation/infection. In some embodiments, such inhibition is complete or substantially complete, such that the bacterium fails to inhabit/feed/grow/reproduce/proliferate at a rate effective to initiate and/or sustain an appreciable infestation/infection. For example, spraying a plant with an enzyme of the present disclosure may inhibit a bacterium's ability to adhere to the surface of a plant, inhibit a bacterium's ability to enter into the plant, inhibit a bacterium's ability to inhabit the plant, inhibit growth of a bacterium on/in the plant, inhibit the reproduction and/or proliferation of a bacterium on/in the plant, degrade one or more structural components of a bacterium (e.g. one or more peptidoglycans and/or one or more lipopolysaccharides) on/in the plant, and/or kill a bacterium, thereby reducing one or more symptoms of infestation and/or enhancing one or more characteristics of growth and/or yield in the plant, as compared to an untreated control plant.

Compositions of the present disclosure may be used to prevent, treat, suppress, eliminate and/or reduce the severity of infestations/infections of/by myriad phytopathogenic bacteria, including, but not limited to, phytopathogenic Erwiniaceae and Xanthomonadales. In some embodiments, enzymes of the present disclosure are used to prevent, treat, suppress, eliminate and/or reduce the severity of an infestation/infection of a plant or plant part by one or more Agrobacterium (e.g., A. rhizogenes, A. tumefaciens, A. vitis), Burkholderia (e.g., B. gladioli), Clostridium, Dickeya (e.g., D. dadantii, D. solani), Erwinia (e.g., E. amylovora, E. aphidicola, E. carotovora, E. chrysanthemi, E. papayae, E. persicina, E. psidii, E. pyrifoliae, E. rhapontici, E. tracheiphila), Pectobacterium (e.g., P. atrosepticum, P. carotovorum), Pseudomonas (e.g., P. agarici, P. amygdali, P. avellanae,P. cannabina, P. caricapapayae, P. cichorii, P. coronafaciens, P. costantinii, P. ficuserectae, P. fuscovaginae, P. helianthin, P. meliae, P. savastanoi, P. syringae, P. tolaasii, P. tomato, P. turbinellae, P. viridiflava), Ralstonia (e.g., R. solanacearum), Xanthomonas (e.g., X. alfalfae, X. ampelina, X. arboricola, X. axonopodia, X. boreopolis, X. badrii, X. bromi, X. campestris, X. cassavae, X. citri, X. cucrurbitae, X. cyanopsidis, X. cynarae, X. euvesicatoria, X. frageriae, X. gardneri, X. holcicola, X. hortorum, X. hyacinthi, X. maliensis, X. malvacearum, X. manihotis, X. melonis, X. oryzae, X. papavericola, X. perforans, X. phaseoli, X. pisi, X. populi, X. sacchari, X. theicola, X. translucens, X. vasicola, X. vesicatoria), and/or Xylella (e.g., X. fastidiosa).

Compositions of the present disclosure may be used to prevent, treat, suppress, eliminate and/or reduce the severity of fungal infestations/infections by, for example, inhibiting adhesion of a fungus to a surface, inhibiting entry of a fungus into a material, inhibiting habitation by a fungus, inhibiting the growth of a fungus, inhibiting the reproduction and/or proliferation of a fungus, degrading on one or more structural components of a fungus (e.g. cell wall components, such as chitins, glucans and mannans, and cell membrane components, such as ergosterols), killing a fungus, and/or reducing one or more symptoms of a fungal infestation/infection. In some embodiments, such inhibition is complete or substantially complete, such that the fungus fails to inhabit/feed/grow/reproduce/proliferate at a rate effective to initiate and/or sustain an appreciable infestation/infection. For example, spraying a plant with an enzyme of the present disclosure may inhibit a fungus' ability to adhere to the surface of a plant, inhibit a fungus' ability to enter into the plant, inhibit a fungus' ability to inhabit the plant, inhibit growth of a fungus on/in the plant, inhibit the reproduction and/or proliferation of a fungus on/in the plant, degrade one or more structural components of a fungus (e.g. one or more chitins, one or more glucans and/or one or more mannans) on/in the plant, and/or kill a fungus, thereby reducing one or more symptoms of infestation and/or enhancing one or more characteristics of growth and/or yield in the plant, as compared to an untreated control plant.

Compositions of the present disclosure may be used to prevent, treat, suppress, eliminate and/or reduce the severity of infestations/infections of/by myriad phytopathogenic fungi, including, but not limited to, phytopathogenic Ascomycetes, Basidiomycetes, Chytridiomycota, Deueromycota, Peronosporomycota, Plasmodiophoromycota and Zygomycota, such as blasts, blights, bunts, galls, mildews, molds, rots, rusts, scabs, smuts and wilts. In some embodiments, enzymes of the present disclosure are used to prevent, treat, suppress, eliminate and/or reduce the severity of an infestation/infection of a plant or plant part by one or more Aecidium (e.g., A. aechmantherae, A. amaryllidis, A. breyniae, A. campanulastri, A. cannabis, A. cantensis, A. capsicum, A. foeniculi, A. narcissi), Alternaria (e.g., A. alternata, A. alternantherae, A. arachidis, A. arborescens, A. arbusti, A. blumeae, A. brassicae, A. brassicicola, A. burnsii. A. carotiincultae, A. carthami, A. celosiae, A. cinerariae, A. citri, A. conjuncta, A. cucumerina, A. dauci, A. dianthi, A. dianthicola, A. eichhorniae, A. euphorbiicola, A. gaisen, A. helianthi, A. helianthicola, A. hungarica, A. infectoria, A. japonica, A. leucanthemi, A. linicola, A. longipes, A. mali, A. molesta, A. padwickii, A. panax, A. perpunctulata, A. patroselini, A. porri, A. quericola, A. radicina, A. raphani, A. saponariae, A. selini, A. senecionis, A. smyrnii, A. solani, A. sonchi, A. tenuissima, A. triticina, A. ventricosa, A. zinniae), Ascochyta (e.g., A. asparagina, A. bohemica, A., caricae, A. doronici, A. fabae, A. gossypii, A. graminea, A. hordei, A. humuli, A. medicaginicola, A. pinodes, A. pisi, A. prasadii, A. rabiei, A. rhei, A. sorghi, A. sorghinia, A. spinaciae, A. tarda, A. tritici, A. viciae, A. vindobonensis), Ascospora (e.g., A. ruborum), Aspergillus (e.g., A. aculeatus, A. candidus, A. clavatus, A. fisherianus, A. flavus, A. fumigatus, A. niger, A. parasiticus, A. restrictus, A. sojae, A. solani), Asteroma (e.g., A. caryae), Austropuccinia (e.g., A. psidii), Bipolaris (e.g., B. cactivora, B. cookei, B. incurvata, B. sacchari, B. sorghicola, B. zeae), Blumeria (e.g., B. graminis), Boeremia (e.g., B. lycopersici), Botrytis (e.g., B. allii, B. anthophila, B. cinerea, B. citricola, B. citrina, B. elliptica, B. fabae, B. fabiopsis, B. galanthina, B. gladioli, B. gossypina, B. hormini, B. hyacinthi, B. isabellina, B. latebricola, B. liliorum, B. limacidae, B. luteobrunnea, B. lutescens, B. mali, B. monilioides, B. narcissicola, B. necans, B. paeoniae, B. peronosporoides, B. pistiae, B. platensis, B. pruinosa, B. pseudocinerea, B. pyramidalis, B. rivoltae, B. rosea, B. rubescens, B. rudiculoides, B. sekimotoi, B. septospora, B. setuligera, B. sinoallii, B. sonchina, B. splendida, B. squamosa, B. taxi, B. terrestris, B. tracheiphila, B. trifolii, B. tulipae, B. viciae-hirsutae, B. yuae), Calonectria (e.g., C. ilicicola, C. indusiate, C. kyotensis, C. pteridis, C. pyrochroa, C. quinqueseptata), Camarotella (e.g., C. acrocomiae, C. costaricensis), Candida (e.g., C. albicans), Capnodium (e.g., C. theae), Cephalosporium (e.g., C. gramineum), Ceratocystis (e.g., C. fimbriata), Ceratobasidium (e.g., C. cereale), Cercoseptoria (e.g., C. ocellata), Cercospora (e.g., C. angreci, C. apii, C. apiicola, C. arachidicola, C. asparagi, C. atrofiliformis, C. beticola, C. bolleana, C. brachypus, C. brassicola, C. brunkii, C. canescens, C. cannabis, C. cantuariensis, C. capsici, C. caribaea, C. carotae, C. circumscissa, C. citrulline, C. clemensiae, C. coffeicola, C. coryli, C. corylina, C. eleusine, C. fragariae, C. fuchsiae, C. fusca, C. fusimaculans, C. gerberae, C. halstedii, C. handelii, C. hayi, C. hydrangeae, C. kaki, C. kikuchii, C. lentis, C. liquidambraris, C. longipes, C. longissima, C. malloti, C. mamaonis, C. mangiferae, C. medicaginis, C. melongenae, C. minima, C. minuta, C. musae, C. nicotianae, C. odontoglossi, C. oryzae, C. papayae, C. penniseti, C. personata, C. piaropi, C. pisa-sativae, C. platanicola, C. puderii, C. pulcherrima, C. rhapidicola, C. rosicola, C. rubrotincta, C. sojina, C. solani, C. solani-tuberosi, C. sorghi, C. theae, C. tuberculans, C. vexans, C. vicosae, C. zeae-maydis, C. zebrina, C. zonata), Cercosporella (e.g., C. rubi), Choanephora (e.g., C. cucurbitarum), Cladosporium (e.g., C. arthropodii, C. brassicae, C. brassicola, C. chrysanthemi, C. citri, C. cladosporioides, C. cucumerinum, C. fulvum, C. gossypiicola, C. herbarum, C. hydrangeae, C. leguminicola, C. musae, C. oncobae, C. orchidis, C. pisi, C. rhododendri, C. salinae, C. spharospermum, C. sorghi, C. syringae, C. syringicola, C. yuccae, C. zeae), Claviceps (e.g., C. africana, C. fusiformis, C. paspali, C. purpurea, C. sorghi, C. zizaniae), Clitocybe (e.g., C. parasitica), Coccidioides (e.g., C. immitus), Cochliobolus (e.g., C. carbonum, C. cymbopogonis, C. hawaiiensis, C. heterostrophus, C. lunatus, C. miyabeanus, C. ravenelii, C. sativus, C. setariae, C. spicifer, C. stenospilus, C. tuberculatus, C. victoriae), Coleosporium (e.g., C. helianthi, C. ipomoeae, C. madiae, C. pacificum, C. tussilaginis), Colletotrichum (e.g., C. acutatum, C. agaves, C. arachidis, C. boninense, C. brasiliense, C. brassicola, C. brevisporum, C. cacao, C. capsici, C. caudatum, C. cereale, C. citri, C. citricola, C. coccodes, C. coffeanum, C. crassipes, C. curcumae, C. dematium, C. derridis, C. destructivum, C. fioriniae, C. fragariae, C. fructi, C. fruticola, C. fructivorum, C. gloeosporioides, C. glycines, C. graminicola, C. gossypii, C. hanaui, C. higginsianum, C. jacksonii, C. kahawae, C. lentis, C. limonicola, C. lindemuthianum, C. lini, C. lupini, C. mangenotii, C. melonis, C. miscanthi, C. musae, C. nicholsonii, C. nigrum, C. orbiculare, C. orchidis, C. paspali, C. pisi, C. pisicola, C. radicis, C. roseum, C. serranegrense, C. sojae, C. spinaceae, C. sublineolum, C. sublineola, C. tabacum, C. trichellum, C. trifolii, C. truncatum, C. zoysiae), Coniella, Coniothecium (e.g., C. chomatosporum), Coniothyrium (e.g., C. henriquesii, C. rosarum, C. wernsdorffiae), Coprinopsis (e.g., C. psychromorbida), Cordana (e.g., C. johnstonii, C. musae), Corticum (e.g., C. theae), Cryphonectria (e.g., C. parasitica), Cylindrocarpon (e.g., C. ianthothele, C. magnusianum, C. musae), Cylindrocladiella (e.g., C. camelliae, C. parva), Cylindrocladium (e.g., C. lanceolatum, C. peruvianum), Cylindrosporium (e.g., C. cannabinum, C. juglandis, C. rubi), Cymadothea (e.g., C. trifolii), Cytospora (e.g, C. palmarum, C. personata, C. sacchari, C. sacculus, C. terebinthi), Cytosporina (e.g., C. ludibunda), Diaporthe (e.g., D. arctii, D. asparagi, D. capsici, D. citri, D. coffeae, D. dulcamarae, D. eres, D. helianthi, D. lagunensis, D. lokoyae, D. melonis, D. musae, D. orthoceras, D. perniciosa, D. phaseolorum, D. rudis, D. tanakae, D. viticola), Diplodia (e.g., D. gossypina), Dreschlera (e.g., D. avenacea, D. campanulata, D. dematioidea, D. gigantea, D. glycines, D. graminea, D. hawaiiensis, D. musae, D. poae, D. teres, D. wirreganensis), Eremothcium (formerly Nematospora) (e.g., E. gossypii), Erysiphe (e.g., E. betae, E. cichoracearum, E. communis, E. cruciferarum, E. flexuosa, E. heraclei, E. necator, E. pisi, E. polygoni, E. robiniae, E. syringae), Exserohilum (e.g., E. oryzicola, E. oryzinum), Fusarium (e.g., F. affine, F. arthrosporioides, F. avenaceum, F. circinatum, F. crookwellense, F. culmorum, F. fujikuroi, F. graminearum, F. incarnatum, F. langsethiae, F. mangiferae, F. merismoides, F. moniliforme, F. oxysporum, F. pallidoroseum, F. poae, F. proliferatum, F. redolens, F. roseum, F. sacchari, F. solani, F. sporotrichioides, F. sterilihyphosum, F. subglutinans, F. sulphureum, F. tricinctum, F. verticillioides, F. virguliforme), Gaeumannomyces (e.g., G. graminis), Geotrichum (e.g., G. candidum), Gibberella (e.g., G. fujikuroi, G. pulicaris, G. stilboides, G. tricincta, G. xylarioides, G. zeae), Gilbertella (e.g., G. persicaria), Glomerella (e.g., G. cingulata), Gymnosporangium (e.g., G. juniperi-virginianae), Helminthosporium (e.g., H. oryzae, H. solani), Hemileia (e.g., H. coffeicola, H. vastatrix), Leptosphaeria (e.g., L. acuta, L. asparagi, L. cannabina, L. coffaeicida, L. coniothyrium, L. glyceriae, L. gossypii, L. grisea, L. longispora, L. maculans, L. maydis, L. musae, L. oryzicola, L. oryzina, L. pini, L. platanicola, L. pratensis, L. raphani, L. saccharicola, L. solani, L. solanicola, L. trifolii, L. viciae, L. woroninii, L. zeae, L. zeae-maydis), Macrophomina (e.g., M. phaseolina), Magnaporthe (e.g., M. grisea, M. oryzae), Melamspora (e.g., M. lini), Monilinia (e.g., M. fructicola), Mucor (e.g., M. piriformis), Mycosphaerella (e.g., M. fijiensis, M. graminicola, M. tassiana, M. zeae-maydis), Neofabraea (e.g., N. malicorticus), Ophiostoma (e.g., O. novo-ulmi, O. ulmi), Paracoccidioides (e.g., P. braziliensis), Penicillium (e.g., P. digitatum, P. expansum, P. italicum, P. rugulosum, P. verrucosum), Phakopsora (e.g., P. gossypii, P. meibomiae, P. pachyrhizi), Phialophora (e.g., P. gregata), Phoma (e.g., P. glycinicola), Phomopsis (e.g., P. asparagi, P. coffeae, P. logicolla, P. mangiferae, P. obscurans, P. perseae, P. purnorum, P. sojae, P. sclerotioides, P. tanakae, P. theae, P. vitcola), Phymatotrichopsis (e.g., P. omnivora), Physalospora (e.g., P. obtusa), Phytomyxea, Pneumocystis (e.g., P. carinii), Podosphaera (e.g., P. oxyacanthae), Pseudocercosporella, Puccinia (e.g., P. asparagi, P. cacahata, P. graminis, P. kuehnii, P. melanocephala, P. porri, P. punctiformis, P. recondita, P. schedonnardii, P. sessilis, P. sorghi, P. striiformis, P. tritici, P. triticina), Pyrenophora (e.g., P. tritici-repentis), Pyricularia, Rhizoctonia (e.g., R. solani), Rhizopus (e.g., R. nigricans, R. stolonifer), Rhynchosporium, Sclerotinia (e.g., S. borealis, S. bulborum, S. homoeocarpa, S. libertiana, S. minor, S. ricini, S. sclerotiorum, S. spermophila, S. trifoliorum), Sclerotium (e.g., S. rolfsii), Scopulariopsis (e.g., S. brevicaulis), Septoria (e.g., S. apiicola, S. aciculosa, S. ampelina, S. avenae, S. azalea, S. bataticola, S. campanulae, S. caryae, S. citri, S. cucurbitacearum, S. cytisi, S. dianthi, S. eumusae, fragariae, S. fragariaecola, S. glycines, S. helianthin, S. humuli, S. hydrangea, S. lactucae, S. lycopersici, S. malagutii, S. menthae, S. musiva, S. ostryae, S. passerinii, S. pisi, S. pistaciae, S. platanifolia, S. rhododendri, S. secais, S. selenophomoides), Sporisorium (e.g., S. scitamineum), Synchytrium (e.g., S. endobioticum), Taphrina (e.g., T. deformans), Thielaviopsis (e.g., T. basicola, T. ceremica), Tilletia (e.g., T. barclayana, T. caries, T. controversa, T. foetida, T. indica, T. laevis, T. tritici), Uncinula, Uromyces (e.g., U. melanocephala), Ustilago (e.g., U. esculenta, U. maydis, U. nuda, U. scitaminea, U. tritici, U. virens), Venturia, Verticillium (e.g., V. alfalfae, V. dahliae, V. isaacii, V. longisporum, V. theobromae, V. zaregamsianum) and/or Zymoseptoria (e.g., Z. tritici). Additional examples of fungi that may be targeted using proteins, formulations, polynucleotides and organisms of the present disclosure may be found in Bradley, Managing Diseases, in ILLINOIS AGRONOMY HANDBOOK (2008).

Compositions of the present disclosure may be used to prevent and/or treat gastropod infestations by, for example, reducing attraction of a gastropod to a surface, inhibiting inhabitation by a gastropod, inhibiting feeding of a gastropod, inhibiting the growth of a gastropod, inhibiting the reproduction and/or proliferation of a gastropod, degrading on one or more structural components of a gastropod (e.g. ______), killing a gastropod, and/or reducing one or more symptoms of a gastropod infestation. In some embodiments, such inhibition is complete or substantially complete, such that the gastropod fails to inhabit/feed/grow/reproduce/proliferate at a rate effective to initiate and/or sustain an appreciable infestation. For example, spraying a plant with an enzyme of the present disclosure may reduce the attractiveness of the plant to a gastropod, reduce a gastropod's desire/ability to inhabit the plant, inhibit a gastropod's desire/ability to feed on the plant, inhibiting the growth of a gastropod after it inhabits/feeds on the plant, inhibit the reproduction and/or proliferation of a gastropod on/in the plant, degrade one or more structural components of a gastropod (e.g. ______) on/in the plant, and/or kill a gastropod, thereby reducing one or more symptoms of infestation and/or enhancing one or more characteristics of growth and/or yield in the plant, as compared to an untreated control plant.

Compositions of the present disclosure may be used to prevent, treat, suppress, eliminate and/or reduce the severity of infestations of/by myriad gastropods, including, but not limited to, slugs and snails.

Compositions of the present disclosure may be used to prevent and/or treat insect infestations by, for example, reducing attraction of an insect to a surface, inhibiting entry of an insect into a material, inhibiting inhabitation by an insect, inhibiting feeding of an insect, inhibiting the growth of an insect, inhibiting the reproduction and/or proliferation of an insect, degrading on one or more structural components of an insect (e.g. procuticle components, such as chitin, and epicuticle components, such as lipoproteins, hydrocarbons, polyphenols and esters of fatty acids and alcohols), killing an insect, and/or reducing one or more symptoms of an insect infestation. In some embodiments, such inhibition is complete or substantially complete, such that the insect fails to inhabit/feed/grow/reproduce/proliferate at a rate effective to initiate and/or sustain an appreciable infestation. For example, spraying a plant with an enzyme of the present disclosure may reduce the attractiveness of the plant to an insect, reduce an insect's desire/ability to inhabit the plant, inhibit an insect's desire/ability to feed on the plant, inhibiting the growth of an insect after it inhabits/feeds on the plant, inhibit the reproduction and/or proliferation of an insect on/in the plant, degrade one or more structural components of an insect (e.g. one or more chitins, one or more lipoproteins and/or one or more long chain hydrocarbons) on/in the plant, and/or kill an insect, thereby reducing one or more symptoms of infestation and/or enhancing one or more characteristics of growth and/or yield in the plant, as compared to an untreated control plant.

Compositions of the present disclosure may be used to prevent and/or treat infestations of myriad insects, including, but not limited to, Coleoptera, Dermaptera, Diptera, Hemiptera, Homoptera, Hymenoptera, Lepidoptera, Orthoptera and Thysanoptera, such as aphids, armyworms, beetles, bollworms, bugs, caterpillars, cutworms, flies, moths and thrips. In some embodiments, enzymes of the present disclosure are used to prevent, treat, suppress, eliminate and/or reduce the severity of an infestation of by one or more Acalymma, Acanthaoscelides (e.g., A. obtectus,), Anasa (e.g., A. tristis), Anastrepha (e.g., A. ludens), Anoplophora (e.g., A. glabripennis), Anthonomus (e.g., A. eugenii), Acyrthosiphon (e.g., A. pisum), Bactrocera (e.g., B. dosalis), Bemisia (e.g., B. argentifolii, B. tabaci), Brevicoryne (e.g., B. brassicae), Bruchidius (e.g., B. atrolineatus), Bruchus (e.g., B. atomarius, B. dentipes, B. lentis, B. pisorum and/or B. rufipes), Callosobruchus (e.g., C. chinensis, C. maculatus, C. rhodesianus, C. subinnotatus, C. theobromae), Caryedon (e.g., C. serratus), Cassadinae, Ceratitis (e.g., C. capitata), Chrysomelinae, Circulfer (e.g., C. tenellus), Criocerinae, Cryptocephalinae, Cryptolestes (e.g., C. ferrugineus, C. pusillis, C. pussilloides), Cylas (e.g., C. formicarius), Delia (e.g., D. antiqua), Diabrotica, Diaphania (e.g., D. nitidalis), Diaphorina (e.g., D. citri), Donaciinae, Ephestia (e.g, E. cautella, E. elutella, E., keuhniella), Epilachna (e.g., E. varivestris), Epiphyas (e.g., E. postvittana), Eumolpinae, Galerucinae, Helicoverpa (e.g., H. zea), Heteroligus (e.g., H. meles), Iobesia (e.g., I. botrana), Lamprosomatinae, Lasioderma (e.g., L. serricorne), Leptinotarsa (e.g., L. decemlineata), Leptoglossus, Liriomyza (e.g., L. trifolii), Manducca, Melittia (e.g., M. cucurbitae), Myzus (e.g., M. persicae), Nezara (e.g., N. viridula), Orzaephilus (e.g., O. merator, O. surinamensis), Ostrinia (e.g., O. nubilalis), Phthorimaea (e.g., P. operculella), Pieris (e.g., P. rapae), Plodia (e.g., P. interpunctella), Plutella (e.g., P. xylostella), Popillia (e.g., P. japonica), Prostephanus (e.g., P. truncates), Psila, Rhizopertha (e.g., R. dominica), Rhopalosiphum (e.g., R. maidis), Sagrinae, Solenopsis (e.g., S. Invicta), Spilopyrinae, Sitophilus (e.g., S. granaries, S. oryzae and/or S. zeamais), Sitotroga (e.g., S. cerealella), Spodoptera (e.g., S. frugiperda), Stegobium (e.g., S. paniceum), Synetinae, Tenebrio (e.g., T. malens and/or T. molitor), Thrips (e.g., T. tabaci), Trialeurodes (e.g., T. vaporariorum), Tribolium (e.g., T. castaneum and/or T. confusum), Trichoplusia (e.g., T. ni), Trogoderma (e.g., T. granarium) and/or Trogossitidae (e.g., T. mauritanicus). Additional species of insects that may be targeted using enzymes, formulations, polynucleotides and organisms of the present disclosure may be found in CAPINERA, HANDBOOK OF VEGETABLE PESTS (2001) and Steffey and Gray, Managing Insect Pests, in ILLINOIS AGRONOMY HANDBOOK (2008).

Compositions of the present disclosure may be used to prevent, treat, suppress, eliminate and/or reduce the severity of nematode infestations/infections by, for example, inhibiting adhesion of a nematode to a surface, inhibiting entry of a nematode into a material, inhibiting habitation by a nematode, inhibiting the growth of a nematode, inhibiting the reproduction and/or proliferation of a nematode, degrading on one or more structural components of a nematode (e.g. cuticle components, such as collagens, cuticlins, glycoproteins and lipids), killing a nematode, and/or reducing one or more symptoms of a nematode infestation/infection. In some embodiments, such inhibition is complete or substantially complete, such that the nematode fails to inhabit/feed/grow/reproduce/proliferate at a rate effective to initiate and/or sustain an appreciable infestation/infection. For example, spraying a plant with an enzyme of the present disclosure may inhibit a nematode's ability to adhere to the surface of a plant, inhibit a nematode's ability to enter into the plant, inhibit a nematode's ability to inhabit the plant, inhibit growth of a nematode on/in the plant, inhibit the reproduction and/or proliferation of a nematode on/in the plant, degrade one or more structural components of a nematode (e.g., one or more collagens, one or more cuticlins, one or more glycoproteins and/or one or more lipids) on/in the plant, and/or kill a nematode, thereby reducing one or more symptoms of infestation and/or enhancing one or more characteristics of growth and/or yield in the plant, as compared to an untreated control plant.

Compositions of the present disclosure may be used to prevent, treat, suppress, eliminate and/or reduce the severity of infestations/infections of/by myriad phytopathogenic nematodes, including, but not limited to, root-knot nematodes, cyst nematodes, burrowing nematodes, root lesion nematodes, wilt nematodes and reniform nematodes. In some embodiments, enzymes of the present disclosure are used to prevent, treat, suppress, eliminate and/or reduce the severity of an infestation/infection of a plant or plant part by one or more Meloidogyne (e.g., M. arenaria, M. graminicola, M. hapla, M. incognita, M. javanica), Globodera (e.g., G. pallida, G. rostochiensis), Heterodera (e.g., H. avenae, H. filipjevi, H. glycines, H. schachtii), Pratylenchus (e.g., P. penetrans, P. thornei, P. neglectus, P. zae, P. vulnus, P. coffeae), Radopholus (e.g., R. similis), Ditylenchus (e.g., D. dipsaci, D. angustus, D. desctructor, D. africanus, D. myceliophagus, D. gigas), Bursaphelenchus (e.g., B. xylophilus, B. mucronatus), Rotylenchus (e.g., R. reniformis, R. parvus), Xiphinema (e.g., X. index, X. italiae, X. viuttenezi, X. diversicaudatun), and/or Nacobbus (e.g., N. aberrans). Additional examples of nematodes that may be targeted by enzymes, formulations, polynucleotides and organisms of the present disclosure may be found in CAPINERA, HANDBOOK OF VEGETABLE PESTS (2001) and Niblack, Nematodes, in ILLINOIS AGRONOMY HANDBOOK (2008)

Compositions of the present disclosure may be used to prevent and/or treat oomycete infestations/infections by, for example, inhibiting adhesion of an oomycete to a surface, inhibiting entry of an oomycete into a material, inhibiting habitation by an oomycete, inhibiting the growth of an oomycete, inhibiting the reproduction and/or proliferation of an oomycete, degrading on one or more structural components of an oomycete (e.g. cell wall components, such as celluloses and other beta-glucans), killing an oomycete, and/or reducing one or more symptoms of an oomycete infestation/infection. In some embodiments, such inhibition is complete or substantially complete, such that the oomycete fails to inhabit/feed/grow/reproduce/proliferate at a rate effective to initiate and/or sustain an appreciable infestation/infection. For example, spraying a plant with an enzyme of the present disclosure may inhibit an oomycete's ability to adhere to the surface of a plant, inhibit an oomycete's ability to enter into the plant, inhibit an oomycete's ability to inhabit the plant, inhibit growth of an oomycete on/in the plant, inhibit the reproduction and/or proliferation of an oomycete on/in the plant, degrade one or more structural components of an oomycete (e.g. one or more beta-glucans) on/in the plant, and/or kill an oomycete, thereby reducing one or more symptoms of infestation and/or enhancing one or more characteristics of growth and/or yield in the plant, as compared to an untreated control plant.

Compositions of the present disclosure may be used to prevent and/or treat infestations/infections of myriad phytopathogenic oomycetes, including, but not limited to, phytopathogenic Albuginaceae, Peronosporaceae and Pythiaceae, such as blights, mildews, molds, root rots and rusts In some embodiments, proteins of the present disclosure are used to prevent, treat, suppress, eliminate and/or reduce the severity of an infestation/infection of a plant or plant part by one or more Achlya, Albugo (e.g., A. candida), Aphanomyces (e.g., A. cochlioides, A. euteiches, A. invadans, A. iridis, A. raphani), Bremia (e.g., B. lactucae), Hyaloperonospora (e.g., H. arabidopsidis), Peronospora (e.g., P. belbahrii, P. destructor, P. effusa, P. farinose, P. fulva, P. lotorum, P. manshurica, P. parasitica, P. potentillae, P. rubi, P. schachtii, P. sparsa, P. tabacina, P. trifolii, P. viciae), Phytophthora (e.g., P. agathidicia, P. boehmeriae, P. cactorum, P. cambivora, P. capsica, P. cinnamomi, P. citricola, P. citrophthora, P. cryptogea, P. drechsleri, P. erythroseptica, P. fragariae, P. heveae, P. infestans, P. kernoviae, P. lateralis, P. megakaryam P. megasperma, P. nicotianae, P. palmivora, P. parasitica, P. ramorum, P. sojae, P. syringae), Plasmopara (e.g., P. halstedii, P. viticola), Pseudeoperonospora (e.g., P. cubensis, P. humuli), Pseudosclerospora (e.g., P. philippinesis, P. sacchari, P. sorghi), Pythium (e.g., P. acanthicum, P. aphanidermatum, P. aristosporum, P. arrhenomanes, P. butleri, P. chondricola, P. citrinum, P. cucurbitacearum, P. debaryanum, P. delicense, P. emineosum, P. graminicola, P. heterothallicum, P. hypogynum, P. insidiosum, P. irregulare, P. iwayamae, P. middletonii, P. myriotylum, P. okanoganense, P. oopapillum, P. paddicum, P. paroecandrum, P. perniciosum, P. porphyrae, P. rostratum, P. scleroteichum, P. spinosum, P. splendens, P. sulcatum, P. tardicrescens, P. tracheiphilum, P. ultimum, P. violae, P. volutum), Saprolegnia (e.g., S. parasitica), Sclerophthora (e.g., S. macrospora, S. rayssiae) and/or Sclerospora (e.g., S. graminicola). Additional examples of fungi that may be targeted using proteins, formulations, polynucleotides and organisms of the present disclosure may be found in Bradley, Managing Diseases, in ILLINOIS AGRONOMY HANDBOOK (2008).

Compositions of the present disclosure may be particularly useful for preventing, treating, suppressing, eliminating and/or reducing the severity of infestations/infections of/by phytopathogenic fungi and oomycetes, such as Albugo (e.g., A. candida, A. occidentalis), Alternaria (e.g., A. alternata, A. alternantherae, A. arachidis, A. arborescens, A. arbusti, A. blumeae, A. brassicae, A. brassicicola, A. burnsii. A. carotiincultae, A. carthami, A. celosiae, A. cinerariae, A. citri, A. conjuncta, A. cucumerina, A. dauci, A. dianthi, A. dianthicola, A. eichhorniae, A. euphorbiicola, A. gaisen, A. helianthi, A. helianthicola, A. hungarica, A. infectoria, A. japonica, A. leucanthemi, A. linicola, A. longipes, A. mali, A. molesta, A. padwickii, A. panax, A. perpunctulata, A. patroselini, A. porri, A. quericola, A. radicina, A. raphani, A. saponariae, A. selini, A. senecionis, A. smyrnii, A. solani, A. sonchi, A. tenuissima, A. triticina, A. ventricosa, A. zinniae), Blumeria (e.g., B. graminis), Botrytis (e.g., B. aclada, B. allii, B. cinerea, B. elliptica, B. fabae, B. squamosa), Ceratocystis (e.g., C. fimbriata), Colletotrichum, Diplodia (e.g., D. gossypina), Erwinia (e.g., E. amylovora, E. aphidicola, E. carotovora, E. chrysanthemi, E. papayae, E. persicina, E. psidii, E. pyrifoliae, E. rhapontici, E. tracheiphila), Fusarium (e.g., F. graminearum, F. oxysporum, F. solani, F. virguliforme), Geotrichum (e.g., G. candidum), Gibberella (e.g., G. fujikuroi, G. pulicaris, G. zeae), Gilbertella (e.g., G. persicaria), Glomerella (e.g., G. cingulata), Hyaloperonospora (e.g., H. arabidopsidis), Macrophomina (e.g., M. phaseolina), Magnaporthe (e.g., M. grisea, M. oryzae), Melampsora (e.g., M. lini), Monilinia (e.g., M. fructicola), Mucor (e.g., M. piriformis), Mycosphaerella (e.g., M. graminicola), Neofabraea (e.g., N. malicorticus), Penicillium (e.g., P. digitatum, P. expansum, P. italicum, P. rugulosum, P. verrucosum), Phakopsora (e.g., P. pachyrhizi), Physalospora (e.g., P. obtusa), Phytophthora (e.g., P. capsici, P. cinnamomi, P. infestans, P. parasitica, P. ramorum, P. sojae), Plasmopara (e.g., P. viticola), Pseudoperonospora (e.g., P. cubensis), Puccinia (e.g., P. asparagi, P. cacahata, P. graminis, P. kuehnii, P. melanocephala, P. porri, P. punctiformis, P. recondita, P. schedonnardii, P. sessilis, P. sorghi, P. striiformis, P. tritici, P. triticina), Pythium (e.g., P. butleri, P. ultimum), Rhizoctonia (e.g., R. solani), Rhizopus (e.g., R. nigricans, R. stolonifer), Sclerotinia (e.g., S. borealis, S. bulborum, S. homoeocarpa, S. libertiana, S. minor, S. ricini, S. sclerotiorum, S. spermophila, S. trifoliorum), Septoria (e.g., S. cucurbitacearum, S. glycines, S. lycospersici), Ustilago (e.g., U. esculenta, U. maydis, U. nuda), Zymoseptoria (e.g., Z. tritici).

Blast infestations/infections, such as those mediated by Magnaporthe (e.g., M. grisea, M. oryzae), may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.11.1 (e.g., 1.11.1.6), 3.2.1 (e.g., 3.2.1.6) and/or 3.4.21 (and corresponding formulations, polynucleotides and organisms). In some embodiments, such infestations/infections may be prevented, treated, suppressed and/or eliminated using one or more of SEQ ID NOs: 1, 2, 5, 6, 10, 11, 14, 21, 99, 101, 116, 126, and enzymatically active fragments/mutants/variants thereof.

In some embodiments, such infestations/infections may be prevented, treated, suppressed and/or eliminated using a combination of enzymes, such as one or more cellulases, one or more hemicellulases and one or more xylanases; one or more peptidases and one or more proteases; one or more cellulases, one or more glucosidases and one or more xylanases.

Blight infestations/infections, such as those mediated by Alternaria (e.g., A. alternata, A. carotiincultae, A. panax, A. petroselini, A. solani, A. triticina), Colletotrichum, Fusarium (e.g., F. graminearum), Gibberella (e.g., G. zeae), Phytophthora (e.g., P. capsici, P. infestans, P. ramorum), may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.10.3 (e.g., 1.10.3.2), 1.11.1 (e.g., 1.11.1.6), 3.1.1 (e.g., 3.1.1.5), 3.2.1 (e.g., 3.2.1.1, 3.2.1.3, 3.2.1.4, 3.2.1.5, 3.2.1.6, 3.2.1.8, 3.2.1.11, 3.2.1.15, 3.2.1.39, 3.2.1.41, 3.2.1.58, 3.2.1.75, 3.2.1.78, 3.2.1.111), 3.4.11 (e.g., 3.4.11.1), 3.4.21 (e.g., 3.4.21.19, 3.4.21.62) and/or 3.4.24 (e.g., 3.4.24.28) (and corresponding formulations, polynucleotides and organisms). In some embodiments, such infestations/infections may be prevented, treated, suppressed and/or eliminated using one or more of SEQ ID NOs: 1, 6, 9, 10, 11, 12, 13, 14, 15, 16, 17, 19, 20, 21, 22, 24, 25, 29, 33, 42, 43, 44, 45, 46, 48, 99, 100, 101, 105, 109, 110, 114, 116, 117, 125, 126, 132, 149, and enzymatically active fragments/mutants/variants thereof. In some embodiments, such infestations/infections may be prevented, treated, suppressed and/or eliminated using a combination of enzymes, such as two or more cellulases; two or more pectinases; two or more glucanases; two or more peptidases; two or more pectinases; one or more cellulases, one or more hemicellulases and one or more xylanases; one or more glucanses and one or more xylanases; one or more amylases, one or more glucanases and one or more xylanases.

Blotch infestations/infections, such as those mediated by Mycosphaerella (e.g., M. graminicola) and Zymoseptoria (e.g., Z. tritici) may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.10.3 (e.g., 1.10.3.2), 1.11.1 (e.g., 1.11.1.6), 3.1.1 (e.g., 3.1.1.5), 3.2.1 (e.g., 3.2.1.1, 3.2.1.3, 3.2.1.6, 3.2.1.8, 3.2.1.11, 3.2.1.15, 3.2.1.39, 3.2.1.41, 3.2.1.58, 3.2.1.75, 3.2.1.78, 3.2.1.101, 3.2.1.109, 3.2.1.110, 3.2.1.112), 3.4.11 (e.g., 3.4.11.1), 3.4.21 (e.g., 3.4.21.62) and/or 3.4.24 (3.4.24.28) (and corresponding formulations, polynucleotides and organisms). In some embodiments, such infestations/infections may be prevented, treated, suppressed and/or eliminated using one or more of SEQ ID NOs: 1, 6, 9, 10, 11, 13, 14, 15, 17, 21, 22, 24, 25, 29, 42, 44, 45, 48, 101, 103, 114, 149, and enzymatically active fragments/mutants/variants thereof. In some embodiments, such infestations/infections may be prevented, treated, suppressed and/or eliminated using a combination of enzymes, such as one or more cellulases, one or more lyases and one or more pectinases; as one or more cellulases, one or more hemicellulases and one or more xylanases; two or more cellulases; two or more glucanases; two or more pectinases; one or more glucanses and one or more xylanases; one or more peptidases and one or more proteases.

Downy mildew infestations/infections, such as those mediated by Bremia (e.g., B. lactucae), Hyaloperonospora (e.g., H. arabidopsidis, H. parasitica), Peronospora (e.g., P. belbahrii, P. destructor, P. effusa, P. farinose, P. fulva, P. lotorum, P. manshurica, P. parasitica, P. potentillae, P. rubi, P. schachtii, P. sparsa, P. tabacina, P. trifolii, P. viciae), Peronosclerospora, Plasmopara (e.g., P. halstedii, P. viticola) and Pseudoperonospora (e.g., P. cubensis, P. humuli), may be prevented, treated, suppressed and/or eliminated with myriad compositions of the present disclosure, including, but not limited to, proteins exhibiting one or more activities belonging to EC 3.2.1. (e.g., 3.2.1.8, 3.2.1.78) and/or 3.4.21 (e.g., 3.4.21.19, 3.4.21.62) (and corresponding formulations, polynucleotides and organisms). In some embodiments, such infestations/infections may be prevented, treated, suppressed and/or eliminated using one or more of SEQ ID NOs: 22, 42, 43, 44, 45, and enzymatically active fragments/mutants/variants thereof.

Powdery mildew infestations/infections, such as those mediated by Blumeria (e.g., B. graminis), Erysiphe (e.g., E. cichoracearum, E. necator), Golovinomyces, Leveillula (e.g., L. taurica), Microsphaera (e.g., M. diffusa), Oidium, Phyllactinia, Podosphaera (e.g., P. aphanis, P. leucotricha, P. pannosa, P. xanthii), Sphaerotheca and Uncinula, may be prevented, treated, suppressed and/or eliminated with myriad compositions of the present disclosure, including, but not limited to, proteins exhibiting one or more activities belonging to EC 1.1.3 (e.g., 1.1.3.4), 3.2.1 (e.g., 3.2.1.8, 3.2.15) and/or 3.4.21 (and corresponding formulations, polynucleotides and organisms). In some embodiments, such infestations/infections may be prevented, treated, suppressed and/or eliminated using one or more of SEQ ID NOs: 1, 10, 22, 42, and enzymatically active fragments/mutants/variants thereof. In some embodiments, such infestations/infections may be prevented, treated, suppressed and/or eliminated using a combination of enzymes, such as two or more pectinases.

Mold infestations/infections, such as those mediated by Botrytis (e.g., B. cinerea, B. elliptica), Penicillium (e.g., P. digitatum), Phytophthora (e.g., P. capsici, P. cinnamomi, P. ramorum, P. sojae), may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.10.3 (e.g., 1.10.3.2), 1.11.1 (e.g., 1.11.1.6, 1.11.1.7), 3.2.1 (e.g., 3.2.1.1, 3.2.1.3, 3.2.1.4, 3.2.1.5, 3.2.1.6, 3.2.1.8, 3.2.1.11, 3.2.1.15, 3.2.1.17, 3.2.1.39, 3.2.1.41, 3.2.1.58, 3.2.1.75, 3.2.1.109, 3.2.1.110, 3.2.1.111, 3.2.1.112), 3.4.11 (e.g., 3.4.11.1), 3.4.21 (e.g., 3.4.21.62) and/or 3.4.24 (e.g., 3.4.24.28) (and corresponding formulations, polynucleotides and organisms). In some embodiments, such infestations/infections may be prevented, treated, suppressed and/or eliminated using one or more of SEQ ID NOs: 1, 6, 9, 10, 11, 12, 13, 14, 16, 17, 20, 21, 22, 24, 25, 29, 33, 41, 42, 44, 45, 48, 99, 101, 102, 111, 116, 119, 126, 129, 149, and enzymatically active fragments/mutants/variants thereof. In some embodiments, such infestations/infections may be prevented, treated, suppressed and/or eliminated using a combination of enzymes, such as two or more cellulases; two or more pectinases; one or more cellulases, one or more hemicellulases and one or more xylanases; one or more peptidases and one or more proteases; one or more amylases, one or more glucanases and one or more bacillolysins; one or more cellulases, one or more hemicellulases and one or more xylanases; two or more peptidases; one or more glucanses and one or more xylanases; one or more peptidases and one or more proteases; one or more cellulases, one or more glucosidases and one or more xylanases; one or more cellulases, one or more furanosidases and one or more xylanases.

Crown/fruit/root/stem rot infestations/infections, such as those mediated by Colletotrichum, Fusarium (e.g., F. solani, F. virgulforme), Phytophthora (e.g., P. capsica, P. cinnamomi, P. nicotianae, P. parasitica, P. sojae), Pythium (e.g., P. graminicola, P. ultimum), Saprolegnia (e.g., S. parasitica), may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.11.1 (e.g., 1.11.1.6), 3.2.1 (e.g., 3.2.1.6, 3.2.1.8, 3.2.1.11, 3.2.1.39, 3.2.1.58, 3.2.1.75, 3.2.1.109, 3.2.1.110, 3.2.1.111) and/or 3.4.21 (e.g., 3.4.21.19) (and corresponding formulations, polynucleotides and organisms). In some embodiments, such infestations/infections may be prevented, treated, suppressed and/or eliminated using one or more of SEQ ID NOs: 1, 6, 9, 10, 11, 12, 13, 14, 15, 16, 17, 20, 21, 22, 24, 25, 29, 41, 42, 43, 44, 45, 48, and enzymatically active fragments/mutants/variants thereof. In some embodiments, such infestations/infections may be prevented, treated, suppressed and/or eliminated using a combination of enzymes, such as two or more cellulases; two or more pectinases; two or more glucanases; two or more peptidases; one or more amylases, one or more glucanases and one or more bacillolysins; one or more cellulases, one or more lyases and one or more pectinases; one or more cellulases, one or more hemicellulases and one or more xylanases; one or more glucanses and one or more xylanases; one or more peptidases and one or more proteases.

Rust infestations/infections, such as those mediated by Albugo (e.g., A. candida, A. occidentalis), Hemileia (e.g., H. coffeicola, H. vastatrix), Melamspora (e.g., M. lini), Phakopsora (e.g., P. meibomiae, P. pachyrhizi), Puccinia (e.g., P. asparagi, P. cacahata, P. graminis, P. kuehnii, P. melanocephala, P. porri, P. punctiformis, P. recondita, P. schedonnardii, P. sessilis, P. sorghi, P. striiformis, P. tritici, P. triticina) and Uromyces (e.g., U. appendiculatus), may be prevented and/or treated with myriad compositions of the present disclosure, including, but not limited to, proteins exhibiting one or more activities belonging to EC 1.1.3 (e.g., 1.1.3.4), 1.10.3 (e.g., 1.10.3.2), 3.1.1 (e.g., 3.1.1.5), 3.2.1 (e.g., 3.2.1.1, 3.2.1.3, 3.2.1.4, 3.2.1.5, 3.2.1.6, 3.2.1.8, 3.2.1.15, 3.2.1.41, 3.2.1.58, 3.2.1.78), 3.4.11 (e.g., 3.4.11.1), 3.4.21 (e.g., 3.4.21.19, 3.4.21.62) and/or 3.4.24 (e.g., 3.4.24.28) (and corresponding formulations, polynucleotides and organisms). In some embodiments, such infestations/infections may be prevented, treated, suppressed and/or eliminated using one or more of SEQ ID NOs: 1, 9, 13, 15, 16, 17, 19, 20, 23, 24, 29, 33, 42, 43, 44, 45, 46, 48, and enzymatically active fragments/mutants/variants thereof. In some embodiments, such infestations/infections may be prevented, treated, suppressed and/or eliminated using a combination of enzymes, such as two or more glucanases; one or more peptidases and one or more proteases; and one or more amylases, one or more glucanases and one or more bacillolysins Wilt infestations/infections, such as those mediated by Fusarium (e.g., F. oxysporum,), Phytophthora (e.g., P. capsici, P. infestans, P. ramorum), may be prevented, treated, suppressed and/or eliminated with myriad compositions of the present disclosure, including, but not limited to, proteins exhibiting one or more activities belonging to EC 1.1.3 (e.g., 1.1.3.4, 1.1.3.25), 1.10.3 (e.g., 1.10.3.2), 1.11.1 (e.g., 1.11.1.6), 3.1.1 (e.g., 3.1.1.5), 3.2.1 (e.g., 3.2.1.1, 3.2.1.3, 3.2.1.4, 3.2.1.5, 3.2.1.6, 3.2.1.8, 3.2.1.11, 3.2.1.15, 3.2.1.39, 3.2.1.41, 3.2.1.58, 3.2.1.75, 3.2.1.78, 3.2.1.111), 3.4.11 (e.g., 3.4.11.1), 3.4.21 (e.g., 3.4.21.19, 3.4.21.62) and/or 3.4.24 (e.g., 3.4.24.28) (and corresponding formulations, polynucleotides and organisms). In some embodiments, such infestations/infections may be prevented, treated, suppressed and/or eliminated using one or more of SEQ ID NOs: 1, 6, 9, 10, 11, 12, 13, 14, 15, 16, 17, 19, 20, 21, 22, 24, 25, 33, 42, 43, 44, 45, 46, 48, 99, 101, 114, 116, 125, 126, and enzymatically active fragments/mutants/variants thereof.

In some embodiments, such infestations/infections may be prevented, treated, suppressed and/or eliminated using a combination of enzymes, such as two or more cellulases; two or more pectinases; two or more glucanases; two or more peptidases; two or more pectinases; one or more cellulases, one or more hemicellulases and one or more xylanases; one or more glucanses and one or more xylanases; one or more amylases, one or more glucanases and one or more xylanases.

Proteins exhibiting activity belonging to EC 1.1 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8 (and corresponding formulations, polynucleotides and organisms) may be especially useful for preventing, treating, suppressing, eliminating and/or reducing the severity of such infestations/infections.

Proteins exhibiting activity belonging to EC 1.1.3 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8 (and corresponding formulations, polynucleotides and organisms) may be especially useful for preventing, treating, suppressing, eliminating and/or reducing the severity of such infestations/infections.

Proteins exhibiting belonging to EC 1.1.3.4 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-5 (and corresponding formulations, polynucleotides and organisms) may be especially useful for preventing, treating, suppressing, eliminating and/or reducing the severity of such infestations/infections.

Proteins exhibiting activity belonging to EC 1.1.3.25 (now included in EC 1.1.99.18) (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 6-8 (and corresponding formulations, polynucleotides and organisms) may be especially useful for preventing, treating, suppressing, eliminating and/or reducing the severity of such infestations/infections.

Proteins exhibiting activity belonging to belonging to EC 1.10 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9 (and corresponding formulations, polynucleotides and organisms) may be especially useful for preventing, treating, suppressing, eliminating and/or reducing the severity of such infestations/infections.

Proteins exhibiting activity belonging to belonging to EC 1.10.3 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9 (and corresponding formulations, polynucleotides and organisms) may be especially useful for preventing, treating, suppressing, eliminating and/or reducing the severity of such infestations/infections.

Proteins exhibiting activity belonging to belonging to EC 1.10.3.2 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9 (and corresponding formulations, polynucleotides and organisms) may be especially useful for preventing, treating, suppressing, eliminating and/or reducing the severity of such infestations/infections.

Proteins exhibiting activity belonging to EC 1.11 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12 (and corresponding formulations, polynucleotides and organisms) may be especially useful for preventing, treating, suppressing, eliminating and/or reducing the severity of such infestations/infections.

Proteins exhibiting activity belonging to EC 1.11.1 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12 (and corresponding formulations, polynucleotides and organisms) may be especially useful for preventing, treating, suppressing, eliminating and/or reducing the severity of such infestations/infections.

Proteins exhibiting activity belonging to EC 1.11.1.6 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-11 (and corresponding formulations, polynucleotides and organisms) may be especially useful for preventing, treating, suppressing, eliminating and/or reducing the severity of such infestations/infections.

Proteins exhibiting activity belonging to EC 1.11.1.7 (and corresponding formulations, polynucleotides and organisms) may be particularly useful for preventing, treating, suppressing, eliminating and/or reducing the severity of infestations/infections of a plant or plant part by Botrytis (e.g., B. cinerea). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 12 (and corresponding formulations, polynucleotides and organisms) may be especially useful for preventing, treating, suppressing, eliminating and/or reducing the severity of such infestations/infections.

Proteins exhibiting activity belonging to EC 1.14 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99 (and corresponding formulations, polynucleotides and organisms) may be especially useful for preventing, treating, suppressing, eliminating and/or reducing the severity of such infestations/infections.

Proteins exhibiting activity belonging to EC 1.14.99 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99 (and corresponding formulations, polynucleotides and organisms) may be especially useful for preventing, treating, suppressing, eliminating and/or reducing the severity of such infestations/infections.

Proteins exhibiting activity belonging to EC 1.14.99.56 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99 (and corresponding formulations, polynucleotides and organisms) may be especially useful for preventing, treating, suppressing, eliminating and/or reducing the severity of such infestations/infections.

Proteins exhibiting activity belonging to EC 3.1 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13 and 100-106 (and corresponding formulations, polynucleotides and organisms) may be especially useful for preventing, treating, suppressing, eliminating and/or reducing the severity of such infestations/infections.

Proteins exhibiting activity belonging to EC 3.1.1 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13, 100-103 and 105 (and corresponding formulations, polynucleotides and organisms) may be especially useful for preventing, treating, suppressing, eliminating and/or reducing the severity of such infestations/infections.

Proteins exhibiting activity belonging to EC 3.1.1.3 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 100-103 (and corresponding formulations, polynucleotides and organisms) may be especially useful for preventing, treating, suppressing, eliminating and/or reducing the severity of such infestations/infections.

Proteins exhibiting activity belonging to EC 3.1.1.5 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13 (and corresponding formulations, polynucleotides and organisms) may be especially useful for preventing, treating, suppressing, eliminating and/or reducing the severity of such infestations/infections.

Proteins exhibiting activity belonging to EC 3.1.1.11 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 105 (and corresponding formulations, polynucleotides and organisms) may be especially useful for preventing, treating, suppressing, eliminating and/or reducing the severity of such infestations/infections.

Proteins exhibiting activity belonging to EC 3.2 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143 (and corresponding formulations, polynucleotides and organisms) may be especially useful for preventing, treating, suppressing, eliminating and/or reducing the severity of such infestations/infections.

Proteins exhibiting activity belonging to EC 3.2.1 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143 (and corresponding formulations, polynucleotides and organisms) may be especially useful for preventing, treating, suppressing, eliminating and/or reducing the severity of such infestations/infections.

Proteins exhibiting activity belonging to EC 3.2.1.1 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-16 and 109-111 (and corresponding formulations, polynucleotides and organisms) may be especially useful for preventing, treating, suppressing, eliminating and/or reducing the severity of such infestations/infections.

Proteins exhibiting activity belonging to EC 3.2.1.3 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 17-18 (and corresponding formulations, polynucleotides and organisms) may be especially useful for preventing, treating, suppressing, eliminating and/or reducing the severity of such infestations/infections.

Proteins exhibiting activity belonging to EC 3.2.1.4 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme) and Phakopsora (e.g., P. pachyrhizi). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 19 and 114-116 (and corresponding formulations, polynucleotides and organisms) may be especially useful for preventing, treating, suppressing, eliminating and/or reducing the severity of such infestations/infections.

Proteins exhibiting activity belonging to EC 3.2.1.6 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 20 (and corresponding formulations, polynucleotides and organisms) may be especially useful for preventing, treating, suppressing, eliminating and/or reducing the severity of such infestations/infections.

Proteins exhibiting activity belonging to EC 3.2.1.7 (and corresponding formulations, polynucleotides and organisms) may be particularly useful for preventing, treating, suppressing, eliminating and/or reducing the severity of infestations/infections of a plant or plant part by Botrytis (e.g., B. cinerea) and Fusarium (e.g., F. graminearum, F. oxysporum, F. virgulforme). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 117 (and corresponding formulations, polynucleotides and organisms) may be especially useful for preventing, treating, suppressing, eliminating and/or reducing the severity of such infestations/infections.

Proteins exhibiting activity belonging to EC 3.2.1.8 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 21-24 and 119 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.11 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 25 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.15 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 125 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.17 (and corresponding formulations, polynucleotides and organisms) may be particularly useful for preventing, treating, suppressing, eliminating and/or reducing the severity of infestations/infections of a plant or plant part by Botrytis (e.g., B. cinerea). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 26 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.21 (and corresponding formulations, polynucleotides and organisms) may be particularly useful for preventing, treating, suppressing, eliminating and/or reducing the severity of infestations/infections of a plant or plant part by Magnaporthe (e.g., M. grisea, M. oryzae), Penicillium (e.g., P. digitatum, P. expansum, P. italicum, P. rugulosum, P. verrucosum), and Phytophthora (e.g., P. capsici, P. cinnamomi, P. infestans, P. parasitica, P. ramorum, P. sojae). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 126 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.39 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 27-28 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.41 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 29 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.55 (and corresponding formulations, polynucleotides and organisms) may be particularly useful for preventing, treating, suppressing, eliminating and/or reducing the severity of infestations/infections of a plant or plant part by Penicillium (e.g., P. digitatum, P. expansum, P. italicum, P. rugulosum, P. verrucosum). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 129 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.58 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici).

Proteins exhibiting activity belonging to belonging to EC 3.2.1.59 (and corresponding formulations, polynucleotides and organisms) may be particularly useful for preventing, treating, suppressing, eliminating and/or reducing the severity of infestations/infections of a plant or plant part by Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 30 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.73 (and corresponding formulations, polynucleotides and organisms) may be particularly useful for preventing, treating, suppressing, eliminating and/or reducing the severity of infestations/infections of a plant or plant part by Fusarium (e.g., F. graminearum, F. oxysporum, F. virguliforme). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 132 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.75 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 31-32 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.78 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 33 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.101 (and corresponding formulations, polynucleotides and organisms) may be particularly useful for preventing, treating, suppressing, eliminating and/or reducing the severity of infestations/infections of a plant or plant part by Fusarium (e.g., F. graminearum, F. oxysporum, F. virgulforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 34 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.109 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 35-40 (and corresponding formulations, polynucleotides and organisms) may be especially useful for preventing, treating, suppressing, eliminating and/or reducing the severity of such infestations/infections.

Proteins exhibiting activity belonging to belonging to EC 3.2.1.133 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 41 (and corresponding formulations, polynucleotides and organisms) may be especially useful for preventing, treating, suppressing, eliminating and/or reducing the severity of such infestations/infections.

Proteins exhibiting activity belonging to belonging to EC 3.4 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-48 (and corresponding formulations, polynucleotides and organisms) may be especially useful for preventing, treating, suppressing, eliminating and/or reducing the severity of such infestations/infections.

Proteins exhibiting activity belonging to belonging to EC 3.4.11 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici).

Proteins exhibiting activity belonging to belonging to EC 3.4.11.1 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi) and Zymoseptoria (e.g., Z. tritici).

Proteins exhibiting activity belonging to belonging to EC 3.4.21 (and corresponding formulations, polynucleotides and organisms) may be particularly useful for preventing, treating, suppressing, eliminating and/or reducing the severity of infestations/infections of a plant or plant part by Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-47 (and corresponding formulations, polynucleotides and organisms) may be especially useful for preventing, treating, suppressing, eliminating and/or reducing the severity of such infestations/infections.

Proteins exhibiting activity belonging to belonging to EC 3.4.21.19 (and corresponding formulations, polynucleotides and organisms) may be particularly useful for preventing, treating, suppressing, eliminating and/or reducing the severity of infestations/infections of a plant or plant part by Fusarium (e.g., F. graminearum, F. oxysporum, F. virgulforme), Phakopsora (e.g., P. pachyrhizi), Phytophthora (e.g., P. capsici, P. cinnamomi, P. infestans, P. parasitica, P. ramorum, P. sojae) and Pseudoperonospora (e.g., P. cubensis). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 43 (and corresponding formulations, polynucleotides and organisms) may be especially useful for preventing, treating, suppressing, eliminating and/or reducing the severity of such infestations/infections.

Proteins exhibiting activity belonging to belonging to EC 3.4.21.62 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 44-47 (and corresponding formulations, polynucleotides and organisms) may be especially useful for preventing, treating, suppressing, eliminating and/or reducing the severity of such infestations/infections.

Proteins exhibiting activity belonging to belonging to EC 3.4.24 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 48 (and corresponding formulations, polynucleotides and organisms) may be especially useful for preventing, treating, suppressing, eliminating and/or reducing the severity of such infestations/infections.

Proteins exhibiting activity belonging to belonging to EC 3.4.24.28 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virgulforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 48 (and corresponding formulations, polynucleotides and organisms) may be especially useful for preventing, treating, suppressing, eliminating and/or reducing the severity of such infestations/infections.

Proteins exhibiting activity belonging to belonging to EC 4.2 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149 (and corresponding formulations, polynucleotides and organisms) may be especially useful for preventing, treating, suppressing, eliminating and/or reducing the severity of such infestations/infections.

Proteins exhibiting activity belonging to belonging to EC 4.2.2 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149 (and corresponding formulations, polynucleotides and organisms) may be especially useful for preventing, treating, suppressing, eliminating and/or reducing the severity of such infestations/infections.

Proteins exhibiting activity belonging to belonging to EC 4.2.2.2 (and corresponding formulations, polynucleotides and organisms) may be particularly useful for preventing, treating, suppressing, eliminating and/or reducing the severity of infestations/infections of a plant or plant part by Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). Proteins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149 (and corresponding formulations, polynucleotides and organisms) may be especially useful for preventing, treating, suppressing, eliminating and/or reducing the severity of such infestations/infections.

It is to be understood that compositions of the present disclosure needn't be toxic to be effective. As noted above, proteins of the present disclosure may exert their effects through various non-lethal means, such as reducing the attraction of a pest to a treated surface, inhibiting feeding, etc. Moreover, proteins and compositions of the present disclosure—even those capable of exerting a toxic effect—may be used in non-lethal doses to enhance the efficacy of and/or expand the target pest range of various chemical pesticides and biological pesticides.

The present disclosure extends to methods of using compositions of the present disclosure (e.g., proteins, formulations, polynucleotides and organisms of the present disclosure) for preventing, treating, suppressing, eliminating and/or reducing the severity of infestations/infections of/by horticultural pests, such as phytopathogenic acarids, bacteria, fungi, gastropod, insects, nematodes, oomycetes protozoa and weeds.

In some embodiments, a protein exhibiting activity belonging to EC 1.1 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, an oxidoreductase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.1.3 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, a oxidoreductase (with oxygen as an acceptor), optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-8 (or a corresponding formulation, polynucleotide, or organism) may be applied to a plant or plant part to prevent, treat, suppress, eliminate and/or reducing the severity of such infestations/infections.

In some embodiments, a protein exhibiting belonging to EC 1.1.3.4 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, a glucose oxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 1-5, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.1.3.25 (now included in EC 1.1.99.18) (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virgulforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a cellobiose dehydrogenase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 6-8, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 1.10 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a oxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 1.10.3 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a oxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 1.10.3.2 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a laccase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 9, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.11 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a peroxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.11.1 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a peroxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-12, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.11.1.6 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a catalase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 10-11, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.11.1.7 (or a corresponding formulation, polynucleotide, or organism) is used to prevent, treat, suppress, eliminate and/or reduce the severity of an infestation/infection of a plant or plant part of/by one or more Botrytis (e.g., B. cinerea). For example, a peroxidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 12, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.14 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a oxygenase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.14.99 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a monooxygenase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 1.14.99.56 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phytophthora (e.g., P. capsici, P. cinnamomi, P. infestans, P. parasitica, P. ramorum, P. sojae) and Zymoseptoria (e.g., Z. tritici). For example, a lytic cellulose monooxygenase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 99, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.1 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a hydrolase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13, and 100-106 (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.1.1 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a carboxylic ester hydrolase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13, 100-103 and 105, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.1.1.3 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a triacylglycerol lipase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 100-103, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.1.1.5 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a lysophospholipase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 13, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.1.1.11 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a pectinesterase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 105, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a glycosylase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a glycosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-41 and 109-143, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.1 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, an alpha-amylase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 14-16 and 109-111, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.3 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a glucan 1,4-alpha-glucosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 17-18, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.4 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme) and Phakopsora (e.g., P. pachyrhizi). For example, a cellulase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 19 and 114-116, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.6 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi) and Zymoseptoria (e.g., Z. tritici). For example, an endo-1,3(4)-beta-glucanase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 20, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.7 (or a corresponding formulation, polynucleotide, or organism) is used to prevent, treat, suppress, eliminate and/or reduce the severity of an infestation/infection of a plant or plant part of/by one or more Botrytis (e.g., B. cinerea) and Fusarium (e.g., F. graminearum, F. oxysporum, F. virguliforme). For example, a inulinase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 117, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to EC 3.2.1.8 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a endo-1,4-beta-xylanase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 21-24 and 119, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.11 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virgulforme) and Zymoseptoria (e.g., Z. tritici). For example, a dextranase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 25, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.15 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a endo-polygalacturonase (pectinase), optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 125, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.17 (or a corresponding formulation, polynucleotide, or organism) is used to prevent, treat, suppress, eliminate and/or reduce the severity of an infestation/infection of a plant or plant part of/by one or more Botrytis (e.g., B. cinerea). For example, a lysozyme, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 26, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.21 (or a corresponding formulation, polynucleotide, or organism) is used to prevent, treat, suppress, eliminate and/or reduce the severity of an infestation/infection of a plant or plant part of/by one or more Magnaporthe (e.g., M. grisea, M. oryzae), Penicillium (e.g., P. digitatum, P. expansum, P. italicum, P. rugulosum, P. verrucosum), and Phytophthora (e.g., P. capsici, P. cinnamomi, P. infestans, P. parasitica, P. ramorum, P. sojae). For example, a beta-glucosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 126, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.39 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme) and Zymoseptoria (e.g., Z. tritici). For example, a glucan endo-1,3-beta-D-glucosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 27-28, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.41 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a pullulanase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 29, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.55 (or a corresponding formulation, polynucleotide, or organism) is used to prevent, treat, suppress, eliminate and/or reduce the severity of an infestation/infection of a plant or plant part of/by one or more Penicillium (e.g., P. digitatum, P. expansum, P. italicum, P. rugulosum, P. verrucosum). For example, an alpha-L-arabinofuranosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 129, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.58 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a glucan 1,3-beta-glucosidase (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.59 (or a corresponding formulation, polynucleotide, or organism) is used to prevent, treat, suppress, eliminate and/or reduce the severity of an infestation/infection of a plant or plant part of/by one or more Zymoseptoria (e.g., Z. tritici). For example, a glucan endo-1,3-alpha-glucosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 30, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.73 (or a corresponding formulation, polynucleotide, or organism) is used to prevent, treat, suppress, eliminate and/or reduce the severity of an infestation/infection of a plant or plant part of/by one or more Fusarium (e.g., F. graminearum, F. oxysporum, F. virgulforme). For example, a licheninase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 132, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.75 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme) and Zymoseptoria (e.g., Z. tritici). For example, a glucan endo-1,6-beta-glucosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 31-32, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.78 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Pseudoperonospora (e.g., P. cubensis) and Zymoseptoria (e.g., Z. tritici).

For example, a mannan endo-1,4-beta-mannosidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 33, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.101 (or a corresponding formulation, polynucleotide, or organism) is used to prevent, treat, suppress, eliminate and/or reduce the severity of an infestation/infection of a plant or plant part of/by one or more Fusarium (e.g., F. graminearum, F. oxysporum, F. virguliforme) and Zymoseptoria (e.g., Z. tritici). Pro For example, a protein teins comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 34 (or a corresponding formulation, polynucleotide, or organism) may be applied to a plant or plant part to prevent, treat, suppress, eliminate and/or reducing the severity of such infestations/infections. For example, a mannan endo-1,6-alpha-mannosidase (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.109 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme) and Zymoseptoria (e.g., Z. tritici). For example, a endogalactosaminidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 35-40, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.2.1.133 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme) and Zymoseptoria (e.g., Z. tritici). For example, a glucan 1,4-alpha-maltohydrase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 41, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virgulforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a peptidases, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-48, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.11 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, an aminopeptidase (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.11.1 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi) and Zymoseptoria (e.g., Z. tritici). For example, a leucyl aminopeptidase (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.21 (or a corresponding formulation, polynucleotide, or organism) is used to prevent, treat, suppress, eliminate and/or reduce the severity of an infestation/infection of a plant or plant part of/by one or more Blumeria (e.g., B. graminis), Botrytis (e.g., B. cinerea), Fusarium (e.g., F. graminearum, F. oxysporum, F. virguliforme), Magnaporthe (e.g., M. grisea, M. oryzae), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a serine endopeptidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 42-47, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.21.19 (or a corresponding formulation, polynucleotide, or organism) is used to prevent, treat, suppress, eliminate and/or reduce the severity of an infestation/infection of a plant or plant part of/by one or more Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae) and Pseudoperonospora (e.g., P. cubensis). For example, a glutamyl endopeptidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 43, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.21.62 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae), Pseudoperonospora (e.g., P. cubensis) and Zymoseptoria (e.g., Z. tritici). For example, a subtilisin, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 44-47, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.24 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, a metalloendopeptidase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 48, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 3.4.24.28 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Phakopsora (e.g., P. pachyrhizi), Phytophthora (e.g., P. capsici, P. cinnamomi, P. infestans, P. parasitica, P. ramorum, P. sojae) and Zymoseptoria (e.g., Z. tritici). For example, a bacillolycin, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 48, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 4.2 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). For example, a carbon-oxygen lyase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 4.2.2 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). For example, a polysaccharide lyase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149, (or a corresponding formulation, polynucleotide, or organism) may be applied to a plant or plant part to prevent, treat, suppress, eliminate and/or reducing the severity of such infestations/infections.

In some embodiments, a protein exhibiting activity belonging to belonging to EC 4.2.2.2 (or a corresponding formulation, polynucleotide, or organism) is used to prevent, treat, suppress, eliminate and/or reduce the severity of an infestation/infection of a plant or plant part of/by one or more Botrytis (e.g., B. cinerea), Fusarium (e.g., F. graminearum, F. oxysporum, F. virguliforme), Penicillium (e.g., P. digitatum, P. expansum, P. italicum, P. rugulosum, P. verrucosum), and Zymoseptoria (e.g., Z. tritici). For example, a pectate lyase, optionally a protein comprising, consisting essentially of or consisting of an amino acid sequence that is about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% identical to one or more of the amino acid sequences set forth herein as SEQ ID NOs: 149, (or a corresponding formulation, polynucleotide, or organism) may be applied to a plant or plant part to prevent, treat, suppress, eliminate and/or reducing the severity of such infestations/infections.

Compositions of the present disclosure may be applied to any plant type, including, but not limited to, row crops and vegetables. In some embodiments, compositions of the present disclosure are formulated for the treatment of one or more plants selected from the families Amaranthaceae (e.g., chard, spinach, sugar beet, quinoa), Asteraceae (e.g., artichoke, asters, chamomile, chicory, chrysanthemums, dahlias, daisies, echinacea, goldenrod, guayule, lettuce, marigolds, safflower, sunflowers, zinnias), Brassicaceae (e.g., arugula, broccoli, bok choy, Brussels sprouts, cabbage, cauliflower, canola, collard greens, daikon, garden cress, horseradish, kale, mustard, radish, rapeseed, rutabaga, turnip, wasabi, watercress, Arabidopsis thaliana), Caricaceae (e.g., papaya), Cucurbitaceae (e.g., cantaloupe, cucumber, honeydew, melon, pumpkin, squash (e.g., acorn squash, butternut squash, summer squash), watermelon, zucchini), Fabaceae (e.g., alfalfa, beans, carob, clover, guar, lentils, mesquite, peas, peanuts, soybeans, tamarind, tragacanth, vetch), Malvaceae (e.g., cacao, cotton, durian, hibiscus, kenaf, kola, okra), Poaceae (e.g., bamboo, barley, corn, fonio, lawn grass (e.g., Bahia grass, Bermudagrass, bluegrass, Buffalograss, Centipede grass, Fescue, or Zoysia), millet, oats, ornamental grasses, rice, rye, sorghum, sugar cane, triticale, wheat and other cereal crops, Polygonaceae (e.g., buckwheat), Rosaceae (e.g., almonds, apples, apricots, blackberry, blueberry, cherries, peaches, plums, quinces, raspberries, roses, strawberries), Solanaceae (e.g., bell peppers, chili peppers, eggplant, petunia, potato, tobacco, tomato) and Vitaceae (e.g., grape).

Non-limiting examples of plants that may be treated with compositions of the present disclosure include plants sold under the ACCELERON®, AGRIPRO®, AGRISURE®, AGROESTE®, AGVENTURE®, ALFOREX™ ASGROW®, AQUAMAX®, BOLLGARD II™, BOLLGARD™ 3, BREVANT™, CHANNEL™, CONFIDOR™, CORTEVA AGRISCIENCE™, CORVUS™, CREDENZ®, CROPSTAR™, DAIRYLAND™, DEKALB®, DELTAPINE™, DERUITER™, DROUGHTGARD®, ENLIST E3®, ENOGEN®, FIBERMAX®, GAUCHO™ GENUITY®, GOLDENHARVEST®, HOEGEMEYER™, INTACTA RR2 PRO™, INVIGOR®, LIBERTY LINK®, NEXGROW®, NK®, NUTECH SEED®, OPTIMUM®, PHYTOGEN®, PIONEER®, QROME®, RIB COMPLETE®, ROUNDUP READY®, ROUNDUP READY 2 YIELD®, ROUNDUP READY 2 XTEND®, SEMETES AGROCERES™, SEMINIS™, SMARTSTAX®, STONEVILLE®, SYNGENTA®, TRUFLEX™, VT DOUBLE PRO®, VT TRIPLE PRO®, YIELDGARD®, YIELDGARD VT ROOTWORM/RR2®, YIELDGARD VT TRIPLE® and/or XTENDFLEX™ tradenames.

Compositions of the present disclosure may be applied to any part/portion of a plant. In some embodiments, the compositions are applied to plant propagation materials (e.g., cuttings, rhizomes, seeds and tubers). In some embodiments, the compositions are applied to the roots of a plant. In some embodiments, the compositions are applied to the foliage of a plant. In some embodiments, the compositions are applied to both the roots and the foliage of a plant. In some embodiments, the compositions are applied to plant propagation materials and to the plants that grow from said plant propagation materials.

Compositions of the present disclosure may be applied to any plant growth medium, including, but not limited to, soil.

Compositions of the present disclosure may be applied to plants, plant parts and/or plant growth media in any suitable manner, including, but not limited to, on-seed application, in-furrow application and foliar application.

Compositions of the present disclosure may be applied using any suitable method(s), including, but not limited to, coating, dripping, dusting, encapsulating, fogging, immersing, spraying, and soaking. Batch systems, in which predetermined batch sizes of material and composition are delivered into a mixer, may be employed. Continuous treatment systems, which are calibrated to apply composition at a predefined rate in proportion to a continuous flow of material, may also be employed. In some embodiments, compositions of the present disclosure are applied using a boom sprayer or an orchard sprayer.

In some embodiments, compositions of the present disclosure are applied directly to plant propagation material (e.g., seeds). According to some embodiments, plant propagation materials are soaked in a composition of the present disclosure for at least 0.1, 0.2, 0.3, 0.4, 0.5, 0.6, 0.7, 0.8, 0.9, 1, 1.25, 1.5, 1.75, 2, 3, 4, 5, 6, 9, 12, 15, 18, 21, 24, 36, 48 hours. According to some embodiments, plant propagation materials are coated with the compositions. Plant propagation materials may be coated with one or more additional layers (e.g., one or more protective layers that serve to enhance the stability and/or activity of an enzyme/organism of the present disclosure and/or one or more sequestration layers comprising substances that may reduce the stability and/or activity of an enzyme/organism of the present disclosure if included in the same layer as the enzyme/organism of the present disclosure). In some embodiments, the coating comprises, consists essentially of, or consists of a composition of the present disclosure and a drying powder.

In some embodiments, compositions of the present disclosure are applied directly to a plant growth medium (e.g., a soil). According to some embodiments, the compositions are applied in the vicinity of a plant propagation material (e.g., a seed). According to some embodiments, the compositions are applied to the root zone of a plant.

According to some embodiments, the compositions are applied using a drip irrigation system.

In some embodiments, compositions of the present disclosure are applied directly to plants. According to some embodiments, the compositions are fogged, misted, sprayed and/or sprinkled onto the plant(s) to be treated (e.g., foliar sprays).

In some embodiments, compositions of the present disclosure are applied to harvested plants and/or plant parts.

Individual components of the compositions (e.g., proteins of the present disclosure and chemical pesticides) may be separately or together. For example, in some embodiments, compositions of the present disclosure may be incorporated into integrated pest management strategies (e.g., a formulation comprising one or more proteins of the present disclosure may be applied to an orchard/vineyard as part of an integrated pest management strategy that includes separate applications of 2, 3, 4, 5 or more distinct pesticides in a rotation designed to reduce/prevent chemical pesticide-induced phytotoxicity and/or pest resistance).

In some embodiments, compositions of the present disclosure are freeze- spray- or spray-freeze-dried and then applied to plants/plant parts. For examples, in some embodiments, a formulation comprising and enzyme/organism of the present disclosure and one or more stabilizing components (e.g., one or more maltodextrins having a DEV of about 15 to about 20) is freeze- spray- or spray-freeze-dried, mixed with a drying powder (e.g., a drying powder comprising calcium stearate, attapulgite clay, montmorillonite clay, graphite, magnesium stearate, silica (e.g., fumed silica, hydrophobically-coated silica and/or precipitated silica) and/or talc), then coated on seed that was been pre-treated with one or more adhesives (e.g., an adhesive composition comprising one or more maltodextrins, one or more mono-, di- or oligosaccharides, one or more peptones, etc.), one or more pesticides and/or one or more plant signal molecules (e.g., one or more LCOs).

Compositions of the present disclosure may be applied to plants, plant parts and/or plant growth media in any suitable amount(s)/concentration(s).

Compositions of the present disclosure may be used to prevent and/or treat infestations/infections of/by horticultural pests at any time, including, prior to planting, at the time of planting, after planting, prior to germination, after germination, prior to seedling emergence, at the time of seedling emergence, after seedling emergence, prior to the vegetative stage, during the vegetative stage, after the vegetative stage, prior to the reproductive stage, during the reproductive stage, after the reproductive stage, prior to flowering, at the time of flowering, after flowering, prior to fruiting, at the time of fruiting, after fruiting, prior to ripening, at the time of ripening, after ripening, prior to harvest, at the time of harvest, and after harvesting. Indeed, compositions of the present disclosure may be used to extend the shelf-life of harvested products by preventing, treating, suppressing, eliminating and/or reducing the severity of infestations/infections of/by acarids, bacteria, fungi, insects, oomycetes and protozoa for many weeks/months post-harvest.

Compositions of the present disclosure may be applied to plants, plant parts and/or plant growth media at any time, including, but not limited to, prior to planting, at the time of planting, after planting, prior to germination, at the time of germination, after germination, prior to seedling emergence, at the time of seedling emergence, after seedling emergence, prior to the vegetative stage, during the vegetative stage, after the vegetative stage, prior to the reproductive stage, during the reproductive stage, after the reproductive stage, prior to flowering, at the time of flowering, after flowering, prior to fruiting, at the time of fruiting, after fruiting, prior to ripening, at the time of ripening, after ripening, prior to harvest, at the time of harvest, and after harvesting.

In some embodiments, compositions of the present disclosure are applied to plant propagation materials (e.g., seeds) about/at least 1, 2, 3, 4, 5, 6, 7, 8, 9, 10, 11, 12, 13, 14, 15, 16, 17, 18, 19, 20, 21, 22, 23, 24, 28, 32, 36, 40, 44, 48, 52, 56, 60, 64, 68, 72, 76, 80, 84, 88, 92, 96, 100, 104 weeks prior to planting.

In some embodiments, compositions of the present disclosure are applied to plant propagation materials (e.g., seeds) at the time of planting.

In some embodiments, compositions of the present disclosure are applied to plant propagation materials (e.g., seeds) after planting but before germination.

In some embodiments, compositions of the present disclosure are applied to plants following emergence.

In some embodiments, compositions of the present disclosure are applied to a plant or plant part pre-harvest (i.e., within 1, 2, 3, 4, 5, 6, 7, 8, 9, 10, 11, 12, 13, 14, 15 or more days before the plant or plant part is (to be) harvested).

In some embodiments, compositions of the present disclosure are applied to a plant or plant part post-harvest (i.e., after the plant or plant part has been harvested).

In some embodiments, compositions of the present disclosure are applied to a processed plant product.

In some embodiments, compositions of the present disclosure are applied to a harvest plant or plant part at a processing/shipping facility.

In some embodiments, compositions of the present disclosure are applied to a processed plant product.

The present disclosure thus extends to plants and plant parts that have been treated with a composition of the present disclosure (e.g., plant propagation materials coated with a formulation comprising one or more enzymes of the present disclosure, plants sprayed with a formulation comprising one or more enzymes of the present disclosure, harvested plant parts coated with a formulation comprising one or more enzymes of the present disclosure), to plants grown from plant propagation materials that were treated with a composition of the present disclosure, to plant parts harvested from plants that have been treated with a composition of the present disclosure, to plant parts harvested from plants grown from plant propagation materials that were treated with a composition of the present disclosure, to crops comprising a plurality of plants that were treated with a composition of the present disclosure, to crops comprising a plurality of plants grown from plant propagation materials that were treated with a composition of the present disclosure, to crops treated with a composition of the present disclosure, to processed products derived from plants that were treated with a composition of the present disclosure, to processed products derived from plants grown from plant parts that were treated with a composition of the present disclosure, and to processed products treated with a composition of the present disclosure.

As noted above, proteins of the present disclosure may be formulated into compositions comprising a variety of components, such as adhesives (stickers), chemical actives, dispersants (spreaders), drying agents, emulsifiers, microbes, nutrients, pest attractants and feeding stimulants, pH control components, postharvest treatments, rain fasteners, rhealogical agents, safeners, stabilizers, UV protectants and wetting agents. It is to be understood that compositions and methods of the present disclosure may likewise be used in combination with such components as separate and distinct compositions (as part of an integrated pest management strategy, for example).

It is to be understood that compositions and methods of the present disclosure are not limited to horticultural uses. The same activities that make enzymes, formulations, nucleic acids and organisms of the present disclosure useful for preventing, treating, suppressing, eliminating and/or reducing the severity of infestations/infections of/by horticultural pests likewise render them useful for preventing, treating, suppressing, eliminating and/or reducing the severity of infestations/infections of/by bacteria, fungi, insects and oomycetes in and on various media, such as food storage containers, animal bedding/feed, clothing, hard surfaces, medical instruments, etc. Thus, it is to be understood that compositions and methods of the present disclosure may be modified for use in any other industry or endeavor in which such prevention, treatment, suppression, elimination and/or reduction in disease severity may be of benefit.

The following is a non-exhaustive listing of concepts and embodiments encompassed by the present disclosure:

Use of a protein or formulation of the present disclosure for any one, two, three, four, five, six, seven, eight, nine, ten or more of the following:
1) preventing/treating/suppressing/eliminating an infestation/infection of a plant or plant part by a horticultural pest
2) preventing/treating/suppressing/eliminating an infestation/infection of a plant or plant part by an acarid
3) preventing/treating/suppressing/eliminating an infestation/infection of a plant or plant part by a bacterium
4) preventing/treating/suppressing/eliminating an infestation/infection of a plant or plant part by a fungus
5) preventing/treating/suppressing/eliminating an infestation/infection of a plant or plant part by a gastropod
6) preventing/treating/suppressing/eliminating an infestation/infection of a plant or plant part by an insect
7) preventing/treating/suppressing/eliminating an infestation/infection of a plant or plant part by a nematode
8) preventing/treating/suppressing/eliminating an infestation/infection of a plant or plant part by an oomycete
9) preventing/treating/suppressing/eliminating an infestation/infection of a plant or plant part by a protozoan
10) reducing disease severity in plants affected by one or more horticultural pests
11) reducing disease severity in plants affected by a phytopathogenic acarid
12) reducing disease severity in plants affected by a phytopathogenic bacteria
13) reducing disease severity in plants affected by a phytopathogenic fungus
14) reducing disease severity in plants affected by a phytopathogenic gastropod
15) reducing disease severity in plants affected by a phytopathogenic insect
16) reducing disease severity in plants affected by a phytopathogenic nematode
17) reducing disease severity in plants affected by a phytopathogenic oomycete
18) reducing disease severity in plants affected by a phytopathogenic protozoa
19) treating a surface/substance that is susceptible to infestation/infection by a horticultural pest
20) treating a surface/substance that is susceptible to infestation/infection by an acarid
21) treating a surface/substance that is susceptible to infestation/infection by a bacterium
22) treating a surface/substance that is susceptible to infestation/infection by a fungus
23) treating a surface/substance that is susceptible to infestation/infection by a gastropod
24) treating a surface/substance that is susceptible to infestation/infection by an insect
25) treating a surface/substance that is susceptible to infestation/infection by a nematode
26) treating a surface/substance that is susceptible to infestation/infection by an oomycete
27) treating a surface/substance that is susceptible to infestation/infection by a protozoan
28) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a horticultural pest
29) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by an acarid
30) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a bacterium
31) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a fungus
32) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a gastropod
33) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by an insect
34) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a nematode
35) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by an oomycete
36) preventing/treating/suppressing/eliminating an infestation/infection of a container, such as a seed container, a planting pot, a hydroponic growth system, an experimental growth chamber, a greenhouse, a postharvest storage container, a postharvest treatment chamber or a postharvest shipping container, by a protozoan
37) treating (e.g., coating, dipping, drenching, fogging, misting, soaking, spraying) a plant or plant part
38) treating (e.g., drenching, fogging, irrigating, misting, spraying) a plant growth medium
39) treating a planting/irrigation/fertilization/harvesting/packing/storage apparatus
40) treating (e.g., coating, dipping, drenching, fogging, misting, soaking, spraying) a storage container prior to/concurrently with/subsequent to introduction of a plant or plant part into said storage container
41) treating (e.g., coating, dipping, drenching, fogging, misting, soaking, spraying) a harvested plant or plant part
42) prolonging the shelf-life of a harvested plant or plant part
43) delaying the ripening of a harvested plant or plant part
44) hastening the ripening of a harvested plant or plant part
45) improving the efficacy of a chemical pesticide
46) improving the efficacy of a chemical acaricide
47) improving the efficacy of a chemical bactericide
48) improving the efficacy of a chemical fungicide
49) improving the efficacy of a chemical gastropodicide
50) improving the efficacy of a chemical herbicide
51) improving the efficacy of a chemical insecticide
52) improving the efficacy of a chemical nematicide
53) improving the efficacy of a chemical oomyceticide
54) improving the efficacy of a chemical protozoacide
55) improving the efficacy of a biological pesticide
56) improving the efficacy of a biological acaricide
57) improving the efficacy of a biological bactericide
58) improving the efficacy of a biological fungicide
59) improving the efficacy of a biological gastropodicide
60) improving the efficacy of a biological herbicide
61) improving the efficacy of a biological insecticide
62) improving the efficacy of a biological nematicide
63) improving the efficacy of a biological oomyceticide
64) improving the efficacy of a biological protozoacide
65) improving the efficacy of a preharvest treatment
66) improving the efficacy of a postharvest treatment
67) expanding the target spectrum of a chemical pesticide
68) expanding the target spectrum of a chemical acaricide
69) expanding the target spectrum of a chemical bactericide
70) expanding the target spectrum of a chemical fungicide
71) expanding the target spectrum of a chemical gastropodicide
72) expanding the target spectrum of a chemical herbicide
73) expanding the target spectrum of a chemical insecticide
74) expanding the target spectrum of a chemical nematicide
75) expanding the target spectrum of a chemical oomyceticide
76) expanding the target spectrum of a chemical protozoacide
77) expanding the target spectrum of a biological pesticide
78) expanding the target spectrum of a biological acaricide
79) expanding the target spectrum of a biological bactericide
80) expanding the target spectrum of a biological fungicide
81) expanding the target spectrum of a biological gastropodicide
82) expanding the target spectrum of a biological herbicide
83) expanding the target spectrum of a biological insecticide
84) expanding the target spectrum of a biological nematicide
85) expanding the target spectrum of a biological oomyceticide
86) expanding the target spectrum of a biological protozoacide
87) expanding the target spectrum of a preharvest treatment
88) expanding the target spectrum of a postharvest treatment
89) reducing chemical pesticide-induced pest resistance and/or phytotoxicity
90) reducing biological pesticide-induced pest resistance and/or phytotoxicity
91) inclusion as part of an integrated pest management strategy.

Any of the foregoing uses in which any one, two, three, four, five, six, seven, eight, nine, ten or more of the following is true:
1) the protein is an enzyme
2) the protein is an enzyme belonging to EC 1
3) the protein is an enzyme belonging to EC 1.1
4) the protein is an enzyme belonging to EC 1.1.3
5) the protein is an enzyme belonging to EC 1.1.3.4
6) the protein is an enzyme belonging to EC 1.1.3.25
7) the protein is an enzyme belonging to EC 1.10
8) the protein is an enzyme belonging to EC 1.10.3
9) the protein is an enzyme belonging to EC 1.10.3.2
10) the protein is an enzyme belonging to EC 1.11
11) the protein is an enzyme belonging to EC 1.11.1
12) the protein is an enzyme belonging to EC 1.11.1.6
13) the protein is an enzyme belonging to EC 1.11.1.7
14) the protein is an enzyme belonging to EC 1.14
15) the protein is an enzyme belonging to EC 1.14.99
16) the protein is an enzyme belonging to EC 1.14.99.56
17) the protein is an enzyme belonging to EC 3
18) the protein is an enzyme belonging to EC 3.1
19) the protein is an enzyme belonging to EC 3.1.1
20) the protein is an enzyme belonging to EC 3.1.1.3
21) the protein is an enzyme belonging to EC 3.1.1.5
22) the protein is an enzyme belonging to EC 3.1.1.11
23) the protein is an enzyme belonging to EC 3.1.1.32
24) the protein is an enzyme belonging to EC 3.1.4
25) the protein is an enzyme belonging to EC 3.1.4.3
26) the protein is an enzyme belonging to EC 3.1.4.11
27) the protein is an enzyme belonging to EC 3.2
28) the protein is an enzyme belonging to EC 3.2.1
29) the protein is an enzyme belonging to EC 3.2.1.1
30) the protein is an enzyme belonging to EC 3.2.1.3
31) the protein is an enzyme belonging to EC 3.2.1.4
32) the protein is an enzyme belonging to EC 3.2.1.5
33) the protein is an enzyme belonging to EC 3.2.1.6
34) the protein is an enzyme belonging to EC 3.2.1.7
35) the protein is an enzyme belonging to EC 3.2.1.8
36) the protein is an enzyme belonging to EC 3.2.1.11
37) the protein is an enzyme belonging to EC 3.2.1.14
38) the protein is an enzyme belonging to EC 3.2.1.15
39) the protein is an enzyme belonging to EC 3.2.1.17
40) the protein is an enzyme belonging to EC 3.2.1.21
41) the protein is an enzyme belonging to EC 3.2.1.37
42) the protein is an enzyme belonging to EC 3.2.1.39
43) the protein is an enzyme belonging to EC 3.2.1.41
44) the protein is an enzyme belonging to EC 3.2.1.55
45) the protein is an enzyme belonging to EC 3.2.1.58
46) the protein is an enzyme belonging to EC 3.2.1.59
47) the protein is an enzyme belonging to EC 3.2.1.73
48) the protein is an enzyme belonging to EC 3.2.1.75
49) the protein is an enzyme belonging to EC 3.2.1.78
50) the protein is an enzyme belonging to EC 3.2.1.91
51) the protein is an enzyme belonging to EC 3.2.1.101
52) the protein is an enzyme belonging to EC 3.2.1.109
53) the protein is an enzyme belonging to EC 3.2.1.132
54) the protein is an enzyme belonging to EC 3.2.1.133
55) the protein is an enzyme belonging to EC 3.2.1.176
56) the protein is an enzyme belonging to EC 3.4
57) the protein is an enzyme belonging to EC 3.4.11
58) the protein is an enzyme belonging to EC 3.4.11.1
59) the protein is an enzyme belonging to EC 3.4.21
60) the protein is an enzyme belonging to EC 3.4.21.19
61) the protein is an enzyme belonging to EC 3.4.21.62
62) the protein is an enzyme belonging to EC 3.4.24
63) the protein is an enzyme belonging to EC 3.4.24.28
64) the protein is an enzyme belonging to EC 3.5
65) the protein is an enzyme belonging to EC 3.5.1
66) the protein is an enzyme belonging to EC 3.5.1.1
67) the protein is an enzyme belonging to EC 4
68) the protein is an enzyme belonging to EC 4.2
69) the protein is an enzyme belonging to EC 4.2.2
70) the protein is an enzyme belonging to EC 4.2.2.2
71) the protein comprises one or more polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof
72) the protein comprises one or more polypeptides encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof
73) the protein comprises one or more polypeptides derived from any one of SEQ ID NOs: 1-48 and 98-150 by substitution, deletion or insertion of one or more amino acids
74) the protein comprises one or more polypeptides derived from a mature polypeptide of any one of SEQ ID NOs: 1-48 and 98-150 by substitution, deletion or insertion of one or more amino acids
75) the protein comprises one or more polypeptides derived from any one of 71) through 74) wherein the N- and/or C-terminal end has been extended by the addition of one or more amino acids
76) the protein comprises a fragment of any one of 71) through 75)
77) the protein is an enzymatically active fragment/mutant/variant of any one of SEQ ID NOs: 1-48 and 98-150 or a mature polypeptide thereof
78) the formulation comprises 2, 3, 4, 5, 6, 7, 8, 9, 10 or more proteins of the present disclosure or enzymatically active fragments/mutations/variants thereof
79) the formulation comprises one or more adhesives
80) the formulation comprises one or more pest attractants
81) the formulation comprises one or more pest feeding stimulants
82) the formulation comprises one or more chemical pesticides
83) the formulation comprises one or more chemical acaricides
84) the formulation comprises one or more chemical bactericides
85) the formulation comprises one or more chemical fungicides
86) the formulation comprises one or more chemical gastropodicides
87) the formulation comprises one or more chemical herbicides
88) the formulation comprises one or more chemical insecticides
89) the formulation comprises one or more chemical nematicides
90) the formulation comprises one or more chemical oomyceticides
91) the formulation comprises one or more chemical protozoacides
92) the formulation comprises one or more biological pesticides
93) the formulation comprises one or more biological acaricides
94) the formulation comprises one or more biological bactericides
95) the formulation comprises one or more biological fungicides
96) the formulation comprises one or more biological gastropodicides
97) the formulation comprises one or more biological herbicides
98) the formulation comprises one or more biological insecticides
99) the formulation comprises one or more biological nematicides
100) the formulation comprises one or more biological oomyceticides
101) the formulation comprises one or more biological protozoacides
102) the formulation comprises one or more dispersants
103) the formulation comprises one or more polyols
104) the formulation comprises glycerol
105) the formulation comprises sorbitol
106) the formulation comprises one or more pH control components
107) the formulation comprises an acetate buffer
108) the formulation comprises a sodium acetate buffer
109) the formulation comprises a carbonate buffer
110) the formulation comprises a sodium carbonate buffer
111) the formulation comprises a citrate buffer
112) the formulation comprises a sodium citrate buffer
113) the formulation comprises a phosphate buffer
114) the formulation comprises a potassium phosphate buffer
115) the formulation has a pH of about 3 to about 7
116) the formulation has a pH of about 3 to about 6
117) the formulation has a pH of about 3 to about 5
118) the formulation has a pH of about 4 to about 5
119) the formulation has a pH of less than 5
120) the formulation has a pH of more than 5
121) the formulation has a pH of about 5 to about 6
122) the formulation has a pH of about 5 to about 7.5
123) the formulation has a pH of less than 6
124) the formulation has a pH of more than 6
125) the formulation has a pH of about 6 to about 7
126) the formulation has a pH of less than 6.5
127) the formulation has a pH of more than 6.5
128) the formulation has a pH of less than 7
129) the formulation has a pH of more than 7
130) the formulation has a pH of about 6 to about 7.5
131) the formulation has a pH of more than 7.5
132) the formulation has a pH of about 7.5 to about 10
133) the formulation has a pH of about 8 to about 10
134) the formulation has a pH of about 8.5 to about 9.5
135) the formulation comprises one or more rain fasteners
136) the formulation comprises one or more organo-modified siloxanes
137) the formulation comprises one or more organo-modified trisiloxanes
138) the formulation comprises one or more polyether trisiloxanes
139) the formulation comprises one or more organo-modified polysiloxanes
140) the formulation comprises one or more polyether polysiloxanes
141) the formulation comprises one or more preservatives
142) the formulation comprises potassium benzoate
143) the formulation comprises potassium sorbate
144) the formulation comprises sodium benzoate
145) the formulation comprises sodium sorbate
146) the formulation comprises one or more postharvest treatments
147) the formulation comprises one or more essential oils
148) the formulation comprises one or more ethylene biosynthesis inhibitors
149) the formulation comprises one or more cyclopropenes
150) the formulation comprises one or more waxes
151) the protein or formulation is applied in a pesticidally effective amount
152) the protein or formulation is applied in an acaricidally effective amount
153) the protein or formulation is applied in a bactericidally effective amount
154) the protein or formulation is applied in a fungicidally effective amount
155) the protein or formulation is applied in a gastropodicidally effective amount
156) the protein or formulation is applied in an herbicidally effective amount
157) the protein or formulation is applied in an insecticidally effective amount
158) the protein or formulation is applied in a nematicidally effective amount
159) the protein or formulation is applied in an oomyceticidally effective amount
160) the protein or formulation is applied in a protozoacidally effective amount
161) the protein or formulation is applied in a pesticidally ineffective amount (e.g., as an adjuvant)
162) the protein or formulation is applied in an acaricidally ineffective amount (e.g., as an adjuvant)
163) the protein or formulation is applied in a bactericidally ineffective amount (e.g., as an adjuvant)
164) the protein or formulation is applied in a fungicidally ineffective amount (e.g., as an adjuvant)
165) the protein or formulation is applied in a gastropodicidally ineffective amount (e.g., as an adjuvant)
166) the protein or formulation is applied in a herbicidially ineffective amount (e.g., as an adjuvant)
167) the protein or formulation is applied in an insecticidally ineffective amount (e.g., as an adjuvant)
168) the protein or formulation is applied in a nematicidally ineffective amount (e.g., as an adjuvant)
169) the protein or formulation is applied in an oomyceticidally ineffective amount (e.g., as an adjuvant)
170) the protein or formulation is applied in a protozoacidally ineffective amount (e.g., as an adjuvant)
171) the protein or formulation is used in combination with one or more adhesives (e.g., in a tank mix)
172) the protein or formulation is used in combination with one or more pest attractants (e.g., in a tank mix)
173) the protein or formulation is used in combination with one or more pest feeding stimulants (e.g., in a tank mix)
174) the protein or formulation is used in combination with one or more chemical pesticides (e.g., in a tank mix)
175) the protein or formulation is used in combination with one or more chemical acaricides (e.g., in a tank mix)
176) the protein or formulation is used in combination with one or more chemical bactericides (e.g., in a tank mix)
177) the protein or formulation is used in combination with one or more chemical fungicides (e.g., in a tank mix)
178) the protein or formulation is used in combination with one or more chemical gastropodicides (e.g., in a tank mix)
179) the protein or formulation is used in combination with one or more chemical herbicides (e.g., in a tank mix)
180) the protein or formulation is used in combination with one or more chemical insecticides (e.g., in a tank mix)
181) the protein or formulation is used in combination with one or more chemical nematicides (e.g., in a tank mix)
182) the protein or formulation is used in combination with one or more chemical oomyceticides (e.g., in a tank mix)
183) the protein or formulation is used in combination with one or more chemical protozoacides (e.g., in a tank mix)
184) the protein or formulation is used in combination with one or more microbial pesticides (e.g., in a tank mix)
185) the protein or formulation is used in combination with one or more microbial acaricides (e.g., in a tank mix)
186) the protein or formulation is used in combination with one or more microbial bactericides (e.g., in a tank mix)
187) the protein or formulation is used in combination with one or more microbial fungicides (e.g., in a tank mix)
188) the protein or formulation is used in combination with one or more microbial gastropodicides (e.g., in a tank mix)
189) the protein or formulation is used in combination with one or more microbial herbicides (e.g., in a tank mix)
190) the protein or formulation is used in combination with one or more microbial insecticides (e.g., in a tank mix)
191) the protein or formulation is used in combination with one or more microbial nematicides (e.g., in a tank mix)
192) the protein or formulation is used in combination with one or more microbial oomyceticides (e.g., in a tank mix)
193) the protein or formulation is used in combination with one or more microbial protozoacides (e.g., in a tank mix)
194) the protein or formulation is used in combination with one or more diazotrophs (e.g., in a tank mix)
195) the protein or formulation is used in combination with one or more phosphate-solubilizing microorganisms (e.g., in a tank mix)
196) the protein or formulation is used in combination with one or more plant growth regulators (e.g., in a tank mix)
197) the protein or formulation is used in combination with one or more rain fasteners (e.g., in a tank mix)
198) the protein or formulation is used in combination with one or more organo-modified siloxanes (e.g., in a tank mix)
199) the protein or formulation is used in combination with one or more organo-modified trisiloxanes (e.g., in a tank mix)
200) the protein or formulation is used in combination with one or more polyether trisiloxanes (e.g., in a tank mix)
201) the protein or formulation is used in combination with one or more organo-modified polysiloxanes (e.g., in a tank mix)
202) the protein or formulation is used in combination with one or more polyether polysiloxanes (e.g., in a tank mix)
203) the protein or formulation is used in combination with one or more preservatives (e.g., in a tank mix)
204) the protein or formulation is used in combination with one or more preharvest treatments (e.g., in a tank mix)
205) the protein or formulation is used in combination with one or more postharvest treatments (e.g., in a tank mix)
206) the protein or formulation is used in combination with one or more essential oils (e.g., in a tank mix)
207) the protein or formulation is used in combination with one or more ethylene biosynthesis inhibitors (e.g., in a tank mix)
208) the protein or formulation is used in combination with one or more cyclopropenes (e.g., in a tank mix)
209) the protein or formulation is used in combination with one or more waxes (e.g., in a tank mix).

A transgenic microorganism, plant or plant part that:
1) comprises one or more polynucleotides encoding a polypeptide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof
2) comprises one or more polynucleotides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof
3) expresses one or more polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof
4) comprises one or more polynucleotides encoding a polypeptide derived from any one of SEQ ID NOs: 1-48 and 98-150 by substitution, deletion or insertion of one or more amino acids
5) expresses one or more polypeptides derived from any one of SEQ ID NOs: 1-48 and 98-150 by substitution, deletion or insertion of one or more amino acids
6) comprises one or more polynucleotides encoding a polypeptide derived from a mature polypeptide of any one of SEQ ID NOs: 1-48 and 98-150 by substitution, deletion or insertion of one or more amino acids
7) expresses one or more polypeptides derived from a mature polypeptide of any one of SEQ ID NOs: 1-48 and 98-150 by substitution, deletion or insertion of one or more amino acids
8) comprises one or more polynucleotides encoding a polypeptide derived from any one of any one of 71) through 74) above wherein the N- and/or C-terminal end has been extended by the addition of one or more amino acids
9) expresses one or more polypeptides derived from any one of 71) through 74) above wherein the N- and/or C-terminal end has been extended by the addition of one or more amino acids
10) comprises one or more polynucleotides encoding an enzymatically active fragment of any one of 71) through 77) above
11) expresses an enzymatically active fragment of any one of 71) through 77) above.

Use of a rain fastener for any one, two, three, four, five, six, seven, eight, nine, ten or more of the following:
1) improving the adhesion/spreading/rainfastness of a protein on a surface/substance that is susceptible to infestation/infection by a horticultural pest
2) improving the adhesion/spreading/rainfastness of a protein on a surface/substance that is susceptible to infestation/infection by an acarid
3) improving the adhesion/spreading/rainfastness of a protein on a surface/substance that is susceptible to infestation/infection by a bacterium
4) improving the adhesion/spreading/rainfastness of a protein on a surface/substance that is susceptible to infestation/infection by a fungus
5) improving the adhesion/spreading/rainfastness of a protein on a surface/substance that is susceptible to infestation/infection by a gastropod
6) improving the adhesion/spreading/rainfastness of a protein on a surface/substance that is susceptible to infestation/infection by an insect
7) improving the adhesion/spreading/rainfastness of a protein on a surface/substance that is susceptible to infestation/infection by a nematode
8) improving the adhesion/spreading/rainfastness of a protein on a surface/substance that is susceptible to infestation/infection by an oomycete
9) improving the adhesion/spreading/rainfastness of a protein on a surface/substance that is susceptible to infestation/infection by a protozoan
10) improving the adhesion/spreading/rainfastness of a protein on a container, such as a seed container, a planting pot, a hydroponic growth system, an experimental growth chamber, a greenhouse, a postharvest storage container, a postharvest treatment chamber or a postharvest shipping container
11) improving the adhesion/spreading/rainfastness of a protein on a plant or plant part
12) improving the adhesion/spreading/rainfastness of a protein on a harvested plant or plant part
13) improving the pesticidal efficacy of a protein or formulation of the present disclosure
14) improving the acaricidal efficacy of a protein or formulation of the present disclosure
15) improving the bactericidal efficacy of a protein or formulation of the present disclosure
16) improving the fungicidal efficacy of a protein or formulation of the present disclosure
17) improving the gastropodicidal efficacy of a protein or formulation of the present disclosure
18) improving the herbicidal efficacy of a protein or formulation of the present disclosure
19) improving the insecticidal efficacy of a protein or formulation of the present disclosure
20) improving the nematicidal efficacy of a protein or formulation of the present disclosure
21) improving the oomyceticidal efficacy of a protein or formulation of the present disclosure
22) improving the protozoacidal efficacy of a protein or formulation of the present disclosure.

Any of the foregoing uses in which any one, two, three, four, five, six, seven, eight, nine, ten or more of the following is true:
1) the rain fastener comprises one or more organo-modified siloxanes
2) the rain fastener comprises one or more organo-modified trisiloxanes
3) the rain fastener comprises one or more polyether trisiloxanes
4) the rain fastener comprises one or more trisiloxane ethoxylates
5) the rain fastener comprises one or more trisiloxane polyethoxylates
6) the rain fastener comprises one or more organo-modified polysiloxanes
7) the rain fastener comprises one or more polyether polysiloxanes
8) the rain fastener comprises one or more polysiloxane ethoxylates
9) the rain fastener comprises one or more polysiloxane polyethoxylates
10) the rain fastener comprises one or more organo-modified siloxanes selected from the group consisting of trisiloxanes and polysiloxanes described by the general Formula I:

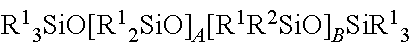

wherein
A is 0-200, preferably A is 0-1, more preferably A is 0;
B is 0-200, preferably B is 0.5-2; more preferably B is 1;

A+B>0;
R¹ represents identical or different from each other hydrocarbon substituents of 1-10 carbons or hydrogen, preferably methyl, ethyl, propyl and/or phenyl substituents, more preferably methyl substituents; and
R² represents identical or different from each other polyether substituents of the general Formula II:

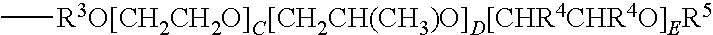

wherein
R³ represents identical or different from each other hydrocarbon moieties of 1-8 carbons, which optionally is interrupted by oxygen atoms, preferably linear hydrocarbons of 2-4 carbons, more preferably —CH₂—CH₂—CH₂—;
R⁴ represents identical or different from each other hydrocarbon substituents of 1-12 carbons or hydrogen, preferably methyl, ethyl, phenyl and/or hydrogen substituents;
R⁵ represents identical or different from each other hydrocarbon substituents of 1-16 carbons, which optionally contains urethane, carbonyl or carboxylic acid functionality, or hydrogen; preferably methyl or hydrogen; more preferably hydrogen;
C is 0-60, preferably C is 1-15;
D is 0-60, preferably D is 0-10;
E is 0-20, preferably E is 0-10, more preferably E is 0; and

C+D+E>0
11) the rain fastener comprises Oxirane, 2-methyl-, polymer with oxirane, mono[3-[1,3,3,3-tetramethyl-1-[(trimethylsilyl)oxy]-1-disiloxanyl]propyl] ether
12) the rain fastener comprises 3-(2-methoxyethoxy)propyl-methyl-bis(trimethylsilyloxy)silane
13) the rain fastener comprises polyalkyleneoxide silane and isotridecylalcohol ethoxylate
14) the rain fastener comprises 3-(polyoxyethylene)propylheptamethyltrisiloxane
15) the rain fastener comprises siloxane polyalkyleneoxide and fatty alcohol (C10-12) ethoxylate propoxylate
16) the rain fastener comprises Oxirane, 2-methyl-, polymer with oxirane, mono[3-[1,3,3,3-tetramethyl-1-[(trimethylsilyl)oxy]-1-disiloxanyl]propyl] ether.

### EXAMPLES

The following examples are provided to illustrate certain embodiments and are not to be construed as limiting the inventive concepts described in the present disclosure.

### Examples 1-3: Ormano-modified Siloxanes Improve Enzyme Rainfastness on Plant Surfaces

### Commercial Adjuvants Tested:

BREAK-THRU® S 301: Oxirane, 2-methyl-, polymer with oxirane, mono[3-[1,3,3,3-tetramethyl-1-[(trimethylsilyl)oxy]-1-disiloxanyl]propyl] ether (Evonik Operations Gmbh, Essen, Germany)
SILWET® L-77: 3-(2-methoxyethoxy)propyl-methyl-bis(trimethylsilyloxy)silane (Momentive Inc, Waterford, NY, USA)
SILWET® HS-312: Polyalkyleneoxide silane and isotridecylalcohol ethoxylate (Momentive Inc, Waterford, NY, USA)
SILWET® 408: 3-(Polyoxyethylene)propylheptamethyltrisiloxane (Momentive Inc, Waterford, NY, USA)
SILWET® STIK 2: Siloxane polyalkyleneoxide and fatty alcohol (C10-12) ethoxylate propoxylate (Momentive Inc, Waterford, NY, USA)
SILWET® 719: Oxirane, 2-methyl-, polymer with oxirane, mono[3-[1,3,3,3-tetramethyl-1-[(trimethylsilyl)oxy]-1-disiloxanyl]propyl] ether (Momentive Inc, Waterford, NY, USA)
Tween® L-1010: Polyoxyethylene (10) polyoxypropylene (10) sorbitan monolaurate (Croda International Plc, East Yorkshire, United Kingdom)
Tween® 24: Polyoxyethlene (16) sorbitan monolaurate (Croda International Plc, East Yorkshire, United Kingdom)
ADSEE™ 900: fatty alcohol ethoxylate (C10) (Nouryon Surface Chemistry AB, Stenungsund, Sweden)
ADSEE™ 973: Alcohol ethoxylate blend (Nouryon Surface Chemistry AB, Stenungsund, Sweden)
LUCROP® ROIL: Blend of esterfied oils and surfactants (LEVACO Chemicals Gmbh, Leverkusen, Germany)
ADSEE™ ST4: Maltodextrin/virylpyrrolidone polymer (Nouryon Surface Chemistry AB, Stenungsund, Sweden)
Ethylan® 995: Alcohol ethoxylate propoxylate (C16-18) (Nouryon Surface Chemistry AB, Stenungsund, Sweden)
Ethomeen® C/15: Coco alkylamine ethoxylate (Nouryon Surface Chemistry AB, Stenungsund, Sweden)

### Rain Fastness Assay:

The rain fastness assay was performed in a 24 well plate. The wells were filled with a heated 1% agar solution that solidifies after cooling to room temperature. 12 mm Leaf discs of preferred plants were prepared and added on top of the agar (the agar supported the leaf to not dry out so quickly).

After preparation of tank mix-formulations a 25 pL droplet of each sample were put in the middle of the leaf disc. The spreading behavior of the droplet was observed to avoid including results of samples in which the droplet spread so far that material was lost from the leaf. After addition of all samples the well plate was left to dry in a fume hood for 24h.

When dried, each disc was washed with 1 mL of tap water. The water was dispensed onto the leaf a total of 3 times. Afterwards the sample was analyzed for enzyme activity to determine residual amount on the leaf by using following equation:

$$\% Retention of treatment = 1 - ( activity units enzyme \text{} in \text{} wash \text{} \text{} solution / \\ activity \text{} units \text{} spray \text{} - solution added onto leaf )$$

The amount of protein added to spray solutions was given as weight percent (% w/w) protein of interest, which in the case of enzymes was determined using a colorimetric assay.

### Example 1

The retention of three enzymes—a cellobiose oxidase obtained from Microdochium nivale (NZ protein #6; SEQ ID NO: 6), a catalase obtained from Aspergillus niger (NZ protein #10; SEQ ID NO: 10), and a serine protease obtained from Nocardiopsis sp. (NZ protein #42; SEQ ID NO: 42)—with and without a trisiloxane adjuvant, BREAK-THRU® S 301, was evaluated. The spray-solutions were applied on top of tomato and grape leaf discs. Table 2 shows the retention of enzyme on the leaf after a simulated rain event.

TABLE 2
Retention of proteins on tomato and grape
leaves after a simulated rain event.

| | | % Retention |
|---|---|---|
| Foliar Spray Formulation | Leaf | of treatment |
| 0.0059% NZ Protein # 42 | Tomato | 40% |
| 0.95% K₂HPO₄ | | |
| 0.05% KH₂PO₄ | | |
| pH 7.9 | | |
| 0.0059% NZ Protein # 42 | Tomato | 95% |
| 0.05% BREAK-THRU ® S 301 | | |
| 0.95% K₂HPO₄ | | |
| 0.05% KH₂PO₄ | | |
| pH 7.9 | | |
| 0.0059% NZ Protein # 42 | Grape | 54% |
| 0.95% K₂HPO₄ | | |
| 0.05% KH₂PO₄ | | |
| pH 7.9 | | |
| 0.0059% NZ Protein # 42 | Grape | 100% |
| 0.05% BREAK-THRU ® S 301 | | |
| 0.95% K₂HPO₄ | | |
| 0.05% KH₂PO₄ | | |
| pH 7.9 | | |
| 0.001% NZ Protein # 6 | Grape | 68% |
| 0.6% K₂HPO₄ | | |
| 0.4% KH₂PO₄ | | |
| pH 6.9 | | |
| 0.001% NZ Protein # 6 | Grape | 95% |
| 0.05% BREAK-THRU ® S 301 | | |
| 0.6% K₂HPO₄ | | |
| 0.4% KH₂PO₄ | | |
| pH 6.9 | | |
| 0.027% NZ Protein # 10 | Tomato | 49% |
| 0.6% K₂HPO₄ | | |
| 0.4% KH₂PO₄ | | |
| pH 6.9 | | |
| 0.027% NZ Protein # 10 | Tomato | 79% |
| 0.05% BREAK-THRU ® S 301 | | |
| 0.6% K₂HPO₄ | | |
| 0.4% KH₂PO₄ | | |
| pH 6.9 | | |
| 0.027% NZ Protein # 10 | Grape | 62% |
| 0.6% K₂HPO₄ | | |
| 0.4% KH₂PO₄ | | |
| 0.027% NZ Protein # 10 | Grape | 86% |
| 0.05% BREAK-THRU ® S 301 | | |
| 0.6% K₂HPO₄ | | |
| 0.4% KH₂PO₄ | | |
| pH 6.9 | | |

The results in Table 2 show a clear difference in rainfastness when formulating the spray tank solution with a trisiloxane (BREAK-THRU® 5301). Further, the results show that there is a significant improvement in rainfastness, independent of enzyme class and leaf type.

### Example 2

The retention of a serine protease obtained from Nocardiopsis sp. (NZ protein #42; SEQ ID NO: 42) on tomato leaf discs was evaluated in presence of various commercially available organo-modified siloxanes.

Table 3 shows the retention of protease in the rainfastness assay with the tested organo-modified siloxanes. Both trisiloxanes (SILWET® L-77, SILWET® 408, SILWET® 719 and BREAK-THRU® S 301) and polysiloxanes (SILWET® HS-312 and SILWET® STIK 2) give rise to significantly improved rainfastness of the protease.

TABLE 3
Retention of a serine protease obtained from Nocardiopsis
sp. (NZ protein # 42; SEQ ID NO: 42) on tomato leaf
discs in presence of different organo-modified siloxanes.

| Foliar Spray Formulation | % Retention of treatment |
|---|---|
| 0.0059% NZ Protein # 42 | 58% |
| 0.0059% NZ Protein # 42 | 71% |
| 0.1% SILWET ™ HS-312 | |
| 0.0059% NZ Protein # 42 | 80% |
| 0.1% SILWET ™ L-77 | |
| 0.0059% NZ Protein # 42 | 94% |
| 0.1% SILWET ™ 408 | |
| 0.0059% NZ Protein # 42 | 93% |
| 0.1% SILWET ™ STIK 2 | |
| 0.0059% NZ Protein # 42 | 92% |
| 0.1% SILWET ™ 719 | |
| 0.0059% NZ Protein # 42 | 91% |
| 0.1% BREAK-THRU ® S 301 | |

### Example 3

The retention a serine protease obtained from Nocardiopsis sp. (NZ protein #42; SEQ ID NO: 42) on tomato leaf discs after a simulated rain event in 24-well plates was determined when combining the enzymes with a range of commercially available adjuvants.

TABLE 4
Effect of common types of adjuvants on
enzyme retention after simulated rain

| Formulation | % Retention of treatment |
|---|---|
| 0.0059% NZ Protein # 42 | 60% |
| 0.0059% NZ Protein # 42 | 87% |
| 0.1% BREAK-THRU ® S301 | |
| 0.0059% NZ Protein # 42 | 42% |
| 0.1% Tween ® L-1010 | |
| 0.0059% NZ Protein # 42 | 38% |
| 0.1% Tween ® 24 | |
| 0.0059% NZ Protein # 42 | 38% |
| 0.1% ADSEE ™ 900 | |
| 0.0059% NZ Protein # 42 | 20% |
| 0.1% ADSEE ™ 973 | |
| 0.0059% NZ Protein # 42 | 48% |
| 0.1% LUCROP ROIL | |
| 0.0059% NZ Protein # 42 | 45% |
| 0.1% ADSEE ™ ST4 | |
| 0.0059% NZ Protein # 42 | 48% |
| 0.1% ETHYLAN ® 995 | |
| 0.0059% NZ Protein # 42 | 22% |
| 0.1% ETHOMEEN ® C/15 | |

The experimental data show the unique rainfastness improvement of enzymes seen with organo-modified siloxane, which cannot be observed for other adjuvants commonly used in agricultural applications.

### Examples 4-5: Alkaline pH Improves the Fungicidal Efficacy of a Serine Protease

### Example 4

The efficacy of a serine protease obtained from Nocardiopsis sp (NZ protein #42; SEQ ID NO: 42) against tomato late blight and cucumber downy mildew was tested at alkaline pH in a plate-based assay.

For the tomato late blight plate assay, 24 well plates were lined with 2 mL. of 1.2% agar supplemented with 0.5% sorbitol. Each well had a 1.125 cm leaf disc cut with a #6 cork borer from tomato plants (cv. Moneymaker). The leaf disc was placed adaxial side up (top side facing up). To each leaf disc 15 μL of our treatments for a total of 8 wells/replicates per treatment. Leaf discs were allowed to dry for 2.25 hours in a laminar flow hood. Each leaf disc was wounded before inoculating 10 μL of the spore suspension at a concentration of 5E4 sporangia/mL onto the wound. Each plate was sealed with parafilm and held at 18 degrees C. and 18:6 light:dark cycle for 5 days before being scored (0=no infection, 1=infection).

For the cucumber downy mildew plate assay 48 well plates were lined with 700 L of 1% agar. Each well contains a 0.875 cm leaf disc of cucumber (cv. Iznik) with the bottom side facing up. To each well we add 15 L of our treatments for a total of 16 wells treatment. The discs were dried for 1-2 hours in a laminar flow hood. The pathogen was prepared by scraping infected and sporulating cucumber leaves with a 10 μL loop submerged in sterile water, and then the sporangia were quantified via a haemocytometer, and finally adjusted to a concentration of 5E4 sporangia/mL. Each leaf disc was wounded and then 10 μL of a 5E4 sporangia/mL solution was pipetted onto the wound. Plates were held at 18 degrees C. and 18:6 light:dark cycle for 5 days before being scored (0=no infection, 1=infection).

TABLE 5
Effect of pH on the effectiveness of a serine protease obtained
from Nocardiopsis sp. (NZ protein # 42; SEQ ID NO:
42) against tomato late blight and cucumber downy mildew

| | Protease dosage | | |
|---|---|---|---|
| | (mg active enzyme/L | | Pathogen |
| Spray solution | spray solution) | Leaf type | incidence |
| Water | 0 | Cucumber | 100% |
| Water | 6 | Cucumber | 92% |
| Water | 60 | Cucumber | 67% |
| 0.8% K₂HPO₄ | 0 | Cucumber | 94% |
| 0.06% KH₂PO₄ | | | |
| pH 7.9 | | | |
| 0.8% K₂HPO₄ | 6 | Cucumber | 63% |
| 0.06% KH₂PO₄ | | | |
| pH 7.9 | | | |
| 0.8% K₂HPO₄ | 60 | Cucumber | 21% |
| 0.06% KH₂PO₄ | | | |
| pH 7.9 | | | |
| Water | 0 | Tomato | 94% |
| Water | 6 | Tomato | 100% |
| Water | 60 | Tomato | 100% |
| 0.8% K₂HPO₄ | 0 | Tomato | 75% |
| 0.06% KH₂PO₄ | | | |
| pH 7.9 | | | |
| 0.8% K₂HPO₄ | 6 | Tomato | 44% |
| 0.06% KH₂PO₄ | | | |
| pH 7.9 | | | |
| 0.9% K₂HPO₄ | 60 | Tomato | 25% |
| 0.06% KH₂PO₄ | | | |
| pH 7.9 | | | |

### Example 5

The efficacy of a serine protease obtained from Nocardiopsis sp (NZ protein #42; SEQ ID NO: 42) was tested at alkaline pH against tomato late blight in green house trials.

For the greenhouse assays, 30 day old tomatoes (cv. Sungold) were treated with treatments at a rate of 30-40 gallons per acre and allowed to air dry for 24 hour before they were sprayed with a sporangia suspension (IE4 sporangia/mL in sterile ddH2O) of P. infestans.

After being sprayed with sporangia (approximately 10 mL per plant) plants were placed in the dark at 18 degrees C. with a humidifier for 48 hours. Plants were then removed and kept at 18 degrees C. with 16:8 light:dark cycle. After 5 days the plants were assessed for disease severity (percentage of disease tissue of the entire plant).

The disease severity measured on an untreated control was 32.5%.

TABLE 6
Effect of pH on the effectiveness of a serine protease
obtained from Nocardiopsis sp. (NZ protein # 42;
SEQ ID NO: 42) against tomato late blight

| | % Disease reduction compared |
|---|---|
| Treatment | to untreated control |
| Water | 58% |
| Protease: 15 mg active enzyme/L | |
| 0.8% K₂HPO₄ | 98% |
| 0.06% KH₂PO₄ | |
| pH 7.9 | |
| 0.1% SILWET ™ L-77 | |
| Protease: 15 mg active enzyme/L | |
| 0.9% K₂HPO₄ | 92% |
| pH 9 | |
| 0.1% SILWET ™ L-77 | |
| Protease: 15 mg active enzyme/L | |

### Examples 6-9: Organo-Modified Trisiloxanes Improve the Retention of Enzymes Sprayed on Plant Surfaces and their Effectiveness Against Zymoseptoria tritici

### Principle

A STB susceptible winter wheat cultivar (var. Hereford) growing in 1 L pots was first sprayed with enzyme and after 24 hours sprayed with a spore suspension of Zymoseptoria tritici. Percent leaf area attacked was assessed 14 days after inoculation and again with 3 days interval until the full effects were found. For scoring the standard EPPO scales were used (EPPO standards: Guidelines on good plant protection practice. Wheat. PP 2/10(1)). Experiments were conducted by Aarhus University, Flakkebjerg, Denmark.

### Materials

Winter wheat (var. Hereford), Zymoseptoria tritici spore suspensions (see Inoculum A and Inoculum B below), K₂HPO₄, KH₂PO₄, sodium acetate, acetic acid, glycerol, Tween® 20 (polyoxyethylene sorbitol ester, Sigma-Aldrich), BREAK-THRU® S 301 (polyether trisiloxane, Evonik Industries AG), and SILWET™ L77 (polyalkyleneoxide modified heptamethyltrisiloxane, Momentive Performance Materials Inc.). Enzymes are described in the examples

### Buffers

1M potassium phosphate stock solutions, pH 6, 7 or 8, were prepared as shown in Table 7 using demineralized water.

TABLE 7

| | K₂PO₄ | KH₂PO₄ | Total volume |
|---|---|---|---|
| Buffer | (g) | (g) | (mL) |
| pH 6 | 5.24 | 9.52 | 100 |
| pH 7 | 11.20 | 4.85 | 100 |
| pH 8 | 16.30 | 0.90 | 100 |

If needed, pH was adjusted to target value using a hydrochloric acid or sodium hydroxide solution. 1 M acetate, pH 5 stock solution was prepared by mixing 5.7 g sodium acetate and 1.8 g glacial acetic acid with water (total volume 100 mL) (pH 5 buffer).

Inoculums (Zymoseptoria tritici Spore Suspension)

### Inoculum A

Five isolates of Zymoseptoria tritici, collected in 2020 from naturally infected plants in Danish fields and considered to represent the natural Septoria community in Denmark that year, were grown on PDA (Potato Dextrose Agar, available e.g. from Sigma-Aldrich) and respective spores harvested and mixed into an unique suspension with a concentration similar to 2×10⁶ spores per ml. The inoculum was freshly prepared before use and contained 0.1% Tween® 20 to ensure good spreading on the leaves.

### Inoculum B

Five isolates of Zymoseptoria tritici, collected in 2021 from naturally infected plants in Danish fields and considered to represent the natural Septoria community in Denmark that year, were grown on PDA (Potato Dextrose Agar, available e.g. from Sigma-Aldrich) and respective spores harvested and mixed into an unique suspension with a concentration similar to 2×10⁶ spores per ml. The inoculum was freshly prepared before use and contained 0.1% Tween® 20 to ensure good spreading on the leaves.

### Procedure

1) Wheat kernels were sown in 1 L pots and allowed to germinate and grow under greenhouse conditions for approximately 2 weeks until reaching the two-leaf crop growth stage (BBCH12).
2) A tank mix for each enzyme to be tested was prepared by diluting the buffer stock solution 100-fold (resulting concentration in tank mix was 10 mM) and adding the enzyme to the concentration indicated in the examples and surfactant to a final concentration of 0.1% (w/v). The buffer pH, type of surfactant and type of enzyme are given in the examples. In some experiments no buffer was added.
3) The plants were treated by spraying the tank mix solution using a cabin sprayer (volume—600 mL; 150 L/ha, 3.6 km/hour, yellow nozzles 0.2). Tank mix solutions were prepared a few hours before application took place. The pH of the buffer depended on the enzyme used.
4) For the Septoria inoculum, 5 isolates of Zymoseptoria tritici collected from naturally infected plants in 2020 Danish fields were grown on PDA and the respective spores collected and mixed into a solution. The Septoria inoculum had a concentration similar to 2×10⁶ spores/mL and contained 0.1% Tween® 20 to ensure that the spores spread well on the leaves. The inoculum was freshly prepared before use.
5) 24 hours after application of the enzyme, the plants were sprayed with the Septoria inoculum (2 mL per pot). After inoculation, the plants were kept under high relative humidity, covered with black plastic for 3 days and transparent plastic for additional 9 days to ensure infection and further development of the pathogen.
6) 6 replicates were made for each condition. As control, plants were sprayed with a tank mix prepared with 0.1% SILWET™L-77 (no enzyme added).
7) Percent leaf area attacked by STB was determined 14 days after inoculation and again with 3 days interval until the full effects were found. For scoring, the standard EPPO scale was used (EPPO standards: Guidelines on good plant protection practice. Wheat. PP 2/10(1)).

### Example 6

Enzymes were tested for efficacy on Zymoseptoria tritici infected winter wheat as described above using Inoculum A. The enzymes tested, buffers and surfactants used as well as results obtained are described in Table 8. Results are presented as percent disease control in relation to the untreated control (UTC) at 18.7% disease pressure. The higher the % control, the better is the result. 100% means no disease was detected in the treatment and 0% means disease as at the same level as the untreated control (UTC). Tank mix with pH buffer and SILWET™ L-77 improved the performance of NZ protein numbers 1 & 10, 1 (p=0.153), 42 (p=0.004), 21 (p=0.014) and 22, as compared to tank mix with Tween 20.

TABLE 8
Effect of an organo-modified trisiloxane on
the efficacy of enzymes sprayed on wheat

| Enzyme | Tank mix description | | | |
|---|---|---|---|---|
| Treatment | | Enzyme | | |
| NZ Protein | | conc. | | % |
| #(s) | Buffer | mg/mL | surfactant | Control |
| UTC | — | — | SILWET ™ L-77 | 0.0 |
| 1 & 10 | — | 0.034 | Tween ® 20 | 53.6 |
| 1 & 10 | pH 7 | 0.034 | SILWET ™ L-77 | 61.6 |
| 1 | — | 0.220 ** | Tween ® 20 | 32.1 |
| 1 | pH 6 | 0.220 ** | SILWET ™ L-77 | 64.3 |
| 42 | — | 0.068 | Tween ® 20 | 33.0 |
| 42 | pH 8 | 0.068 | SILWET ™ L-77 | 75.9 |
| 21 | — | 0.122 | Tween ® 20 | 56.3 |
| 21 | pH 5 | 0.122 | SILWET ™ L-77 | 79.5 |
| 22 | — | 0.038 | Tween ® 20 | 34.8 |
| 22 | pH 5 | 0.038 | SILWET ™ L-77 | 50.9 |

** 0.1 mL glycerol per 100 mL tank mix was included

### Example 7

Enzymes were tested for efficacy on Zymoseptoria tritici infected winter wheat as described above using Inoculum A. The enzymes tested, buffers and surfactants used as well as results obtained are described in Table 9. Results are presented as percent disease control in relation to the untreated control (UTC) at 15.7% disease pressure. The higher the % control, the better is the result. 100% means no disease was detected in the treatment and 0% means disease as at the same level as the untreated control (UTC). Tank mix with pH buffer and SILWET™ L-77 significantly improved the performance of the pectinase mixture (p=0.069), as compared to tank mix with Tweent 20.

TABLE 9
Effect of an organo-modified trisiloxane on
the efficacy of enzymes sprayed on wheat

| Enzyme | Tank mix description | | | |
|---|---|---|---|---|
| Treatment | | Enzyme | | |
| NZ Protein | | conc. | | % |
| #(s) | Buffer | mg/mL | surfactant | Control |
| UTC | | | SILWET ™ L-77 | 0.0 |
| pectinases | — | 0.023 | Tween ® 20 | 37.2 |
| pectinases | pH 5 | 0.023 | SILWET ™ L-77 | 61.7 |
| 45 | — | 0.051 | Tween ® 20 | 76.1 |
| 45 | pH 8 | 0.051 | SILWET ™ L-77 | 76.1 |

### Example 8

Enzymes were tested for efficacy on Zymoseptoria tritici infected winter wheat as described above using Inoculum B. The enzymes tested, buffers and surfactants used as well as results obtained are described in Table 10. Results are presented as percent disease control in relation to the untreated control (UTC) at two timepoints: T1—19.2% disease pressure; T2—29.2% disease pressure. The higher the % control, the better is the result. 100% means no disease was detected in the treatment and 0% means disease as at the same level as the untreated control (UTC). Tank mix with pH buffer and SILWET™ L-77 improved the performance of NZ protein numbers 42, as compared to tank mix with pH buffer and BREAK-THRU® S 301. Tank mix with pH buffer and BREAK-THRU® S 301 improved the performance of NZ protein numbers 10, as compared to tank mix with pH buffer and SILWET™ L-77. Tank mix with pH buffer and SILWET™ L-77 improved the performance of NZ protein number 1, as compared to tank mix with pH buffer and BREAK-THRU® S 301 or Tween® 20 alone. Tank mix with pH buffer and BREAK-THRU® S 301 also improved the performance of NZ protein number 1, as compared to tank mix with TWEEN® 20 alone.

TABLE 10
Effect of organo-modified trisiloxanes on
the efficacy of enzymes sprayed on wheat

| Enzyme | Tank mix description | | | % | % |
|---|---|---|---|---|---|
| Treatment | | Enzyme | | Con- | Con- |
| NZ Protein | Buff- | conc. | | trol | trol |
| #(s) | er | mg/mL | surfactant | T1 | T2 |
| UTC | — | — | SILWET ™ L-77 | 0.0 | 0.0 |
| 42 | pH 8 | 0.068 | SILWET ™ L-77 | 67.0 | 62.9 |
| 42 | pH 8 | 0.068 | SILWET ™ L-77 | 53.9 | 74.3 |
| 42 | pH 8 | 0.068 | BREAK-THRU ® | 39.1 | 42.9 |
| | | | S 301 | | |
| 42 | pH 8 | 0.017 | SILWET ™ L-77 | 80.9 | 82.3 |
| 42 | pH 8 | 0.017 | BREAK-THRU ® | 54.8 | 55.4 |
| | | | S 301 | | |
| 10 | pH 7 | 0.034 | SILWET ™ L-77 | 42.6 | 48.6 |
| 10 | pH 7 | 0.034 | BREAK-THRU ® | 83.5 | 71.4 |
| | | | S 301 | | |
| 10 | — | 0.034 | Tween ® 20 | 91.3 | 88.6 |
| 1 | pH 6 | 0.220 | SILWET ™ L-77 | 89.6 | 84.0 |
| 1 | pH 6 | 0.220 ** | BREAK-THRU ® | 84.3 | 77.7 |
| | | | S 301 | | |
| 1 | pH 6 | 0.110 *** | SILWET ™ L-77 | 90.4 | 84.6 |
| 1 | — | 0.220 ** | Tween ® 20 | 75.7 | 61.1 |

** 0.1 mL glycerol per 100 mL tank mix was included
*** 0.05 mL glycerol per 100 mL tank mix was included

### Example 9

Enzymes were tested for efficacy on Zymoseptoria tritici infected winter wheat as described above using Inoculum B. The enzymes tested, buffers and surfactants used as well as results obtained are described in Table 11. Results are presented as percent disease control in relation to the untreated control (UTC) at two timepoints: T1—16.7% disease pressure; T2—26.7% disease pressure. The higher the % control, the better is the result. 100% means no disease was detected in the treatment and 0% means disease as at the same level as the untreated control (UTC). Tank mix with pH buffer and SILWET™ L-77 improved the performance of NZ protein number 21, as compared to tank mix with pH buffer and BREAK-THRU® S 301 or TWEEN® 20 alone. Tank mix with pH buffer and BREAK-THRU® S 301 also improved the performance of NZ protein number 21, as compared to tank mix with TWEEN® 20 alone. Tank mix with pH buffer and SILWET™ L-77 improved the performance of NZ protein number 22, as compared to tank mix with pH buffer and BREAK-THRU® 301. Tank mix with pH buffer and SILWET™ L-77 improved the performance of NZ protein number 25, as compared to tank mix with TWEEN® 20.

TABLE 11
Effect of organo-modified trisiloxanes on
the efficacy of enzymes sprayed on wheat

| Enzyme | Tank mix description | | | % | % |
|---|---|---|---|---|---|
| Treatment | | Enzyme | | Con- | Con- |
| NZ Protein | Buff- | conc. | | trol | trol |
| #(s) | er | mg/mL | surfactant | T1 | T2 |
| UTC | — | — | SILWET ™ L-77 | 0.0 | 0.0 |
| 21 | pH 5 | 0.122 | SILWET ™ L-77 | 85.0 | 85.6 |
| 21 | pH 5 | 0.122 | BREAK-THRU ® S 301 | 79.0 | 70.6 |
| 21 | — | 0.122 | Tween ® 20 | 61.0 | 45.6 |
| 22 | pH 5 | 0.038 | SILWET ™ L-77 | 87.0 | 84.4 |
| 22 | pH 5 | 0.038 | BREAK-THRU ® S 301 | 70.0 | 65.6 |
| 25 | pH 7 | 0.022 | SILWET ™ L-77 | 52.0 | 58.6 |
| 25 | — | 0.037 | Tween ® 20 | 28.1 | 32.3 |

### Example 10: Organo-Modified Trisiloxanes Improve the Retention of Enzymes Suraved on Plant Surfaces and their Effectiveness Against Phytophthora infestans

### Principle

A late blight susceptible tomato variety (Sungold) was grown in the greenhouse for approximately 3-weeks and then leaves were harvested for leaf disk assays within 24-well plates. Leaf disks were treated with 0.25 to 2.5 mg/ml enzyme and allowed to dry fully for approximately 2 hours. Once dry, 10 μl of Phytophthora infestans (US 23) was pipetted onto the leaf surface at a concentration of 1×10⁵ sporangia per ml. Disease was assessed 6 days post inoculation. Experiments were conducted by Novozymes Biologicals, Salem, VA, USA.

### Materials

Susceptible tomato plants (Sungold)
Rye A media (60 g Rye grains, 20 g sucrose, 15 g agar per liter)
Enzyme(s)
Phytophthora infestans (US 23 isolate)
Potassium Phosphate Buffer (0.05 M, pH 7.88)
Adjuvant A: SILWET™ L-77 (trisiloxane ethoxylate)
Adjuvant B: BREAK-THRU® SP 133 (polyglycerol esters and fatty acid esters)
0.5% Butterfield's buffer agar (5 g agar per liter, 1 L Butterfield's buffer), 2 ml within each well of a 24-well plate
10 ml atomizer spray bottles
Incubator (18° C.) with cool fluorescent light on timer
14 mm Cork borer
Hemocytometer
Phase contrast microscope (10× objective)

### Procedure

### Leaf Disk Assay

1. 24-well plates containing 2 ml of solidified 0.5% Butterfield's buffer agar (Butterfield's buffer was used as a replacement to typical water agar to balance pH) were briefly dried within a hood to remove condensation.
2. Enzyme dilutions were made with potassium phosphate buffer (0.05 M, pH 7.88) with protein concentrations of one of the following buffers and protein concentrations 0.25, 0.5, 1.0, and 2.5 mg/ml
3. In some instances, adjuvants were also applied with enzymes and their appropriate buffers. The adjuvants and tested concentrations are listed below:
   SILWET™ L-77 at a concentration of 0.1%
   BREAK-THRU® SP 133 at a concentration of 0.1%
4. Leaves were detached from the mid-region of a susceptible tomato variety (Sungold) at approximately 3-weeks of age.
5. Leaf disk were excised using a cork borer (14 mm diameter) and placed (adaxial/upper side up) into each of the wells.
6. Enzyme dilutions were applied to the leaf surface with atomizer spray bottles. Two spray pumps were applied to each leaf disk which adequately covered the leaf disks without pooling. Wells with different treatments were covered during application to eliminate contamination from overspray.
7. Enzyme applications were left to dry on the leaf surface for approximately 2 hours.
8. While waiting, the spore solution was prepared using the protocol below.
9. After enzymes were dry, the center of the leaf disk was inoculated with 10 μl of the spore suspension containing 1×10⁵ sporangia per ml (or 10 μl sterile water for uninoculated controls).
10. Plates were sealed with parafilm and incubated at 18° C. under a 16-hour light/8-hour dark cycle.
11. Images of the leaf disk plates were captured and analyzed for disease at 5-6 days post infection.

### Spore Solution Preparation

1. Phytophthora infestans was grown on Rye A medium at 18° C. under dark conditions for 2-3 weeks.
2. Plates were flooded with approximately 3 ml cold sterile distilled water, and the surface of the plate was gently scraped with an inoculation loop.
3. Water was pipetted off the plate and placed into a 15 ml conical tube. At roughly a 45-degree angle, another 2 ml of sterile distilled water was pipetted one ml at a time over the plate. The volume was transferred into the same 15 ml conical tube.
4. Sporangia were enumerated using a hemocytometer.
5. The spore suspension was incubated at 4° C. for 0.5-2 hours to induce zoospore release and then diluted to a concentration of 1×10⁵ sporangia per ml.

### Example 10

Enzymes were tested for efficacy against Phytophthora infestans infected tomato as described above. In this example, enzymes were diluted using potassium phosphate buffer (0.05 M, pH 7.88) and tested at concentrations of 0.25, 0.5. 1.0, and 2.5 mg protein per ml. Enzymes were tested without adjuvant as well as with 0.1% SILWET™ L-77 or 0.1% BREAK-THRU® SP 133. Efficacy observed for disease control on the leaf disks at 6 days post infection is shown in Table 12. A minimum of two experimental repeats with four replicates each were completed for each treatment. Disease reduction is defined as (−) no reduction, (+) mild reduction, (++) moderate reduction, and (+++) severe reduction. Dose responses can be observed for the enzymes as well as improved disease reduction with the addition of SILWET™ L-77 and BREAK-THRU®SP 133. In some instances, addition of the adjuvant allowed for comparable efficacy results at a lower enzyme dosage.

TABLE 12
Effect of organo-modified trisiloxanes on the
efficacy of enzymes sprayed on tomato leaves

| Enzyme | | | |
|---|---|---|---|
| Treatment | Protein | | |
| NZ Protein | concentration | | Disease |
| #(s) | (mg/ml) | Adjuvant | Reduction |
| UTC | 0 | none | − |
| UTC | 0 | SILWET ™ L-77 | + |
| UTC | 0 | BREAK-THRU ® SP 133 | − |
| 45 | 0.25 | None | − |
| 45 | 0.50 | None | − |
| 45 | 1.0 | None | − |
| 45 | 2.5 | None | ++ |
| 45 | 0.25 | SILWET ™ L-77 | + |
| 45 | 0.50 | SILWET ™ L-77 | + |
| 45 | 1.0 | SILWET ™ L-77 | +++ |
| 45 | 2.5 | SILWET ™ L-77 | +++ |
| 45 | 0.25 | BREAK-THRU ® SP 133 | + |
| 45 | 0.50 | BREAK-THRU ® SP 133 | + |
| 45 | 1.0 | BREAK-THRU ® SP 133 | + |
| 45 | 2.5 | BREAK-THRU ® SP 133 | ++ |
| 33 | 0.25 | None | − |
| 33 | 0.50 | None | − |
| 33 | 1.0 | None | + |
| 33 | 2.5 | None | ++ |
| 33 | 0.25 | SILWET ™ L-77 | + |
| 33 | 0.50 | SILWET ™ L-77 | + |
| 33 | 1.0 | SILWET ™ L-77 | + |
| 33 | 2.5 | SILWET ™ L-77 | +++ |
| 33 | 0.25 | BREAK-THRU ® SP 133 | − |
| 33 | 0.50 | BREAK-THRU ® SP 133 | − |
| 33 | 1.0 | BREAK-THRU ® SP 133 | − |
| 33 | 2.5 | BREAK-THRU ® SP 133 | +++ |
| 43 | 0.25 | None | + |
| 43 | 0.50 | None | + |
| 43 | 1.0 | None | + |
| 43 | 2.5 | None | ++ |
| 43 | 0.25 | SILWET ™ L-77 | + |
| 43 | 0.50 | SILWET ™ L-77 | + |
| 43 | 1.0 | SILWET ™ L-77 | ++ |
| 43 | 2.5 | SILWET ™ L-77 | ++ |
| 43 | 0.25 | BREAK-THRU ® SP 133 | − |
| 43 | 0.50 | BREAK-THRU ® SP 133 | − |
| 43 | 1.0 | BREAK-THRU ® SP 133 | ++ |
| 43 | 2.5 | BREAK-THRU ® SP 133 | +++ |
| 44 | 0.25 | None | + |
| 44 | 0.50 | None | + |
| 44 | 1.0 | None | ++ |
| 44 | 2.5 | None | +++ |
| 44 | 0.25 | SILWET ™ L-77 | + |
| 44 | 0.50 | SILWET ™ L-77 | + |
| 44 | 1.0 | SILWET ™ L-77 | ++ |
| 44 | 2.5 | SILWET ™ L-77 | +++ |
| 44 | 0.25 | BREAK-THRU ® SP 133 | + |
| 44 | 0.50 | BREAK-THRU ® SP 133 | + |
| 44 | 1.0 | BREAK-THRU ® SP 133 | +++ |
| 44 | 2.5 | BREAK-THRU ® SP 133 | +++ |

1. Use of an organo-modified siloxane, optionally an organo-modified trisiloxane or an organo-modified polysiloxane, for improving the rainfastness of a protein on a plant surface.

2. The use according to claim 1, characterized in that said organo-modified siloxane is an organo-modified trisiloxane comprising one or more polyether groups, optionally a trisiloxane ethoxylate.

3. The use according to claim 1, characterized in that said organo-modified siloxane is an organo-modified polysiloxane comprising one or more polyether groups, optionally a polysiloxane ethoxylate.

4. The use according to claim 1, characterized in that said organo-modified siloxane is selected from the group consisting of trisiloxanes and polysiloxanes described by the general Formula I: 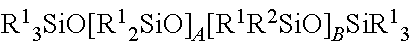
wherein
A is 0-200, preferably A is 0-1, more preferably A is 0;
B is 0-200, preferably B is 0.5-2; more preferably B is 1;
A+B>0;
R¹ represents identical or different from each other hydrocarbon substituents of 1-10 carbons or hydrogen, preferably methyl, ethyl, propyl and/or phenyl substituents, more preferably methyl substituents; and
R² represents identical or different from each other polyether substituents of the general Formula II: 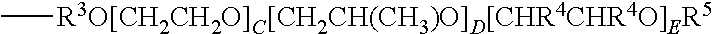
wherein
R³ represents identical or different from each other hydrocarbon moieties of 1-8 carbons, which optionally is interrupted by oxygen atoms, preferably linear hydrocarbons of 2-4 carbons, more preferably —CH₂—CH₂—CH₂—;
R⁴ represents identical or different from each other hydrocarbon substituents of 1-12 carbons or hydrogen, preferably methyl, ethyl, phenyl and/or hydrogen substituents;
R⁵ represents identical or different from each other hydrocarbon substituents of 1-16 carbons, which optionally contains urethane, carbonyl or carboxylic acid functionality, or hydrogen;
preferably methyl or hydrogen; more preferably hydrogen;
C is 0-60, preferably C is 1-15;
D is 0-60, preferably D is 0-10;
E is 0-20, preferably E is 0-10, more preferably E is 0; and
C+D+E>0.

5. The use according to claim 1, characterized in that said protein is an enzyme, optionally a protein that exhibits lipase, triacylglycerol lipase, pectinesterase, phospholipase, lysophospholipase, amylase, glucosidase, galactosidase, cellulase, glucanase, xylanase, ceramidase, dextranase, chitinase, chitosanase, galacturonase, fucosidase, lysozymes, xylosidase, lucosidass, pullulanase, mannosidase, amidase, asparaginase, aminidase, maltohydrolases, cellobiosidase, pectinase, aminopeptidase, serine peptidase and/or metallopeptidase activity.

6. The use according to claim 1, characterized in that said protein:
a) comprises one or more polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof;
b) comprises one or more polypeptides encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof,
c) comprises one or more polypeptides derived from any one of SEQ ID NOs: 1-48 and 98-150 by substitution, deletion or insertion of one or more amino acids;
d) comprises one or more polypeptides derived from a mature polypeptide of any one of SEQ ID NOs: 1-48 and 98-150 by substitution, deletion or insertion of one or more amino acids;
e) comprises one or more polypeptides derived from any one of a) through d) above wherein the N- and/or C-terminal end has been extended by the addition of one or more amino acids;
f) comprises a fragment of any one of a) through e) above; and/or
g) is an enzymatically active fragment/mutant/variant of any one of SEQ ID NOs: 1-48 and 98-150 or a mature polypeptide thereof.

7. An aqueous liquid formulation, characterized in that it comprises:
a) 0.0001 to 40% w/w protein, preferably 0.0001 to 25% w/w, more preferably 0.0001 to 1% w/w;
b) 0.001 to 50% w/w organo-modified trisiloxane, optionally an organo-modified trisiloxane or an organo-modified polysiloxane, preferably 0.001 to 10% w/w, more preferably 0.025 to 0.5% w/w;
c) 0.001 to 10% w/w pH control component, preferably 0.001 to 5% w/w, more preferably 0.01 to 1% w/w.

8. The aqueous liquid formulation according to claim 7, characterized in that said organo-modified siloxane is an organo-modified trisiloxane comprising one or more polyether groups, optionally a trisiloxane ethoxylate.

9. The aqueous liquid formulation according to claim 7, characterized in that said organo-modified siloxane is an organo-modified polysiloxane comprising one or more polyether groups, optionally a polysiloxane ethoxylate.

10. The aqueous liquid formulation according to claim 7, characterized in that said organo-modified siloxane is selected from the group consisting of trisiloxanes and polysiloxanes described by the general Formula I: 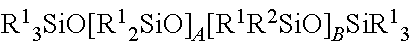
wherein
A is 0-200, preferably A is 0-1, more preferably A is 0;
B is 0-200, preferably B is 0.5-2; more preferably B is 1;
A+B>0;
R¹ represents identical or different from each other hydrocarbon substituents of 1-10 carbons or hydrogen, preferably methyl, ethyl, propyl and/or phenyl substituents, more preferably methyl substituents; and
R² represents identical or different from each other polyether substituents of the general Formula II: 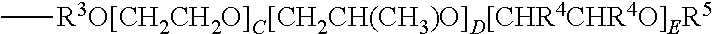
wherein
R³ represents identical or different from each other hydrocarbon moieties of 1-8 carbons, which optionally is interrupted by oxygen atoms, preferably linear hydrocarbons of 2-4 carbons, more preferably —CH₂—CH₂—CH₂—;
R⁴ represents identical or different from each other hydrocarbon substituents of 1-12 carbons or hydrogen, preferably methyl, ethyl, phenyl and/or hydrogen substituents;
R⁵ represents identical or different from each other hydrocarbon substituents of 1-16 carbons, which optionally contains urethane, carbonyl or carboxylic acid functionality, or hydrogen;
preferably methyl or hydrogen; more preferably hydrogen;
C is 0-60, preferably C is 1-15;
D is 0-60, preferably D is 0-10;
E is 0-20, preferably E is 0-10, more preferably E is 0; and
C+D+E>0.

11. The aqueous liquid formulation according to claim 7, characterized in that said protein is an enzyme, optionally a protein that exhibits lipase, triacylglycerol lipase, pectinesterase, phospholipase, lysophospholipase, amylase, glucosidase, galactosidase, cellulase, glucanase, xylanase, ceramidase, dextranase, chitinase, chitosanase, galacturonase, fucosidase, lysozymes, xylosidase, lucosidass, pullulanase, mannosidase, amidase, asparaginase, aminidase, maltohydrolases, cellobiosidase, pectinase, aminopeptidase, serine peptidase and/or metallopeptidase activity.

12. The aqueous liquid formulation according to claim 7, characterized in that said protein:
a) comprises one or more polypeptides having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to one or more of SEQ ID NOs: 1-48 and 98-150 or a mature polypeptide thereof;
b) comprises one or more polypeptides encoded by a polynucleotide having about/at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% sequence identity to any one or more of SEQ ID NOs: 49-97 and 151-203 or the cDNA sequence thereof, c) comprises one or more polypeptides derived from any one of SEQ ID NOs: 1-48 and 98-150 by substitution, deletion or insertion of one or more amino acids;
d) comprises one or more polypeptides derived from a mature polypeptide of any one of SEQ ID NOs: 1-48 and 98-150 by substitution, deletion or insertion of one or more amino acids;
e) comprises one or more polypeptides derived from any one of a) through d) above wherein the N- and/or C-terminal end has been extended by the addition of one or more amino acids;
f) comprises a fragment of any one of a) through e) above; and/or
g) is an enzymatically active fragment/mutant/variant of any one of SEQ ID NOs: 1-48 and 98-150 or a mature polypeptide thereof.

13. Currently Amended A method for preparing an aqueous liquid formulation according to claim 7, characterized in that it comprises:
a) providing an aqueous buffer solution comprising said organo-modified siloxane and said pH control component; and
b) introducing said protein into said aqueous buffer solution.

14. A method for depositing a protein on a plant surface, characterized in that it comprises:
a) preparing an aqueous liquid formulation according to claim 7; and
b) spraying said aqueous liquid formulation onto a plant, thereby depositing said protein on a surface of said plant.

15. A method for improving the rainfastness of a protein in an aqueous liquid formulation, characterized in that it comprises introducing an organo-modified siloxane, optionally an organo-modified trisiloxane or an organo-modified polysiloxane, optionally a polyether trisiloxane or a polyether polysiloxane, into said aqueous liquid formulation to a concentration of 0.001 to 50% w/w, preferably 0.001 to 10% w/w/, more preferably 0.025 to 0.5% w/w.
